(19) United States
(12) Patent Application Publication
(10) Pub. No.: US 2002/0024517 A1
(43) Pub. Date: Feb. 28, 2002

(54) Apparatus and method for three-dimensional image production and presenting real objects in virtual three-dimensional space

(75) Inventors: Hiroyoshi Yamaguchi, Kanagawa (JP); Tetsuya Shinbo, Kanagawa (JP); Hisashi Hamachi, Kanagawa (JP)

Correspondence Address: ARMSTRONG,WESTERMAN, HATTORI,, MCLELAND & NAUGHTON, LLP, 1725 K STREET, NW, SUITE 1000, WASHINGTON, DC, 20006, US

(73) Assignee: Komatsu Ltd., Tokyo (JP)

(21) Appl. No.: 09/902,644

(22) Filed: Jul. 12, 2001

(30) Foreign Application Priority Data
Jul. 14, 2000 (JP) 2000-214715
Aug. 8, 2000 (JP) 2000-240125

(51) Int. Cl. G06T 17/00

(52) U.S. Cl. 345/424

(57) ABSTRACT

Using a stereo viewing method, three-dimensional model data are produced that completely express an object in a three-dimensional shape, or moving images of the object as seen from any viewpoint are produced.

The object 10 is photographed by a plurality of multi-eyes stereo cameras 11, 12, and 13 deployed at different locations, and, for each of the multi-eyes stereo cameras 11, 12, and 13, a brightness image of the object 10 and a distance image indicating the distance to the outer surface of the object 10 are obtained. Based on these brightness images and distances, voxels in which the outer surface of the object 10 exists are determined, out of a multiplicity of voxels 30 virtually defined by finely dividing a space 20 into which the object 10 has entered, and the brightness of the object 10 in each of those voxels is determined. Based on these results, a three-dimensional model of the object 10 is produced, and, using that three-dimensional model, images looking at the object 10 from any viewpoint 40 are rendered. As a modification, the production of the three-dimensional model of the object 10 can be omitted, and images looking at the object 10 from any viewpoint 40 made directly on the basis of the brightness images and distance images described above.

### BACKGROUND OF THE INVENTION

1. Field of the Invention

This invention relates to an apparatus and method for producing three-dimensional model data for an object, or producing images that view the object from any viewpoint, based on object distance data obtained by a stereo ranging method. And this invention relates to a system and method for presenting three-dimensional model data for real objects in virtual three-dimensional space.

2. Description of the Related Art

In Japanese Patent Application Laid-Open No. H11-355806/1999 and No. H11-355807/1999, art is disclosed for producing an image of an object seen from any viewpoint, based on object distance data obtained by a stereo ranging method. With that prior art, multiple observation locations are established around the object, and the object is photographed with a double-eyes stereo camera from those observation locations. Then, based on those photographed images, curved-surface shapes for the surfaces of the object seen from each of the observation locations in turn are computed. Then the viewpoint is established at will, one observation location closest to that established viewpoint is selected, and, using the curved-surface shapes of the object computed for that one selected observation location, an image of the object seen from that viewpoint is produced.

With the prior art described above, curved-surface shapes of surfaces of an object seen from individual observation locations are computed, but three-dimensional model data that completely represent the three-dimensional shape of the object are not produced.

Moreover, with the prior art described in the foregoing, after computing the curved-surface shapes of the object surfaces seen from each of the plurality of observation locations, one observation location closest to a discretionally established viewpoint is selected, and, based on the curved-surface shapes of the object surfaces computed for that selected observation location, an image of the object seen from that viewpoint is produced. For that reason, considerable time is required for the completion of the image of the object. As a result, when the object moves, or when the viewpoint moves, it is difficult to produce images such that the way the object is viewed changes in real time along with those movements.

Why then, systems that involve computer-based virtual three-dimensional space are being proposed for various applications such as apparel trial fitting and direct-involvement games and the like. In Japanese Patent Application Laid-Open No. H10-124574/1998, for example, a system is disclosed that is made so that three-dimensional model data are produced for a user's body from photographs of and/or dimensional data on the user's body, that user's body three-dimensional model is imported into the virtual three-dimensional space of a computer, and, by clothing that model with three-dimensional apparel models and applying lipstick color data and the like, apparel and lipstick try-on simulations can be done. Analogous or related trial fitting systems are disclosed in Japanese Patent Application Laid-Open No. H10-340282/1998, H11-203347/1999, and H11-265243/1999, etc.

In Japanese Patent Application Laid-Open No. H11-3437/1999, moreover, a system is disclosed which employs virtual three-dimensional space in a direct-involvement game. In this system, two-dimensional images of a game player photographed by a camera are texture-mapped to a three-dimensional model of an appearing character existing inside the virtual three-dimensional space of the game, and thereby the player himself or herself can participate in the game as though he or she were a character appearing in the game.

In the conventional game systems described above, three-dimensional models of appearing characters existing in virtual three-dimensional space have a certain form that is altogether unrelated to the physical characteristics of the game player. In that regard, the reality level is still unsatisfactory in the sense of the player himself or herself becoming a character appearing in the game. On the other hand, in the conventional trial fitting systems described in the foregoing, three-dimensional model data of the user's body are imported into virtual three-dimensional space, wherefore the reality of the user himself or herself doing the trying on is very high.

Nevertheless, the prior art described in the foregoing does not provide any specific method or means for producing three-dimensional model data of the user's body. If, in order to produce three-dimensional model data of the user's body, the user himself or herself must have very expensive equipment, or enormous time and effort or costs are involved, then it will be very difficult to render practical a system that uses virtual space, such as described in the foregoing.

### SUMMARY OF THE INVENTION

Accordingly, one object of the present invention is to make it possible to produce three-dimensional model data that completely represent the three-dimensional shape of an object, using a stereo ranging method.

Another object of the present invention is to make it possible to produce images such that, when the object moves, or when the viewpoint moves, the way the object is viewed changes in real time along with those movements.

Another object of the present invention is to generate three-dimensional model data of such real physical objects as a person's body or article, without placing an overly large burden on the user, and to make provision for that three-dimensional model to be imported into virtual three-dimensional space.

Another object of the present invention is to make provision so that, in order to further enhance the reality of the virtual three-dimensional space into which three-dimensional model data for a real object has been imported, those three-dimensional model data can be made to assume different poses and perform motion inside the virtual three-dimensional space.

According to a first perspective of the present invention, a three-dimensional modeling apparatus is provided that comprises: a stereo processing unit that receives images from a plural number of stereo cameras deployed at different locations so as to photograph the same object, and produces a plurality of distance images of the object using the received images from the stereo cameras; a voxel processing unit that receives the plurality of distance images from the stereo processing unit, and, from a multiplicity of voxels established beforehand in a prescribed space into which the object enters, selects voxels wherein the surfaces of the object exist; and a modeling unit for producing three-dimensional models of the object, based on the coordinates of the voxels selected by the voxel processing unit.

According to this apparatus, complete three-dimensional models of objects can be produced. Based on this three-dimensional model, and using a commonly known rendering technique, an image of an object viewed from any viewpoint can be produced.

In a preferred embodiment aspect, the stereo cameras output moving images respectively, and, for each frame of those moving images from those stereo cameras, the stereo processing unit, voxel processing unit, and modeling unit respectively perform the processes described above. Thereby, a three-dimensional model is obtained that moves along with and in the same manner as the movements of the object.

According to a second perspective of the present invention, a three-dimensional image producing apparatus is provided that comprises: a stereo processing unit that receives images from a plural number of stereo cameras deployed at different locations so as to photograph the same object and produce a plurality of distance images of the object from images from that plural number of stereo cameras; an object detection unit that receives the plurality of distance images from the stereo processing unit, and determines coordinates where surfaces of the object exist in a viewpoint coordinate system referenced to viewpoints established at discretionary locations; and a target image production unit for producing images of the object seen from the viewpoints, based on the coordinates determined by the object detection unit.

In a preferred embodiment aspect, the stereo cameras output moving images respectively, and, for each frame of those moving images from those stereo cameras, the stereo processing unit, the object detection unit, and the target image production unit respectively perform the processes described above. Thereby, moving images are obtained wherein the images of the object change along with the motions of the object and movements of the viewpoints.

The apparatuses of the present invention can be implemented by pure hardware, by a computer program, or by a combination of the two.

According to a third perspective of the present invention, a system for making it possible to cause a real physical object to appear in virtual three-dimensional space in a computer application used by a user that follows a first perspective of the present invention comprises: photographed data reception means for receiving photographed data produced by stereo photographing a real physical object, from a stereo photographing apparatus usable by the user, capable of communicating with that stereo photographing apparatus; modeling means for producing a three-dimensional model of the physical object, based on the received photographed data, in a prescribed data format that can be imported into virtual three-dimensional space by the computer application; and three-dimensional model output means for outputting the produced three-dimensional model data by a method wherewith those data can be presented to the user or a computer application used by the user.

If this system is used, if a user photographs a physical object, such as his or her own body or an article, which he or she wishes to import into the virtual three-dimensional space of a computer application, with a stereo photographing apparatus, and transmits those photographed data to this system, three-dimensional model data for that physical object can be received from this system, wherefore the user can import those received three-dimensional model data into his or her computer application.

In a preferred embodiment aspect, this system exists as a modeling server on a communications network such as the internet. Thereupon, if a user photographs a desired physical object with a stereo photographing apparatus installed in a store such as a department store, game center, or convenience store or the like, for example, or with a stereo photographing apparatus possessed by the user himself or herself, and transmits those photographed data to a modeling server via a communications network, that three-dimensional model will be sent back via the communications network to the computer system in the store or to the computer system in the possession of the user. Thus the user can easily access a three-dimensional model of a desired physical object, and import that into a desired application such as a virtual trial fitting application or direct-involvement game or the like.

In a preferred embodiment aspect, the photographed data for a physical object photographed with a stereo photographing apparatus comprises photographed data of a plurality of poses photographed when that physical object assumed respectively different poses. For example, if the stereo photographing apparatus employs a video camera, when the user photographs himself or herself, for example, if that photographing is done while various poses are assumed or motions are performed, photographed data for many different poses will be obtained. The modeling means receive the photographed data for such different poses and, based thereon, produce three-dimensional model data of a configuration wherewith different poses can be assumed and motions performed. The user, thereby, can import the produced three-dimensional model data into the virtual three-dimensional space of a computer application, and then cause that three-dimensional model to assume various different poses or perform motions.

In a preferred embodiment aspect, the stereo photographing apparatus uses a video camera and, when a real physical object is performing some motion, photographs that and outputs moving image data for that motion. The modeling means receive those moving image data, and, based thereon, produce three-dimensional modeling data having a configuration wherewith the same motion as performed by the real physical object is performed. For that reason, the user can cause that three-dimensional model to perform the same motion as the real physical object inside the virtual three-dimensional space. Furthermore, in a preferred embodiment aspect, the modeling means produce the three-dimensional modeling data described above so that the same motion is performed, in substantially real time, as the motion being performed by the real physical object during the photographing by the stereo photographing apparatus. For that reason, if the user imports three-dimensional modeling data for himself or herself output in real time from the modeling means, while photographing himself or herself; for example, when the user performs some motion, the three-dimensional model of the user will perform exactly the same motion in the virtual three-dimensional space of the game simultaneously therewith. Thus a high level of reality is realized, as though the user himself or herself were imported into the virtual three-dimensional space.

A system that follows a forth perspective of the present invention combines the stereo photographing apparatus and the modeling apparatus described in the foregoing.

A system that follows a fifth perspective of the present invention further combines, in addition to the stereo photographing apparatus and modeling apparatus described in the foregoing, a computer apparatus capable of executing a computer application that imports produced three-dimensional models into virtual three-dimensional space.

### BRIEF DESCRIPTION OF THE DRAWINGS

FIG. 1 is a perspective view representing in simplified form the overall configuration of one embodiment aspect of the present invention;

FIG. 2 is a block diagram of the internal configuration of an arithmetic logic unit 18;

FIG. 3 is a perspective view showing how voxels are established referenced to the visibility and distance from a viewpoint 40;

FIG. 4 is a block diagram of the configuration of an arithmetic logic unit 200 used in a second embodiment aspect of the present invention;

FIG. 5 is a block diagram of the configuration of an arithmetic logic unit 300 used in a third embodiment aspect of the present invention;

FIG. 6 is a block diagram of the configuration of an arithmetic logic unit 400 used in a fourth embodiment aspect of the present invention; and

FIG. 7 is a block diagram of the configuration of an arithmetic logic unit 500 used in a fifth embodiment aspect of the present invention.

FIG. 8 is a block diagram of the overall configuration of a virtual trial fitting system relating to a sixth embodiment aspect of the present invention;

FIG. 9 is a flowchart of that portion of the processing procedures of a virtual trial fitting system that is executed centrally by a modeling server 1001;

FIG. 10 is a flowchart of that portion of the processing procedures of a virtual trial fitting system that is executed centrally by a virtual trial fitting server 1003;

FIG. 11 is a diagram of one example of a virtual trial fitting window that a virtual trial fitting program displays on a display screen of a user system;

FIG. 12 is a flowchart showing the process flow when an articulated standard full-length model is produced by a modeling server;

FIG. 13 is a diagram of the configuration of a three-dimensional human-form model produced in the course of the processing flow diagrammed in FIG. 12;

FIG. 14 is a flowchart showing the process flow of a virtual trial fitting program that uses an articulated standard full-length model;

FIG. 15 is a diagram for describing operations performed in the course of the process flow diagrammed in FIG. 14 on a user's standard full-length model and three-dimensional models of apparel;

FIG. 16 is a simplified diagonal view of the overall configuration of a stereo photographing system;

FIG. 17 is a block diagram of the internal configuration of an arithmetic logic unit 1018;

FIG. 18 is a block diagram of the internal configuration of a second arithmetic logic unit 1200 that can be substituted in place of the arithmetic logic unit 1018 diagrammed in FIG. 16 and 17;

FIG. 19 is a block diagram of the internal configuration of a third arithmetic logic unit 1300 that can be substituted in place of the arithmetic logic unit 1018 diagrammed in FIG. 16 and 17;

FIG. 20 is a block diagram of the internal configuration of a fourth arithmetic logic unit 1400 that can be substituted in place of the arithmetic logic unit 1018 diagrammed in FIG. 16 and 17;

FIG. 21 is a diagonal view of the overall configuration of a virtual trial fitting system relating to a seventh embodiment aspect of the present invention;

FIG. 22 is a block diagram of the overall configuration of a game system relating to a eighth embodiment aspect of the present invention;

FIG. 23 is a flowchart of processing for the game system diagrammed in FIG. 22;

FIG. 24 is a diagram of a photographing window;

FIG. 25 is a block diagram of the overall configuration of a game system relating to a ninth embodiment aspect of the present invention;

FIG. 26 is a flowchart of processing for the game system diagrammed in FIG. 25; and

FIG. 27 is a diagonal view of the overall configuration of a game system relating to a tenth embodiment aspect of the present invention.

### DESCRIPTION OF THE PREFERRED EMBODIMENTS

A number of embodiment aspects of the present invention are now described with reference to the drawings.

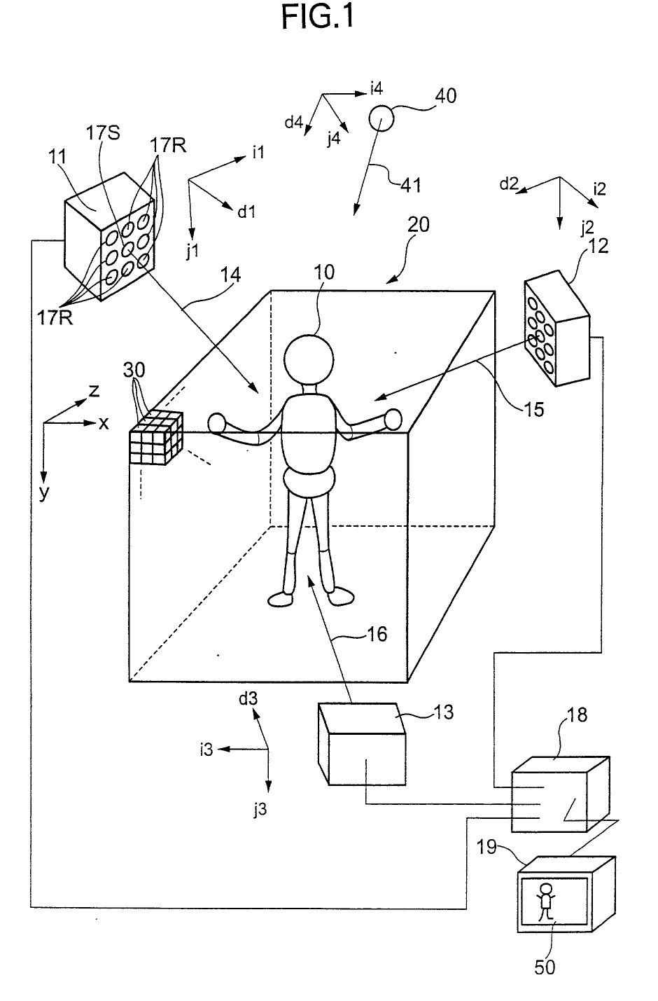

In FIG. 1 is represented, in simplified form, the overall configuration of one embodiment aspect of an apparatus for effecting three-dimensional modeling and three-dimensional image display according to the present invention.

A three-dimensional space 20 is established for inserting therein a modeling object (which, although a person in this example, may be any physical object) 10. At a plurality of different locations about the periphery of this space 20, multi-eyes stereo cameras 11, 12, and 13 are respectively fixed. In this embodiment aspect, there are three multi-eyes stereo cameras 11, 12, and 13, but this is one preferred example, and any number of stereo cameras 2 or greater is permissible. The lines of sight 14, 15, and 16 of these multi-eyes stereo cameras 11, 12, and 13 extend toward the interior of the space 20 in mutually different directions.

The output signals from the multi-eyes stereo cameras 11, 12, and 13 are input to the arithmetic logic unit 18. The arithmetic logic unit 18 virtually establishes a viewpoint 40 at any location inside or outside the space 20, and virtually establishes a line of sight 41 in any direction from the viewpoint 40. The arithmetic logic unit 18 also produces moving images when the object 10 is seen along the line of sight 41 from the viewpoint 40, based on input signals from the multi-eyes stereo cameras 11, 12, and 13, and outputs those moving images to a television monitor 19. The television monitor 19 displays those moving images.

Each of the multi-eyes stereo cameras 11, 12, and 13 comprises independent video cameras 17S, 17R, . . . , 17R, the positions whereof are relatively different and the lines of sight whereof are roughly parallel, the number whereof is 3 or more, and preferably 9, arranged in a 3×3 matrix pattern. The one video camera 17S positioned in the middle of that 3×3 matrix is called the “main camera”. The eight video cameras 17R, . . . , 17R positioned about that main camera 17S are called “reference cameras”. The main camera 17S and one reference camera 17R configure a pair of stereo cameras that is the minimal unit to which the stereo viewing method is applicable. The main camera 17S and the eight reference cameras 17R configure eight pairs of stereo cameras arranged in radial directions centered on the main camera 17S. These eight pairs of stereo cameras make it possible to compute stable distance data relating to the object 10 with high precision. Here, the main camera 17S is a color camera or a black and white camera. When color images are to be displayed on the television monitor 19, a color camera is used for the main camera 17S. The reference cameras 17R, . . . , 17R, on the other hand, need only be black and white cameras, although color cameras may be used also.

Each of the multi-eyes stereo cameras 11, 12, and 13 outputs nine moving images from the nine video cameras 17S, 17R, . . . , 17R. First, the arithmetic logic unit 18 fetches the latest frame image (still image) of the nine images output from the first multi-eyes stereo camera 11, and, based on those nine still images (that is, on the one main image from the main camera 17S and the eight reference images from the eight reference cameras 17R, . . . , 17R), produces the latest distance image of the object 10 (that is, an image of the object 10 represented at the distance from the main camera 17S), by a commonly known multi-eyes stereo viewing method. The arithmetic logic unit 18, in parallel with that described above, using the same method as described above, produces latest distance images of the object 10 for the second multi-eyes stereo camera 12 and for the third multi-eyes stereo camera 13 also. Following thereupon, the arithmetic logic unit 18 produces the latest three-dimensional model of the object 10, by a method described further below, using the latest distance images produced respectively for the three multi-eyes stereo cameras 11, 12, and 13. Following thereupon, the arithmetic logic unit 18 produces the latest image 50 of the object 10 as seen along the line of sight 41 from the viewpoint 40, using that latest three-dimensional model, and outputs that latest image 50 to the television monitor 19.

The arithmetic logic unit 18 repeats the actions described above every time it fetches the latest frame of a moving image from the multi-eyes stereo cameras 11, 12, and 13. Thereby, the latest image 50 displayed on the television monitor 19 is updated at high speed, as a result whereof the moving image of the object 10 as seen along the line of sight 41 from the viewpoint 40 is shown on the television monitor 19.

If the object 10 moves, the latest three-dimensional model produced by the arithmetic logic unit 18 changes, according to that movement, in real time. Therefore, the moving images of the object displayed on the television monitor 19 also change in conjunction with the motion of the actual object 10. The arithmetic logic unit 18 can also move the virtually established viewpoint 40 or change the direction of the line of sight 41. When the viewpoint 40 or the line of sight 41 moves, the latest image seen from the viewpoint 40 produced by the arithmetic logic unit 18 changes so as to follow that movement in real time. Therefore the moving images of the object displayed on the television monitor 19 also change in conjunction with movements of the viewpoint 40 or line of sight 41.

A detailed description is now given of the internal configuration and operation of the arithmetic logic unit 18.

In the arithmetic logic unit 18, the plurality of coordinate systems described below is used. That is, as diagrammed in FIG. 1, in order to process an image from the first multi-eyes stereo camera 11, a first camera rectangular coordinate system i1, j1, d1 having coordinate axes matched with the position and direction of the first multi-eyes stereo camera 11 is used. Similarly, in order to respectively process images from the second multi-eyes stereo camera 12 and the third multi-eyes stereo camera 13, a second camera rectangular coordinate system i2, j2, d2 and a third camera rectangular coordinate system i3, j3, d3 matched to the positions and directions of the second multi-eyes stereo camera 12 and the third multi-eyes stereo camera 13, respectively, are used. Furthermore, in order to define positions inside the space 20 and process a three-dimensional model for the object 10, a prescribed single overall rectangular coordinate system x, y, z is used.

The arithmetic logic unit 18, as diagrammed in FIG. 1, virtually finely divides the entire region of the space 20 into Nx, Ny, and Nz voxels 30, . . . , 30 respectively along the coordinate axes of the overall coordinate system x, y, z (a voxel connoting a small cube). Accordingly, the space 20 is configured by Nx×Ny×Nz voxels 30, . . . , 30. The three-dimensional model of the object 10 is made using these voxels 30, . . . , 30. Hereafter, the coordinates of each voxel 30 based on the overall coordinate system x, y, z are represented (vx, vy, vz).

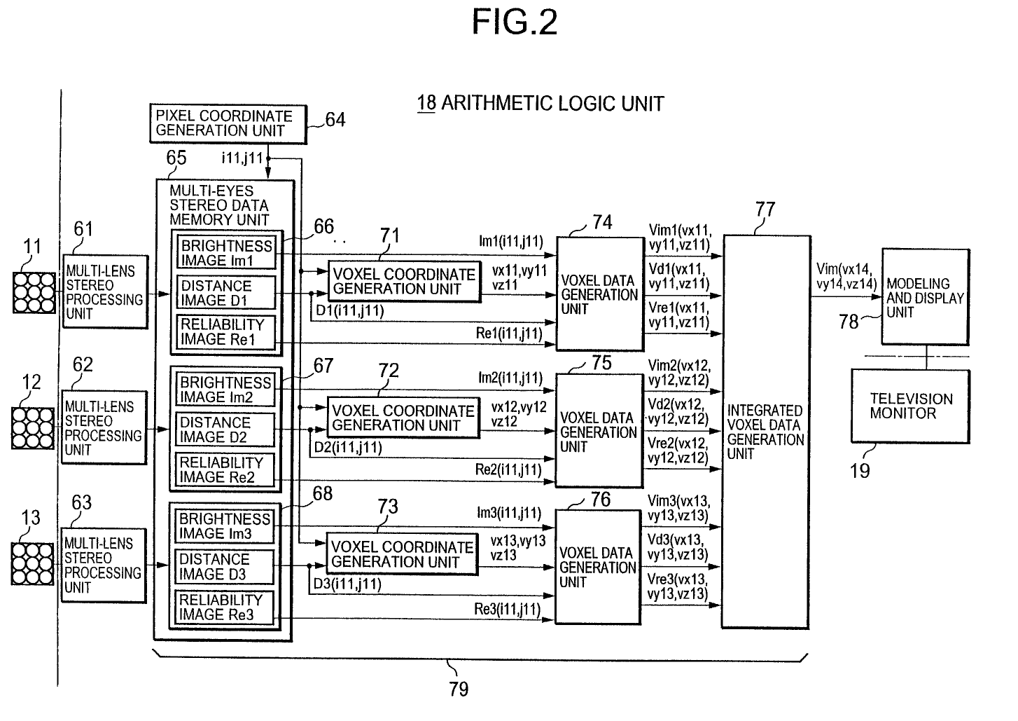

In FIG. 2 is represented the internal configuration of the arithmetic logic unit 18.

The arithmetic logic unit 18 has multi-eyes stereo data memory units 61, 62, and 63, a pixel coordinate generation unit 64, a multi-eyes stereo data memory unit 65, voxel coordinate generation units 71, 72, and 73, voxel data generation units 74, 75, and 76, an integrated voxel data generation unit 77, and a modeling and display unit 78. The processing functions of each unit are described below.

(1) Multi-eyes stereo processing units 61, 62, 63

The multi-eyes stereo processing units 61, 62, and 63 are connected on a one-to-one basis to the multi-eyes stereo cameras 11, 12, and 13. Because the functions of the multi-eyes stereo processing units 61, 62, and 63 are mutually the same, a representative description is given for the first multi-eyes stereo processing unit 61.

The multi-eyes stereo processing unit 61 fetches the latest frames (still images) of the nine moving images output by the nine video cameras 17S, 17R, . . . , 17R, from the multi-eyes stereo camera 11. These nine still images, in the case of black and white cameras, are gray-scale brightness images, and, in the case of color cameras, are three-color (R, G, B) component brightness images. The R, G, B brightness images, if they are integrated, become gray-scale brightness images as with the black and white cameras. The multi-eyes stereo processing unit 61 makes the one brightness image from the main camera 17S (as it is in the case of a black and white camera; made gray-scale by integrating the R, G, and B in the case of a color camera) the main image, and makes the eight brightness images from the other eight reference cameras (which are black and white cameras) 17R, . . . , 17R reference images. The multi-eyes stereo processing unit 61 then makes pairs of each of the eight reference images, on the one hand, with the main image, on the other (to make eight pairs), and, for each pair, finds the parallax between the two brightness images, pixel by pixel, by a prescribed method.

Here, for the method for finding the parallax, the method disclosed in Japanese Patent Application Laid-Open No. H11-175725/1999, for example, can be used. The method disclosed in Japanese Patent Application Laid-Open No. H11-175725/1999, simply described, is as follows. First, one pixel on the main image is selected, and a window region having a prescribed size (3×3 pixels, for example) centered on that selected pixel is extracted from the main image. Next, a pixel (called the corresponding candidate point) at a position shifted away from the aforesaid selected pixel on the reference image by a prescribed amount of parallax is selected, and a window region of the same size, centered on that corresponding candidate point, is extracted from the reference image. Then the degree of brightness pattern similarity is computed between the window region at the corresponding candidate point extracted from the reference image and the window region of the selected pixel extracted from the main image (as, for example, the inverse of the square added value of the difference in brightness between positionally corresponding pixels in the two window regions, for example). While sequentially changing the parallax from the minimum value to the maximum value and moving the corresponding candidate point, for each individual corresponding candidate point, the computation of the degree of similarity between the window region at that corresponding candidate point and the window region of the pixel selected from the main image is repeatedly performed. From the results of those computations, the corresponding candidate point for which the highest degree of similarity was obtained is selected, and the parallax corresponding to that corresponding candidate point is determined to be the parallax in the pixel selected as noted above. Such parallax determination is done for all of the pixels in the main image. From the parallaxes for the pixels in the main image, the distances between the main camera and the portions corresponding to the pixels of the object are determined on a one-to-one basis. Accordingly, by computing the parallax for all of the pixels in the main image, as a result thereof, distance images are obtained wherein the distance from the main camera to the object is represented for each pixel in the main image.

The multi-eyes stereo processing unit 61 computes distance images by the method described above for each of the eight pairs, then integrates the eight distance images by a statistical procedure (computing by averaging, for example), and outputs that result as the final distance image D1. The multi-eyes stereo processing unit 61 also outputs a brightness image Im1 from the main camera 17S. The multi-eyes stereo processing unit 61 also produces and outputs a reliability image Re1 that represents the reliability of the distance image D1. Here, by the reliability image Re1 is meant an image that represents, pixel by pixel, the reliability of the distance represented, pixel by pixel, by the distance image D1. For example, it is possible to compute the degree of similarity for each parallax while varying the parallax as described earlier for the pixels in the main image, then, from those results, to find the difference in the degrees of similarity between the parallax of the highest degree of similarity and the parallaxes adjacent thereto before and after, and to use that as the reliability of the pixels. In the case of this example, the larger the difference in degree of similarity, the higher the reliability.

Thus, from the first multi-eyes stereo processing unit 61, three types of output are obtained, namely the brightness image Im1, the distance image D1, and the reliability image Re1, as seen from the position of the first multi-eyes stereo camera 11. Accordingly, from the three multi-eyes stereo processing units 61, 62, and 63, the brightness images Im1, Im2, and Im3, the distance images D1, D2, and D3, and the reliability images Re1, Re2, and Re3 are obtained from the three camera positions (with the term “stereo output image” used as a general term for images output from these multi-eyes stereo processing units).

(2) Multi-eyes stereo data memory unit 65

The multi-eyes stereo data memory unit 65 inputs the stereo output images from the three multi-eyes stereo processing units 61, 62, and 63, namely the brightness images Im1, Im2, and Im3, the distance images D1, D2, and D3, and the reliability images Re1, Re2, and Re3, and stores those stereo output images in memory areas 66, 67, and 68 that correspond to the multi-eyes stereo processing units 61, 62, and 63, as diagrammed. The multi-eyes stereo processing unit 65, when coordinates indicating pixels to be processed (being coordinates in the camera coordinate systems of the multi-eyes stereo cameras 11, 12, and 13 indicated in FIG. 1, hereinafter indicated by (i11, j11)) are input from the pixel coordinate generation unit 64, reads out and outputs the values of the pixel indicated by those pixel coordinates (i11, j11) from the brightness images Im1, Im2, and Im3, the distance images D1, D2, and D3, and the reliability images Re1, Re2, and Re3.

That is, the multi-eyes stereo processing unit 65, when the pixel coordinates (i11, j11) are input, reads out the brightness Im1(i11, j11), distance D1(i11, j11), and reliability Re1(i11, j11) of the pixel corresponding to the coordinates (i11, j11) in the first camera coordinate system i1, j1, d1 from the main image Im1, distance image D1, and reliability image Re1 of the first memory area 66, reads out the brightness Im2(i11, j11), distance D2(i11, j11), and reliability Re2(i11, j11) of the pixel corresponding to the coordinates (i11, j11) in the second camera coordinate system i2, j2, d2 from the main image Im2, distance image D2, and reliability image Re2 of the second memory area 67, reads out the brightness Im3(i11, j11), distance D3(i11, j11), and reliability Re3(i11, j11) of the pixel corresponding to the coordinates (i11, j11) in the third camera coordinate system i3, j3, d3 from the main image Im3, distance image D3, and reliability image Re3 of the third memory area 68, and outputs those values.

(3) Pixel coordinate generation unit 64

The pixel coordinate generation unit 64 generates coordinates (i11, j11) that indicate pixels to be subjected to three-dimensional model generation processing, and outputs those coordinates to the multi-eyes stereo data memory unit 65 and to the voxel coordinate generation units 71, 72, and 73. The pixel coordinate generation unit 64, in order to cause the entire range or a part of the range of the stereo output images described above to be raster-scanned, for example, sequentially outputs the coordinates (i11, j11) of all of the pixels in that range.

(4) Voxel coordinate generation units 71, 72, and 73

Three voxel coordinate generation units 71, 72, and 73 are provided corresponding to the three multi-eyes stereo processing units 61, 62, and 63. The functions of the three voxel coordinate generation units 71, 72, and 73 are mutually identical, wherefore the first voxel coordinate generation unit 71 is described representatively.

The voxel coordinate generation unit 71 inputs the pixel coordinates (i11, j11) from the pixel coordinate generation unit 64, and inputs the distance D1(i11, j11) read out from the memory area 66 that corresponds to the multi-eyes stereo data memory unit 65 for those pixel coordinates (i11, j11). The input pixel coordinates (i11, j11) and the distance D1(i11, j11) represent the coordinates of one place on the outer surface of the object 10 based on the first camera coordinate system i1, j1, d1. That being so, the voxel coordinate generation unit 71 performs processing to convert coordinate values in the first camera coordinate system i1, j1, d1 incorporated beforehand to coordinate values in the overall coordinate system x, y, z, and converts the pixel coordinates (i11, j11) and distance D1(i11, j11) based on the first camera coordinate system i1, j1, d1 input to coordinates (x11, y11, z11) based on the overall coordinate system x, y, z. Next, the voxel coordinate generation unit 71 determines whether or not the converted coordinates (x11, y11, z11) are contained in which voxel 30 in the space 20, and, when such are contained on some voxel 30, outputs the coordinates (vx11, vy11, vz11) of that voxel 30 (that meaning one voxel wherein it is estimated that the outer surface of the object 10 exists). When the coordinates (x11, y11, z11) after conversion are not contained in any voxel 30 in the space 20, on the other hand, the voxel coordinate generation unit 71 outputs prescribed coordinate values (xout, yout, zout) indicating that such are not contained (that is, that those coordinates are outside of the space 20).

Thus the first voxel coordinate generation unit 71 outputs voxel coordinates (vx11, vy11, vz11) where is positioned the outer surface of the object 10 estimated on the basis of an image from the first multi-eyes stereo camera 11. The second and third voxel coordinate generation units 72 and 73 also, similarly, output voxel coordinates (vx12, vy12, vz12) and (vx13, vy13, vz13) where is positioned the outer surface of the object 10 estimated on the basis of images from the second and third multi-eyes stereo cameras 12 and 13.

The three voxel coordinate generation units 71, 72, and 73, respectively, repeat the processing described above for all of the pixel coordinates (i11, j11) output from the pixel coordinate generation unit 64. As a result, all voxel coordinates where the outer surface of the object 10 is estimated to be positioned are obtained.

(5) Voxel data generation units 74, 75, 76

Three voxel data generation units 74, 75, and 76 are provided corresponding to the three multi-eyes stereo processing units 61, 62, and 63. The functions of the three voxel data generation units 74, 75, and 76 are mutually identical, wherefore the first voxel data generation unit 74 is described representatively.

The voxel data generation unit 74 inputs the voxel coordinates (vx11, vy11, vz11) described earlier from the corresponding voxel coordinate generation unit 71, and, when the value thereof is not (xout, yout, zout), stores in memory data input from the multi-eyes stereo data memory unit 65 relating to those voxel coordinates (vx11, vy11, vz11). Those data, specifically, are the set of three types of values, namely the distance D1(i11, j11), brightness Im1(i11, j11), and reliability Re1(i11, j11) of the pixel corresponding to the coordinates (vx11, vy11, vz11) of that voxel. These three types of values are associated with the coordinates (vx11, vy11, vz11) of that voxel, and accumulated, respectively, as the voxel distance Vd1(vx11, vy11, vz11), voxel brightness Vim1(vx11, vy11, vz11), and voxel reliability Vre1(vx11, vy11, vz11) (with sets of values that are associated with voxels as these are being called “voxel data”).

After the pixel coordinate generation unit 64 has finished generating coordinates (i11, j11) for all of the pixels of the object being processed, the voxel data generation unit 74 outputs the voxel data accumulated for all of the voxels 30, . . . , 30. The number of the voxel data accumulated for the individual voxels is not constant. As there are voxels for which pluralities of voxel data are accumulated, for example, so there are voxels for which no voxel data whatever are accumulated. By a voxel for which no voxel data whatever have been accumulated is meant a voxel wherein, based on the photographed images from the 1st multi-eyes stereo camera 11, the existence of the outer surface of the object 10 there has not been estimated.

In such manner, the first voxel data generation unit 74 outputs voxel data Vd1(vx11, vy11, vz11), Vim1(vx11, vy11, vz11), and Vre1(vx11, vy11, vz11) based on photographed images from the first multi-eyes stereo camera 11 for all of the voxels. Similarly, the second and third voxel data generation units 75 and 76 also output voxel data Vd2(vx12, vy12, vz12), Vim2(vx12, vy12, vz12), and Vre2(vx12, vy12, vz12) and Vd3(vx13, vy13, vz13), Vim3(vx13, vy13, vz13), and Vre3(vx13, vy13, vz13), respectively, based on photographed images from the second and third multi-eyes stereo cameras 12 and 13 for all of the voxels.

(6) Integrated voxel data generation unit 77

The integrated voxel data generation unit 77 accumulates and integrates, for each voxel 30, the voxel data Vd1(vx11, vy11, vz11), Vim1(vx11, vy11, vz11), and Vre1(vx11, vy11, vz11), the voxel data Vd2(vx12, vy12, vz12), Vim2(vx12, vy12, vz12), and Vre2(vx12, vy12, vz12) and the voxel data Vd3(vx13, vy13, vz13), Vim3(vx13, vy13, vz13), and Vre3(vx13, vy13, vz13) input from the three voxel data generation units 74, 75, and 76 described above, and thereby finds the integrated brightness Vim(vx14, vyl4, vz14) for the voxels.

The following are examples of integration methods.

A. Case of a voxel for which pluralities of voxel data are accumulated:

(1) The average of the plurality of brightness accumulated is made the integrated brightness Vim(vx14, vy14, vz14). In this case, the distribution value of the plurality of brightness accumulated is found, and, when that distribution value is equal to or greater than a prescribed value, that voxel is assumed to have no data, whereupon the integrated brightness can be set to Vim(vx14, vy14, vz14)=0, for example.

(2) Alternatively, from a plurality of accumulated reliabilities, the highest one is selected, and the brightness corresponding to that highest reliability is made the integrated brightness Vim(vx14, vy14, vz14). In that case, when that highest reliability is lower than a prescribed value, it is assumed that there are no data in that voxel, and the integrated brightness is set to Vim(vx14, vy14, vz14)=0, for example.

(3) Alternatively, a weight coefficient is determined from the accumulated reliabilities, that weight coefficient is applied to the corresponding brightness, and the averaged value is made the integrated brightness Vim(vx14, vy14, vz14).

(4) Alternatively, because it is assumed that the brightness reliability will be higher the closer the distance of the camera to the object, the shortest one of a plurality of distances accumulated is selected, and the one brightness corresponding to that shortest distance is made the integrated brightness Vim(vx14, vy14, vz14).

(5) Alternatively, a method which modifies or combines the methods noted above in (1) to (4) is used.

B. Case of a voxel for which only one set of voxel data is accumulated:

(1) One accumulated brightness is made the integrated brightness Vim(vx14, vy14, vz14) as it is.

(2) Alternatively, when the reliability is equal to or greater than a prescribed value, that brightness is made the integrated brightness Vim(vx14, vy14, vz14), and when the reliability is less than the prescribed value, it is assumed that that voxel has no data, and the integrated brightness is set to Vim(vx14, vy14, vz14)=0, for example.

C. Case of a voxel for which no voxel data are accumulated:

(1) It is assumed that that voxel has no data, and the integrated brightness is set to Vim(vx14, vy14, vz14)=0, for example.

The integrated voxel data generation unit 77 finds an integrated brightness Vim(vx14, vy14, vz14) for all of the voxels 30, . . . , 30 and outputs that to the modeling and display unit 78.

(7) Modeling and display unit 78

The modeling and display unit 78 inputs an integrated brightness Vim(vx14, vy14, vz14) for all of the voxels 30, . . . , 30 inside the space 20 from the integrated voxel data generation unit 77. Voxels for which the value of the integrated brightness Vim(vx14, vy14, vz14) is other than “0” connote voxels where the outer surface of the object 10 is estimated to exist. Thereupon, the modeling and display unit 78 produces a three-dimensional model representing the three-dimensional shape of the outer surface of the object 10, based on the coordinates (vx14, vy14, vz14) of voxels having values other than “0” for the integrated brightness Vim(vx14, vy14, vz14). This three-dimensional model may be, for example, polygon data that represent a three-dimensional shape by a plurality of polygons obtained by connecting the coordinates (vx14, vy14, vz14), for the voxels having integrated brightness Vim(vx14, vy14, vz14) values other than “0,” which are close to each other into closed loops. Next, the modeling and display unit 78, using that three-dimensional model and the integrated brightness Vim(vx14, vy14, vz14) of the voxels configuring that three-dimensional model, produces a two-dimensional image as seen when looking at the object 10 along the line of sight 41 from the viewpoint 40 indicated in FIG. 1, by a commonly known rendering technique, and outputs that two-dimensional image to the television monitor 19. The coloring done when rendering can be effected using the integrated brightness Vim(vx14, vy14, vz14) of the voxels based on an actual photographed image, wherefore such onerous surface processing as ray tracing and texturing can be omitted (or performed if desired, of course), and rendering can be finished in a short time.

The processing in the units described above in (1) to (7) is repeated for each frame of the moving images output from the multi-eyes stereo cameras 11, 12, and 13. As a result, moving images of the object 10 as seen along the line of sight 41 from the viewpoint 40 are displayed in real time on the television monitor 19.

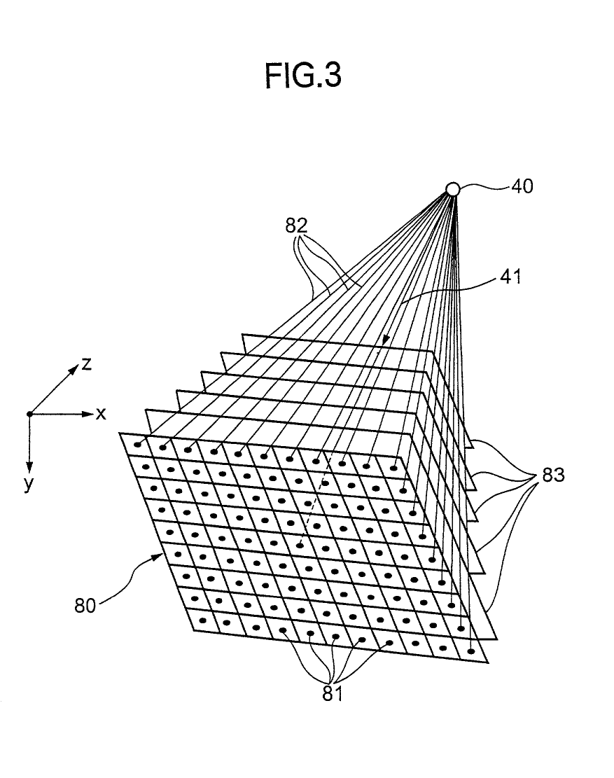

Now, in the foregoing description, the voxels 30, . . . , 30 inside the space 20 are established according to an overall rectangular coordinate system, but it is not absolutely necessary to make those voxels 30, . . . , 30 accord with an overall rectangular coordinate system and, for example, voxels like those diagrammed in FIG. 3 may be established. Specifically, first, an image screen 80 is established at right angles to a line of sight 41 as seen along that line of sight 41 from a viewpoint 40 established anywhere on an overall coordinate system x, y, z, and line segments 82 are extended toward the viewpoint 40 from each of all of the pixels 81 in that image screen 80. Further, a plurality of planes 83 are established parallel to the image screen 80, at different distances from the viewpoint 40. When that is done, intersections are formed between the line segments 82 from the pixels 81 and the planes 83. Boundary surfaces are established, centered on those intersections, between those intersections and the adjacent intersections, hexahedral regions are established so as to contain, one by one, the intersections enclosed by those boundary surfaces, and those hexahedral regions are made the voxels.

Moreover, the line segments 82 from the pixels 81 may be extended parallel to the line of sight 41, without being directed toward the viewpoint 40. When that is done, the voxels will be established according to a line of sight rectangular coordinate system i4, j4, d4 that takes distance coordinate axes in the direction of the line of sight 41 from the viewpoint 40 as an origin, as diagrammed in FIG. 1.

When the processing in the units described in (4) to (7) earlier is performed using voxels established as described above, when the final rendering of the two-dimensional image as seen from the viewpoint 40 by the modeling and display unit 78 is done, the process of converting the voxel coordinates to coordinates referenced to the viewpoint 40 can be omitted, thereby making it possible to perform rendering at higher speed.

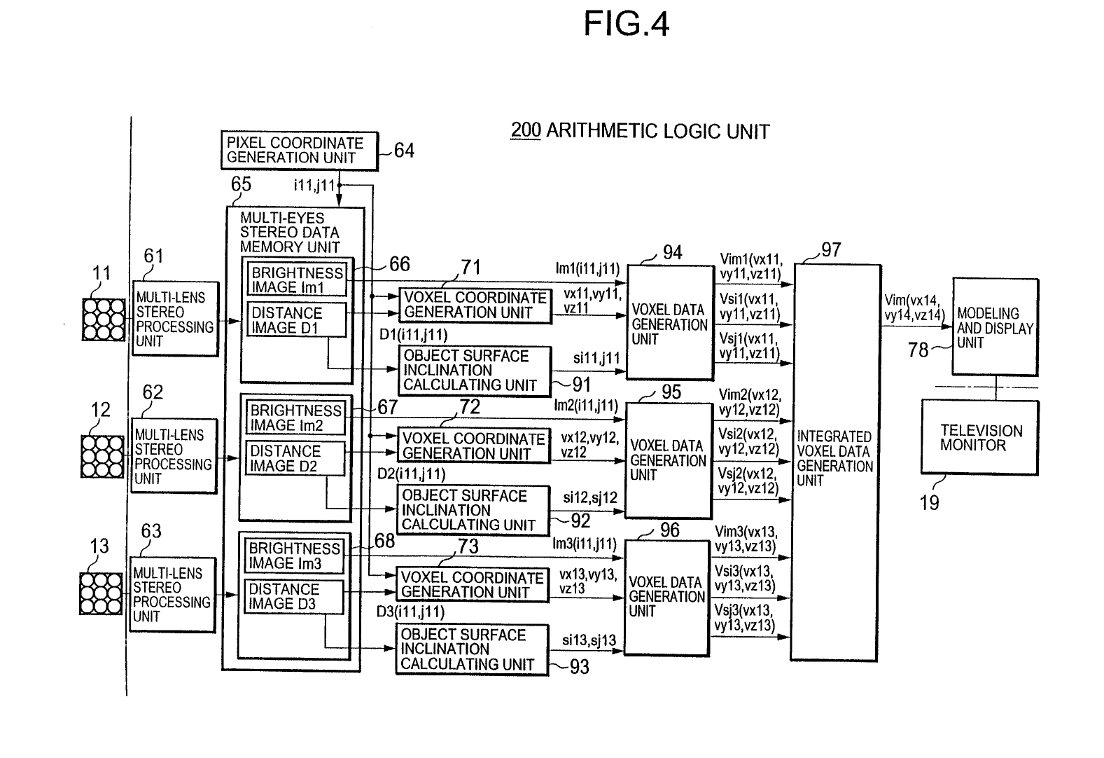

In FIG. 4 is diagrammed the configuration of an arithmetic logic unit 200 used in a second embodiment aspect of the present invention.

The overall configuration of this embodiment aspect is basically the same as that diagrammed in FIG. 1, but with the arithmetic logic unit 18 thereof replaced by the arithmetic logic unit 200 having the configuration diagrammed in FIG. 4.

In the arithmetic logic unit 200 diagrammed in FIG. 4, the multi-eyes stereo processing units 61, 62, and 63, pixel coordinate generation unit 64, multi-eyes stereo data memory unit 65, voxel coordinate generation units 71, 72, and 73, and modeling and display unit 78 have exactly the same functions as the processing units of the same reference number that the arithmetic logic unit 18 diagrammed in FIG. 2 has, as already described. What makes the arithmetic logic unit 200 diagrammed in FIG. 4 different from the arithmetic logic unit 18 diagrammed in FIG. 2 are the addition of object surface inclination calculating units 91, 92, and 93, and the functions of voxel data generation units 94, 95, and 96 and an integrated voxel data generation unit 97 that are to process the outputs from those object surface inclination calculating units 91, 92, and 93. Those portions that are different are now described.

(1) Object surface inclination calculating units 91, 92, and 93

Three object surface inclination calculating units 91, 92, and 93 are provided in correspondence, respectively, with the three multi-eyes stereo processing units 61, 62, and 63. The functions of these object surface inclination calculating units 91, 92, and 93 are mutually identical, wherefore the first object surface inclination calculating unit 91 is described representatively.

The object surface inclination calculating unit 91, upon inputting the coordinates (i11, j11) from the pixel coordinate generation unit 64, establishes a window of a prescribed size (3×3 pixels, for example) centered on those coordinates (i11, j11), and inputs the distances for all of the pixels in that window from the distance image D1 in the memory area 66 corresponding to the multi-eyes stereo data memory unit 65. Next, the object surface inclination calculating unit 91, under the assumption that the outer surface of the object 10 (hereinafter called the object surface) inside the area of the window is a flat surface, calculates the inclination between the object surface in that window and a plane at right angles to the line of sight 14 from the multi-eyes stereo camera 11 (zero-inclination plane), based on the distances of all the pixels in that window.

For the calculation method, there is, for example, a method wherewith, using the distances inside the window, a normal vector for the object surface is found by the method of least squares, then the differential vector between that normal vector and the vector of the line of sight 14 from the camera 11 is found, the i direction component Si11 and the j direction component Sj11 of that differential vector are extracted, and the object surface is given the inclination Si11, Sj11.

In this manner, the first object surface inclination calculating unit 91 calculates and outputs the inclination Si11, Sj11 for the object as seen from the first multi-eyes stereo camera 11, for all of the pixels in the main image photographed by that camera 11. Similarly, the second and third object surface inclination calculating units 92 and 93 calculate and output the inclinations Si12, Sj12 and Si13, Sj13 for the object as seen from the second and third multi-eyes stereo cameras 12 and 13, for all of the pixels in the reference images photographed by those cameras 12 and 13, respectively.

(2) Voxel data generation units 94, 95, 96

Three voxel data generation units 94, 95, and 96 that correspond respectively to the three multi-eyes stereo processing units 61, 62, and 63 are provided. The functions of these voxel data generation units 94, 95, and 96 are mutually the same, wherefore the first voxel data generation unit 94 is described representatively.

The voxel data generation unit 94 inputs the voxel coordinates (vx11, vy11, vz11) from the corresponding voxel coordinate generation unit and, if the value thereof is not (xout, yout, zout), accumulates voxel data for those voxel coordinates (vx11, vy11, vz11). For the voxel data accumulated, there are three types of values, namely the brightness Im1(i11, j11) read out from the first memory area 66 inside the multi-eyes stereo data memory unit 65 for the pixel corresponding to those voxel coordinates (vx11, vy11, vz11), and the inclination Si11, Sj11 of the object surface output from the first object surface inclination calculating unit 91. Those three types of values are accumulated in the form Vim1(vx11, vy11, vz11), Vsi1(vx11, vy11, vz11), and Vsj1(vx11, vy11, vz11).

After the pixel coordinate generation unit 64 has finished generating the coordinates (i11, j11) for all of the pixels of the object being processed, the voxel data generation unit 94 outputs the voxel data Vim1(vx11, vy11, vz11), Vsi1(vx11, vy11, vz11), and Vsj1(vx11, vy11, vz11) for all of the voxels 30, . . . , 30.

Similarly, the second and third voxel data generation units 95 and 96 output the voxel data Vim2(vx12, vy12, vz12), Vsi2(vx12, vy12, vz12), and Vsj2(vx12, vy12, vz12), and Vim3(vx13, vy13, vz13), Vsi3(vx13, vy13, vz13), and Vsj3(vx13, vy13, vz13), respectively, based, respectively, on the photographed images from the second and third multi-eyes stereo cameras 12 and 13, accumulated for all of the voxels 30, . . . , 30.

(3) Integrated voxel data generation unit 97

The integrated voxel data generation unit 97 accumulates and integrates, for each voxel 30, the voxel data Vim1(vx11, vy11, vz11), Vsi1(vx11, vy11, vz11), and Vsj1(vx11, vy11, vz11), Vim2(vx12, vy12, vz12), Vsi2(vx12, vy12, vz12), and Vsj2(vx12, vy12, vz12), and Vim3(vx13, vy13, vz13), Vsi3(vx13, vy13, vz13), and Vsj3(vx13, vy13, vz13), from the three voxel data generation units 94, 95, and 96, and thereby finds the integrated brightness Vim(vx14, vy14, vz14) for the voxels.

There are the following integration methods. The processing here is done with the presupposition that the smaller the object surface inclination, the higher the reliability of the multi-eyes stereo data.

A. Case of voxel for which pluralities of voxel data are accumulated:

(1) The sums of the squares of the i direction components Vsi1(vx11, vy11, vz11) and j direction components Vsj1(vx11, vy11, vz11) of the inclinations accumulated are found, and the brightness corresponding to the inclination where that sum of squares is the smallest is made the integrated brightness Vim(vx14, vy14, vz14). In this case, if the value of the smallest sum of squares is larger than a prescribed value, then it may be assumed that that voxel has no data, and the integrated brightness be made Vim(vx14, vy14, vz14)=0, for example.

(2) Alternatively, the average value of the i components and the average value of the j components of the plurality of inclinations accumulated are found, only inclinations that are comprehended within prescribed ranges centered on those average values of the i components and j components are extracted, the brightness corresponding to those extracted inclinations are extracted, and the average value of those extracted brightness is made the integrated brightness Vim(vx14, vy14, vz14).

B. Case of voxel for which only one set of voxel data is accumulated:

(1) One brightness accumulated is used as is for the integrated brightness Vim(vx14, vy14, vz14). In this case, if the sum of the squares of the i component and the j component of one inclination accumulated is equal to or greater than a prescribed value, it may be assumed that that voxel has no data, and the integrated brightness be made Vim(vx14, vy14, vz14)=0, for example.

C. Case of voxel for which no voxel data are accumulated:

(1) It is assumed that this voxel has no data, and the integrated brightness is made Vim(vx14, vy14, vz14)=0, for example.

In this manner, the integrated voxel data generation unit 97 computes all of the voxel integrated brightness Vim(vx14, vy14, vz14) and sends those to the modeling and display unit 78. The processing done by the modeling and display unit 78 is as already described with reference to FIG. 2.

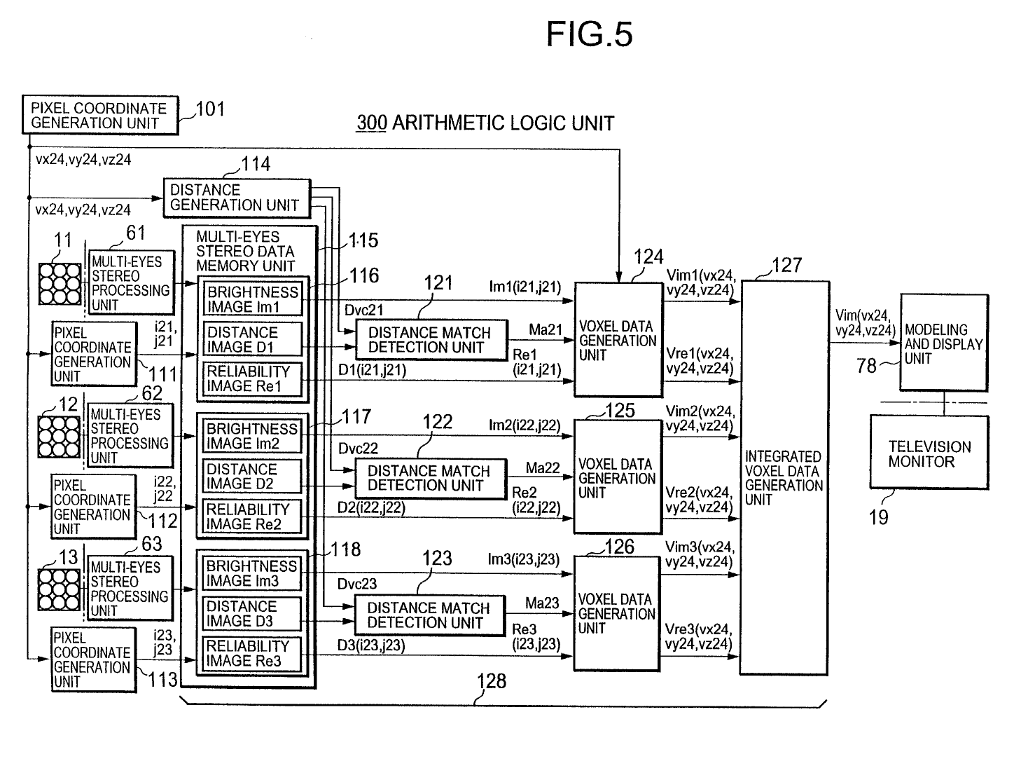

In FIG. 5 is diagrammed the configuration of an arithmetic logic unit 300 used in a third embodiment aspect of the present invention.

The overall configuration of this embodiment aspect is basically the same as that diagrammed in FIG. 1, but with the arithmetic logic unit 18 thereof replaced by the arithmetic logic unit 300 having the configuration diagrammed in FIG. 5.

The arithmetic logic unit 300 diagrammed in FIG. 5, compared to the arithmetic logic units 18 and 200 diagrammed in FIG. 2 and FIG. 4, respectively, differs in the processing procedure for producing voxel data, as follows. That is, the arithmetic logic units 18 and 200 diagrammed in FIG. 2 and 4 scan within the images output by the multi-eyes stereo processing units, find corresponding voxels 30 from the space 20, for each pixel in those images, and assign voxel data The arithmetic logic unit 300 diagrammed in FIG. 5, conversely, first scans the space 20, finds corresponding stereo data from the images output by the multi-eyes stereo processing units, for each voxel 30 in the space 20, and assigns those data to the voxels.

The arithmetic logic unit 300 diagrammed in FIG. 5 has multi-eyes stereo processing units 61, 62, and 63, a voxel coordinate generation unit 101, pixel coordinate generation units 111, 112, and 113, a distance generation unit 114, a multi-eyes stereo data memory unit 115, distance match detection units 121, 122, and 123, voxel data generation units 124, 125, and 126, an integrated voxel data generation unit 127, and a modeling and display unit 78. Of these, the multi-eyes stereo processing units 61, 62, and 63 and the modeling and display unit 78 have exactly the same functions as the processing units of the same reference number in the arithmetic logic unit 18 diagrammed in FIG. 2 and already described. The functions of the other processing units differ from those of the arithmetic logic unit 18 diagrammed in FIG. 2. Those areas of difference are described below. In the description which follows, the coordinates representing the positions of the voxels 30 are made (vx24, vy24, vz24).

(1) Voxel coordinate generation unit 101

This unit sequentially outputs the coordinates (vx24, vy24, vz24) for all of the voxels 30, . . . , 30 in the space 20.

(2) Pixel coordinate generation units 111, 112, 113

Three pixel coordinate generation units 111, 112, and 113 are provided corresponding respectively to the three multi-eyes stereo processing units 61, 62, and 63. The functions of these pixel coordinate generation units 111, 112, and 113 are mutually the same, wherefore the first pixel coordinate generation unit 111 is described representatively.

The pixel coordinate generation unit 111 inputs voxel coordinates (vx24, vy24, vz24), and outputs pixel coordinates (i21, j21) for images output by the corresponding first multi-eyes stereo processing unit 61. The relationship between the voxel coordinates (vx24, vy24, vz24) and the pixel coordinates (i21, j21), moreover, may be calculated using the multi-eyes stereo camera 11 attachment position information and lens distortion information, etc., or, alternatively, the relationships between the pixel coordinates (i21, j21) and all of the voxel coordinates (vx24, vy24, vz24) may be calculated beforehand, stored in memory in the form of a look-up table or the like, and called from that memory.

Similarly, the second and third pixel coordinate generation units 112 and 113 output the coordinates (i22, j22) and (i23, j23) for the images output by the second and third multi-eyes stereo system 62 and 63 corresponding to the voxel coordinates (vx24, vy24, vz24).

(3) Distance generation unit 114

The distance generation unit 114 inputs voxel coordinates (vx24, vy24, vz24), and outputs the distances Dvc21, Dvc22, and Dvc23 between the voxels corresponding thereto and the first, second, and third multi-eyes stereo cameras 11, 12, and 13. The distances Dvc21, Dvc22, and Dvc23 are calculated using the attachment position information and lens distortion information, etc., of the multi-eyes stereo cameras 11, 12, and 13.

(4) Multi-eyes stereo data memory unit 115

The multi-eyes stereo data memory unit 115, which has memory areas 116, 117, and 118 corresponding to the three multi-eyes stereo processing units 61, 62, and 63, inputs images (brightness images Im1, Im2, and Im3, distance images D1, D2, and D3, and reliability images Re1, Re2, and Re3) after stereo processing from the three multi-eyes stereo processing units 61, 62, and 63, and stores those input images in the corresponding memory areas 116, 117, and 118. The brightness image Im1, distance image D1, and reliability image Re1 from the first multi-eyes stereo processing unit 61, for example, are accumulated in the first memory area 116.

Following thereupon, the multi-eyes stereo data memory unit 115 inputs pixel coordinates (i21, j21), (i22, j22), and (i23, j23) from the three pixel coordinate generation units 111, 112, and 113, and reads out pixel stereo data (brightness, distance, reliability) corresponding respectively to the input pixel coordinates (i21, j21), (i22, j22), and (i23, j23), from the memory areas 116, 117, and 118 corresponding respectively to the three pixel coordinate generation units 111, 112, and 113, and outputs those. For the pixel coordinates (i21, j21) input from the first pixel coordinate generation unit 111, for example, from the brightness image Im1, distance image D1, and reliability image Re1 of the first multi-eyes stereo processing unit 61 that are accumulated, the brightness Im1(i21, j21), distance D1(i21, j21), and reliability Re1(i21, j21) of the pixel corresponding to those input pixel coordinates (i21, j21) are read out and output.

Furthermore, whereas the input pixel coordinates (i21, j21), (i22, j22), and (i23, j23) are real number data found by computation from the voxel coordinates, in contrast thereto, the pixel coordinates (that is, the memory addresses) of images stored in the multi-eyes stereo data memory unit 115 are integers. Thereupon, the multi-eyes stereo data memory unit 115 may discard the portions of the input pixel coordinates (i21, j21), (i22, j22), and (i23, j23) following the decimal point and convert those to integer pixel coordinates, or, alternatively, select a plurality of integer pixel coordinates in the vicinities of the input pixel coordinates (i21, j21), (i22, j22), and (i23, j23), read out and interpolate stereo data for that plurality of integer pixel coordinates, and output the results of those interpolations as stereo data for the input pixel coordinates.

(5) Distance match detection units 121, 122, 123

Three distance match detection units 121, 122, and 123 are provided corresponding respectively to the three multi-eyes stereo processing units 61, 62, and 63. The functions of these distance match detection units 121, 122, and 123 are mutually the same, wherefore the first distance match detection unit 121 is described representatively.

The first distance match detection unit 121 compares the distance D1(i21, j21) measured by the first multi-eyes stereo processing unit 61 output from the multi-eyes stereo data memory unit 115 against a distance Dvc1 corresponding to the voxel coordinates (vx24, vy24, vz24) output from the distance generation unit 114. When the outer surface of the object 10 exists in that voxel, D1(i21, j21) and Dvc21 should agree. Thereupon, the distance match detection unit 121, when the absolute value of the difference between D1(i21, j21) and Dvc21 is equal to or less than a prescribed value, judges that the outer surface of the object 10 exists in that voxel and outputs a judgment value Ma21=1. When the absolute value of the difference between D1(i21, j21) and Dvc21 is greater than the prescribed value, on the other hand, the distance match detection unit 121 judges that the outer surface of the object 10 does not exist in that voxel and outputs a judgment value Ma21=0.

Similarly, the second and third distance match detection units 122 and 123 judge whether or not the outer surface of the object 10 exists in those voxels, based respectively on the measured distances D2(i22, j22) and D3(i23, j23) according to the second and third multi-eyes stereo processing units 62 and 63, and outputs the judgment values Ma22 and Ma23, respectively.

(6) Voxel data generation units 124, 125, 126

Three voxel data generation units 124, 125, and 126 are provided corresponding respectively to the three multi-eyes stereo processing unit 61, 62, and 63. The functions of these voxel data generation units 124, 125, and 126 are mutually the same, wherefore the first voxel data generation unit 124 is described representatively.

The first voxel data generation unit 124 checks the judgment value Ma21 from the first distance match detection unit and, when Ma21 is 1 (that is, when the outer surface of the object 10 exists in the voxel having the voxel coordinates (vx24, vy24, vz24)), accumulates the data output from the first memory area 116 of the multi-eyes stereo data memory unit 115 for that voxel as the voxel data for that voxel. The accumulated voxel data are the brightness Im1(i21, j21) and reliability Re1(i21, j21) for the pixel coordinates (i21, j21) corresponding to those voxel coordinates (vx24, vy24, vz24), and are accumulated, respectively, as the voxel brightness Vim1(vx24, vy24, vz24) and the voxel reliability Vre1(vx24, vy24, vz24).

After the voxel coordinate generation unit 101 has generated voxel coordinates for all of the voxels 30, . . . , 30 which are to be processed, the voxel data generation unit 124 outputs the voxel data Vim1(vx24, vy24, vz24) and Vre1(vx24, vy24, vz24) accumulated for each of all of the voxels 30, . . . , 30. The numbers of sets of voxel data accumulated for the individual voxels are not the same, and there are also voxels for which no voxel data are accumulated.

Similarly, the second and third voxel data generation units 125 and 126, for each of all of the voxels 30, . . . , 30, accumulate, and output, the voxel data Vim2(vx24, vy24, vz24) and Vre2(vx24, vy24, vz24), and Vim3(vx24, vy24, vz24) and Vre3(vx24, vy24, vz24), based respectively on the outputs of the second and third multi-eyes stereo processing units 62 and 63.

(7) Integrated voxel data generation unit 127

The integrated voxel data generation unit 127 integrates the voxel data from the three voxel data generation units 124, 125, and 126, voxel by voxel, and thereby finds an integrated brightness Vim(vx24, vy24, vz24) for the voxels.

There are the following integration methods.

A. Case of voxel for which pluralities of voxel data are accumulated:

(1) The average of a plurality of accumulated brightness is made the integrated brightness Vim(vx24, vy24, vz24). In this case, the distribution value of the plurality of brightness is found, and, if that distribution value is equal to or greater than a prescribed value, it may be assumed that that voxel has no data, and Vim(vx24, vy24, vz24)=0 be set, for example.

(2) Alternatively, the highest of a plurality of accumulated reliabilities is selected, and the brightness corresponding to that highest reliability is made the integrated brightness Vim(vx24, vy24, vz24). In that case, if that highest reliability is equal to or below the prescribed value, it may be assumed that that voxel has no data, and Vim(vx24, vy24, vz24)=0 be set, for example.

(3) Alternatively, a weight coefficient is determined from the accumulated reliabilities, each of the plurality of accumulated brightness, respectively, is multiplied by the weight coefficient, and the averaged value is made the integrated brightness Vim(vx24, vy24, vz24).

B. Case of voxel for which one set of voxel data is accumulated:

(1) That brightness is made the integrated brightness Vim(vx24, vy24, vz24). In this case, when the reliability is equal to or lower than a prescribed value, that voxel may be assumed to have no data and Vim(vx24, vy24, vz24)=0 set, for example.

C. Case of voxel for which no voxel data are accumulated:

(1) That voxel is assumed to have no data, and Vim(vx24, vy24, vz24)=0 set, for example.

In this manner, the integrated voxel data generation unit 127 computes the integrated brightness Vim(vx24, vy24, vz24) for all of the voxels and sends the same to the modeling and display unit 78. The processing of the modeling and display unit 78 is as has already been described with reference to FIG. 2.

Now, with the arithmetic logic unit 300 diagrammed in FIG. 5, in the same manner as seen in the difference between the arithmetic logic unit 18 diagrammed in FIG. 2 and the arithmetic logic unit 200 diagrammed in FIG. 4, it is possible to add an object surface inclination calculating unit and use the inclination of the object surface instead of the reliability when generating integrated brightness. In the arithmetic logic unit 300 diagrammed in FIG. 5, moreover, instead of using an overall rectangular coordinate system, voxels may be established in conformity with a coordinate system that uses distances in the line of sight direction from the viewpoint 40, as diagrammed in FIG. 3.

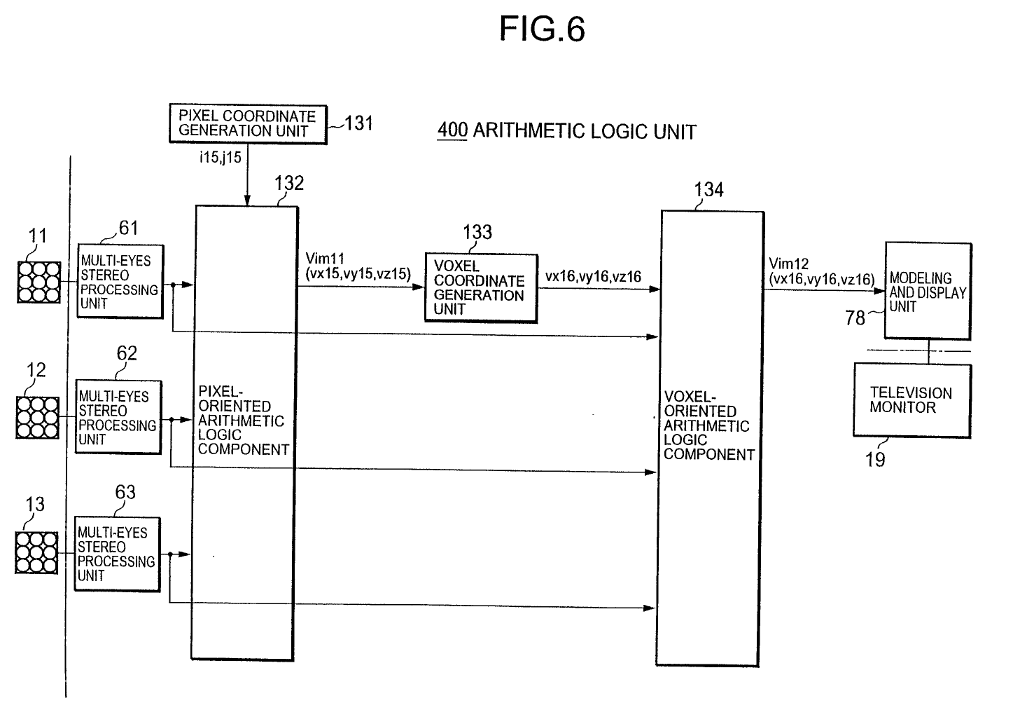

In FIG. 6 is diagrammed the configuration of an arithmetic logic unit 400 used in a fourth embodiment aspect of the present invention.

The overall configuration of this embodiment aspect is basically the same as that diagrammed in FIG. 1, but with the arithmetic logic unit 18 therein replaced by the arithmetic logic unit 400 having the configuration diagrammed in FIG. 6.

The arithmetic logic unit 400 diagrammed in FIG. 6, combining the configuration of the arithmetic logic unit 18 diagrammed in FIG. 2 and the arithmetic logic unit 300 diagrammed in FIG. 5, is designed so as to capitalize on the merits of those respective configurations while suppressing their mutual shortcomings. More specifically, based on the configuration of the arithmetic logic unit 300 diagrammed in FIG. 5, processing is performed wherein the three axes of coordinates of the voxel coordinates (vx24, vy24, vz24) are varied, wherefore, when the voxel size is made small and the number of voxels increased to make a fine three-dimensional model, the computation volume becomes enormous, which is a problem. Based on the configuration of the arithmetic logic unit 18 diagrammed in FIG. 2, on the other hand, it is only necessary to vary the two axes of coordinates of the pixel coordinates (i11, j11), wherefore the computation volume is small compared to the arithmetic logic unit 300 of FIG. 5, but, if the number of voxels is increased to obtain a fine three-dimensional model, the number of voxels for which voxel data are given is limited by the number of pixels, wherefore gaps open up between the voxels for which voxel data are given, and a fine three-dimensional model cannot be obtained, which is a problem.

Thereupon, in order to resolve those problems, with the arithmetic logic unit 400 diagrammed in FIG. 6, a small number of coarse voxels is first established and pixel-oriented arithmetic processing is performed as with the arithmetic logic unit 18 of FIG. 2, and an integrated brightness Vim11(vx15, vy15, vz15) is found for the coarse voxels. Next, based on the coarse voxel integrated brightness Vim11(vx15, vy15, vz15), for a coarse voxel having an integrated brightness for which it is judged that the outer surface of the object 10 exists, the region of that coarse voxel is divided into fine voxels having small regions, and voxel-oriented arithmetic processing such as is performed by the arithmetic logic unit 300 of FIG. 5 is only performed for those divided fine voxels.

More specifically, the arithmetic logic unit 400 diagrammed in FIG. 6 comprises, downstream of multi-eyes stereo processing units 61, 62, and 63 having the same configuration as has already been described, a pixel coordinate generation unit 131, a pixel-oriented arithmetic logic component 132, a voxel coordinate generation unit 133, a voxel-oriented arithmetic logic component 134, and a modeling and display unit 78 having the same configuration as already described.

The pixel coordinate generation unit 131 and the pixel-oriented arithmetic logic component 132 have substantially the same configuration as in block 79 in the arithmetic logic unit 18 diagrammed in FIG. 2 (namely, the pixel coordinate generation unit 64, multi-eyes stereo data memory unit 65, voxel coordinate generation units 71, 72, and 73, voxel data generation units 74, 75, and 76, and integrated voxel data generation unit 77). More specifically, the pixel coordinate generation unit 131, in the same manner as the pixel coordinate generation unit 64 indicated in FIG. 2, scans all of the pixels in either the entire regions or in the partial regions to be processed of the images output by the multi-eyes stereo processing units 61, 62, and 63, and sequentially outputs coordinates (i15, j15) for the pixels. The pixel-oriented arithmetic logic component 132, based on the pixel coordinates (i15, j15) and on the distances relative to those pixel coordinates (i15, j15), finds the coordinates (vx15, vy15, vz15) of the coarse voxels established beforehand by the coarse division of the space 20, and then finds, and outputs, an integrated brightness Vim11(vx15, vy15, vz15) for those coarse voxel coordinates (vx15, vy15, vz15) using the same method as the arithmetic logic unit 18 of FIG. 2. Also, for the method used here for finding the integrated brightness Vim11(vx15, vy15, vz15), instead of the method already described, a simple method may be used which merely distinguishes whether or not Vim11(vx15, vy15, vz15) is zero (that is, whether or not the outer surface of the object 10 exists in that coarse voxel).

The voxel coordinate generation unit 133 inputs an integrated brightness Vim11(vx15, vy15, vz15) for the coordinates (vx15, vy15, vz15) for the coarse voxels, whereupon the coarse voxels for which that integrated brightness Vim11(vx15, vy15, vz15) is not zero (that is, wherein it is estimated that the outer surface of the object 10 exists), and those only, are divided into pluralities of fine voxels, and the voxel coordinates (vx16, vy16, vz16) for those fine voxels are sequentially output.

The voxel-oriented arithmetic logic component 134 has substantially the same configuration as in the block 128 (i.e. the pixel coordinate generation units 111, 112, and 113, distance generation unit 114, multi-eyes stereo data memory unit 115, distance match detection units 121, 122, and 123, voxel data generation units 124, 125, and 126, and integrated voxel data generation unit 127) of the arithmetic logic unit 300 diagrammed in FIG. 5. This voxel-oriented arithmetic logic component 134, for the coordinates (vx16, vy16, vz16) of the fine voxels, finds voxel data based on the images output from the multi-eyes stereo processing units 61, 62, and 63, integrates those to find the integrated brightness Vim12(vx16, vy16, vz16), and outputs that integrated brightness Vim12(vx16, vy16, vz16).

The process of generating the fine voxel data by the voxel-oriented arithmetic logic component 134 is performed in a limited manner only on those voxels wherein it is assumed the outer surface of the object 10 exists. Wasteful processing on voxels wherein the outer surface of the object 10 does not exist is therefore eliminated, and processing time is reduced by that measure.

In the configuration described in the foregoing, the pixel-oriented arithmetic logic component 132 and the voxel-oriented arithmetic logic component 134 have multi-eyes stereo data memory units, respectively. However, the configuration can instead be made such that both the pixel-oriented arithmetic logic component 132 and the voxel-oriented arithmetic logic component 134 jointly share one multi-eyes stereo data memory unit.

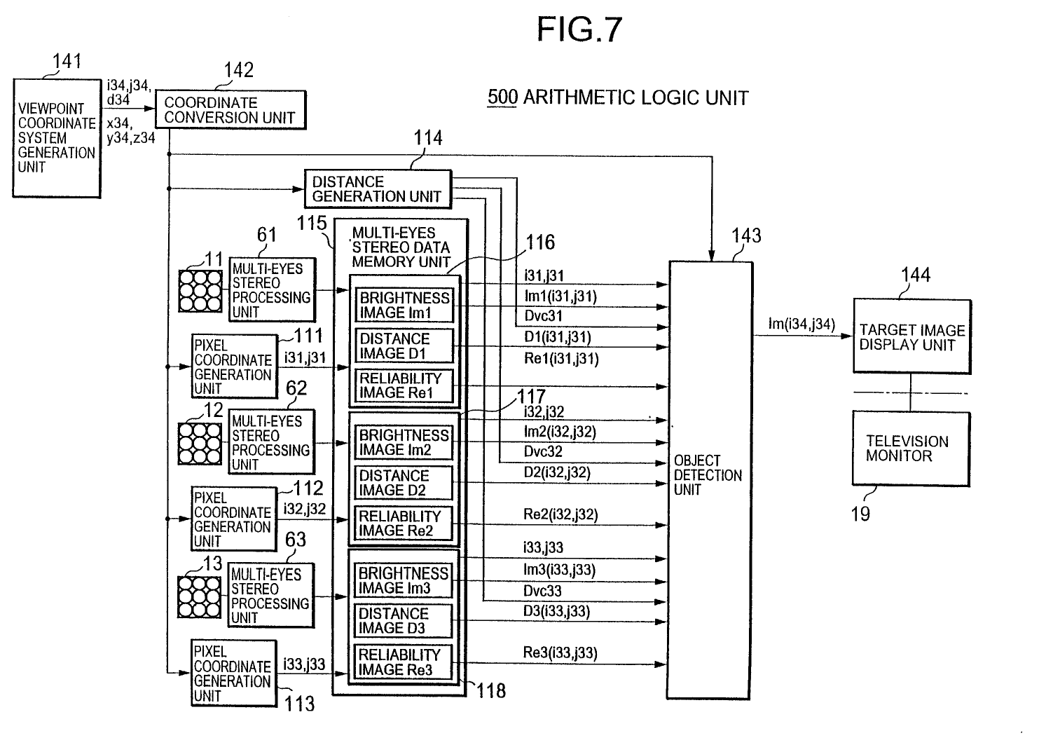

In FIG. 7 is diagrammed the configuration of an arithmetic logic unit 500 used in a fifth embodiment aspect of the present invention.

The overall configuration of this embodiment aspect is basically the same as that diagrammed in FIG. 1, wherein the arithmetic logic unit 18 therein has been replaced by the arithmetic logic unit 500 having the configuration diagrammed in FIG. 7.

In the arithmetic logic unit 500 diagrammed in FIG. 7, the generation of a three-dimensional model of the object 10 is omitted, and an image of the object 10 as seen along the line of sight 41 from the viewpoint 40 is generated directly from the multi-eyes stereo data. The method used here is similar to the method of establishing voxels according to a viewpoint coordinate system i4, j4, d4 as described with reference to FIG. 3. In the method used here, however, a three-dimensional model is not produced, wherefore the voxel concept is no longer used. Here, for each coordinate in the viewpoint coordinate system i4, j4, d4, a check is done to see whether or not there are corresponding multi-eyes stereo data and, when there are, an image seen from the viewpoint 40 is rendered directly using those multi-eyes stereo data.

More specifically, the arithmetic logic unit 500 diagrammed in FIG. 7 has multi-eyes stereo processing units 61, 62, and 63, a viewpoint coordinate system generation unit 141, a coordinate conversion unit 142, pixel coordinate generation units 111, 112, and 113, a distance generation unit 114, a multi-eyes stereo data memory unit 115, an object detection unit 143, and a target image display unit 144. Of these, the multi-eyes stereo processing units 61, 62, and 63, pixel coordinate generation units 111, 112, and 113, distance generation unit 114, and multi-eyes stereo data memory unit 115 have the same functions as the processing units having the same reference number in the arithmetic logic unit 300 diagrammed in FIG. 5. The functions and operations primarily of those processing units that are different are described below.

(1) Viewpoint coordinate system generation unit 141

The viewpoint coordinate system generation unit 141 uses the viewpoint rectangular coordinate system i4, j4, d4 as shown in FIG. 1 to raster-scan the i4 and j4 coordinates covered by the brightness image seen from the virtual viewpoint 40 in the direction of the line of sight 41 (that is, the image displayed on the television monitor 19, hereinafter called the “target image”) (that is, the range of the image screen 80 as diagrammed in FIG. 3), and, while doing so, sequentially changes the distance coordinate d34 for each of the coordinates (i34, j34) of the pixels in that target image from the minimum value to the maximum value, and thereby sequentially outputs coordinates (i34, j34, d34) based on the viewpoint rectangular coordinate system i4, j4, d4. Spatial points indicated by those coordinates (i34, j34, d34) are hereinafter called “search points.”

Instead of the viewpoint rectangular coordinate system i4, j4, d4 such as diagrammed in FIG. 1, the search points may be represented as the coordinates (i34, j34, d34), using a viewpoint coordinate system defined by the coordinates of pixels 81 in the target image 80 and the distance from the viewpoint 40 along lines 82 extending from the pixels 81 toward the viewpoint 40, as diagrammed in FIG. 3.

(2) Coordinate conversion unit 142

The coordinate conversion unit 142 inputs coordinates (i34, j34, d34) based on the viewpoint rectangular coordinate system i4, j4, d4 for the search points from the viewpoint coordinate system generation unit 141, and converts them to coordinates (x34, y34, z34) based on the overall rectangular coordinate system x, y, z, and outputs those converted coordinates. The functions of this coordinate conversion unit 142, moreover, are substantially the same as the functions of the voxel coordinate generation unit 101 in cases where voxels are established according to the viewpoint rectangular coordinate system i4, j4, d4 in the arithmetic logic unit 300 diagrammed in FIG. 5.

The search point coordinates (x34, y34, z34) based on the overall rectangular coordinate system x, y, z output from the coordinate conversion unit 142 are input to the pixel coordinate generation units 111, 112, and 113, as already described for the arithmetic logic unit 300 of FIG. 5, and there converted to coordinates (i31, j31), (i32, j32), and (i33, j33) of corresponding pixels on the images output by the multi-eyes stereo processing units 61, 62, and 63. Then the stereo data (brightness Im1(i31, j31), Im2(i32, j32), Im3(i33, j33), distance D1(i31, j31), D2(i32, j32), D3(i33, j33), and reliability Re1(i31, j31), Re2(i32, j32), Re3(i33, j33) for the pixels corresponding respectively to those pixel coordinates (i31, j31), (i32, j32), and (i33, j33) are output from the multi-eyes stereo data memory unit 115.

The coordinates (x34, y34, z34) for the search point output from this coordinate conversion unit 142 are input to the distance generation unit 114 as already described for the arithmetic logic unit 300 diagrammed in FIG. 5, and there are converted to the distances Dvc31, Dvc32, and Dvc33 between that search point and each of the multi-eyes stereo cameras 11, 12, and 13.

(3) Object detection unit 143

The object detection unit 143 inputs the stereo data output from the multi-eyes stereo data memory unit 115 and the distances Dvc31, Dvc32, and Dvc33 output from the distance generation unit 114. As described earlier, the viewpoint coordinate system generation unit 141 changes the distance coordinate d34 in the viewpoint coordinate system and moves the search point, for each of the pixel coordinates (i34, j34) in the target image. For that reason, from the multi-eyes stereo data memory unit 115, stereo data for a plurality of search points having a different distance d34 in the viewpoint coordinate system, corresponding to the coordinates (i34, j34) of each of the pixels in the target image, will be continuously output. The object detection unit 143, for each of the pixel coordinates (i34, j34) in the target image, collects the stereo data for the plurality of search points of different distance d34 input continuously in that manner, and, using the stereo data on that plurality of search points, determines which of that plurality of search points is a search point wherein the outer surface of the object 10 exists. It then outputs the brightness corresponding to that determined search point as the brightness of the coordinates (i34, j34) for that pixel. The method for determined which search point the outer surface of the object 10 exists in may be a method described below, for example.

(1) For each search point, the distribution value for the brightness Im1(i31, j31), Im2(i32, j32), and Im3(i33, j33) for the corresponding pixels (i31, j31), (i32, j32), and (i33, j33) obtained from the three multi-eyes stereo processing units 61, 62, and 63 is found. Then, the one search point that among the plurality of search points corresponding to the same pixel coordinates (i34, j34) has the smallest distribution value is selected as the search point where the outer surface of the object 10 exists.

(2) Alternatively, for each search point, a window of a prescribed size centered on the corresponding pixel (i31, j31), (i32, j32), and (i33, j33) respectively is set in each of the three images output from the three multi-eyes stereo processing units 61, 62, and 63, and the brightness of all of the pixels in those three windows are input to the object detection unit 143. Then, the distribution values of the brightness of the pixels for which the pixel coordinates match between those three windows are determined, and the average value of those distribution values in the windows is found. Then the search point of the plurality of search points corresponding to the same pixel coordinates (i34, j34) for which that average value is the smallest is selected as the search point wherein the outer surface of the object 10 exists.

(3) Alternatively, for each of the search points, the absolute value Dad31 of the difference between the distance D1(i31, j31) measured by the first multi-eyes stereo processing unit 61 and the distance Dvc31 measured by the distance generation unit 114 on the basis of the coordinates (x34, y34, z34) is found. Similarly, for each of the search points, the absolute values Dad32 and Dad33 between the distance measured by the distance generation unit 114, on the one hand, and the distances measured by the second and third multi-eyes stereo processing units 62 and 63, on the other, respectively, are found. Then, the one search point of the plurality of search points corresponding to the same pixel coordinates (i34, j34) for which the sum of the three distance differences Dad31, Dad32, and Dad33 is the smallest is selected as the search point where the outer surface of the object 10 exists.

(4) Alternatively, for each of the search points, the coordinates (x31, y31, z31) in the overall coordinate system for the point indicated by the distance D1(i31, j31) in the corresponding pixel coordinate (i31, j31) measured by the first multi-eyes stereo processing unit 61 are found. Similarly, for each search point, the coordinates (x32, y32, z32) and (x33, y33, z33) in the overall coordinate system for the point(s) indicated by the output of the distances in the corresponding pixel coordinates measured by the second and third multi-eyes stereo processing units 62 and 63, respectively, are found. Then, for each search point, the distribution value of the x components x31, x32, and x33, the distribution value of the y components y31, y32, and y33, and the distribution value of the z components z31, z32, and z33 between those three sets of coordinates are found, and the average value of those distribution values is found. That average value indicates the degree of matching in the overall coordinate system for the points indicated by the distances measured by the three multi-eyes stereo processing units 61, 62, and 63 for the pixel coordinates corresponding to the same search point. That is, the smaller that average value, the higher the degree of matching. Thereupon, the one search point among the plurality of search points corresponding to the same pixel coordinates (i34, j34) for which the average value described above is the smallest is selected as the search point where the outer surface of the object 10 exists.

(5) In (4) above, the degree of matching for one pixel to which the distance images from the three multi-eyes stereo processing units 61, 62, and 63 together correspond was found, but windows of some size in those distance images may be set and the degree of matching between those windows found. That is, for each search point, a window of a prescribed size centered on the corresponding pixel coordinates (i31, j31) in the distance image from the first multi-eyes stereo processing unit 61 is set, and the distances of all of the pixels inside that window are input to the object detection unit 143. Similarly, from the distance images from the second and third multi-eyes stereo processing units 62 and 63 also, the distances of all the pixels in windows centered on the corresponding pixel coordinates are input to the object detection unit 143. Then, for the pixels in these three windows, coordinates in the overall coordinate system indicated by that distance information are found. Then distribution values for each component in the overall coordinate system corresponding to the same pixel coordinates, between those three windows, are found, and the average value of those distribution values is found. That average value is found also for all of the pixels in the windows, and the sum thereof is found. Then that one search point among the plurality of search points corresponding to the same pixel coordinates (i34, j34) for which that sum is the smallest is selected as the search point wherein the outer surface of the object 10 exists.

(6) Alternatively, for each search point, the distribution values of the reliabilities Re1(i31, j31), Re2(i32, j32), and Re3(i33, j33) from the three multi-eyes stereo processing units 61, 62, and 63 are found. Then the one search point among the plurality of search points corresponding to the same pixel coordinates (i34, j34) for which that distribution value is the smallest is selected as the search point wherein the outer surface of the object 10 exists.

When one search point wherein the outer surface of the object 10 exists has been determined for some set of pixel coordinates (i34, j34) inside the target image by a method such as any of those described above, the object detection unit 143 next outputs the average value of three brightness Im1(i31, j31), Im2(i32, j32), and Im3(i33, j33) for that one determined search point (or the brightness corresponding to the shortest distance among the distances D1(i32, j31), D2(i32, j32), and D3(i33, j33) for that one selected search point) as the brightness Im(i34, j34) of the pixel coordinates (i34, j34) at issue in the target image.

(4) Target image display unit 144

The brightness Im(i34, j34) for the pixel coordinates (i34, j34) output from the object detection unit 143 for all of the pixels are collected, and the target image is produced and output to the television monitor 19. The target image is updated for each frame of the moving images from the multi-eyes stereo cameras 11, 12, and 13, wherefore, on the television monitor 19, images will be displayed that change so as to follow the motion of the object 10 and the movements of the viewpoint 40 in real time.

With the arithmetic logic unit 500 diagrammed in FIG. 7 and described in the foregoing, modeling of the object 10 is eliminated, wherefore the processing time is shortened by that measure.

With the arithmetic logic units 18, 200, 300, and 400 diagrammed in FIG. 2, 4, 5, and 6, on the other hand, a complete three-dimensional model of the object 10 is produced by the modeling and display unit 78 (a three-dimensional model which in fact moves so as to follow the motion of the object 10 in real time), wherefore it is possible to make the configuration such that that three-dimensional model is extracted and imported to another graphic processing apparatus (such as a game program for performing computer three-dimensional animation). When that is done, applications are possible wherewith the three-dimensional model of the object 10 is displayed moving in another graphic processing apparatus (such, for example, as applications that import the three-dimensional model of a real game player that is the object 10 into the game program noted above, such that that three-dimensional model takes part in the virtual world displayed by that game program while moving in the same way as the game player).

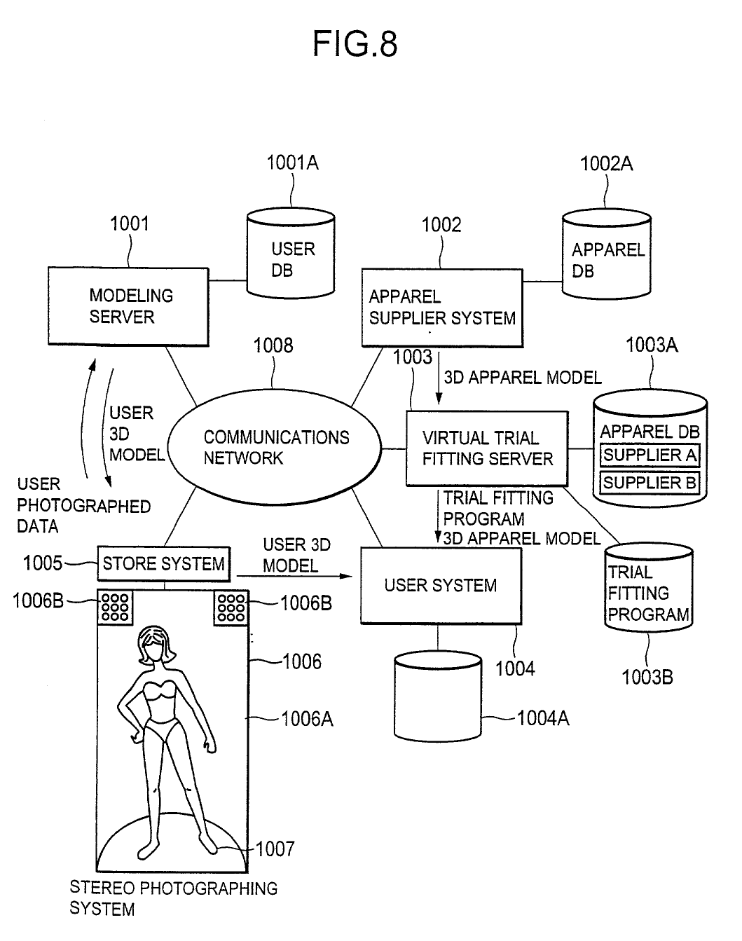

FIG. 8 represents the overall configuration of a virtual trial fitting system relating to a sixth embodiment aspect of the present invention.

A modeling server 1001, a computer system controlled by an apparel supplier such as an apparel manufacturer or apparel retailer (hereinafter called the “apparel supplier system”) 1002, a virtual trial fitting server 1003, a user computer system (being a personal computer or game computer or the like, hereinafter called the “user system”) 1004, and a computer system installed in a store such as a department store, game center, or convenience store or the like (hereinafter called the “store system”) 1005 are connected, so that they can communicate with each other, via a communications network 1008 such as the internet. In FIG. 8, only one each of the modeling server 1001, apparel supplier system 1002, virtual trial fitting server 1003, user system 1004, and store system 1005, respectively, is indicated in the diagram, but those, respectively, may be plural in number. In particular, the apparel supplier system 1002, user system 1004, and store system 1005 will usually exist in plural numbers according to the numbers of the apparel suppliers, users, and stores, respectively.

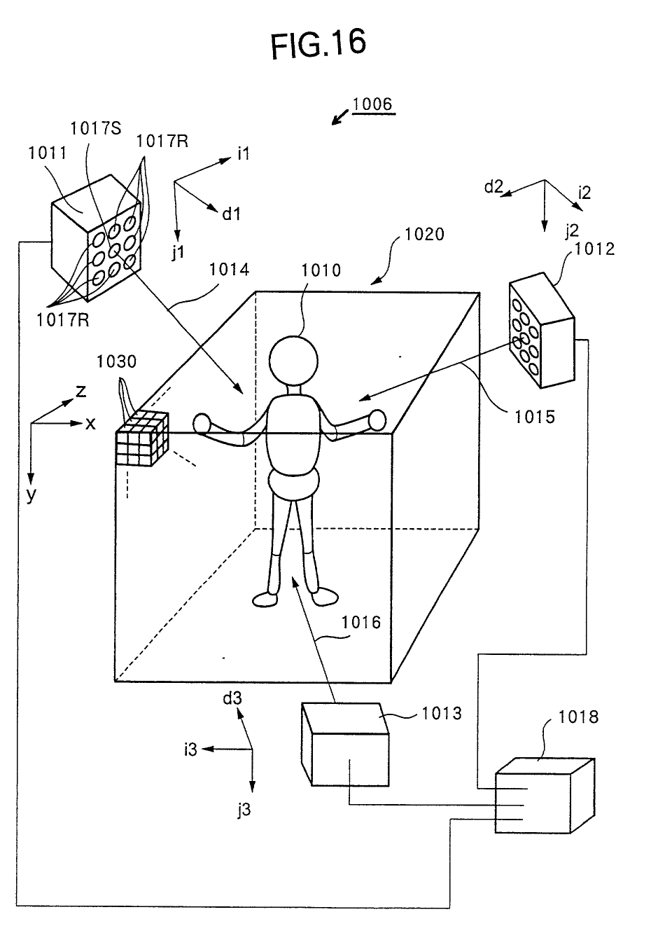

In each of the stores such as the department stores, game centers, and convenience stores and the like, moreover, a stereo photographing system 1006 that is connected to the store system 1005 is installed. The stereo photographing system 1006, as will be described in detail subsequently with reference to FIG. 16, is a facility that comprises a space 1006A such as a room large enough for a user 1007 to enter and assume various poses, and a plurality of multi-eyes stereo cameras 1006B, 1006B, . . . deployed about the periphery of that space 1006A so as to be able to photograph that space 1006A. Each of the multi-eyes stereo cameras 1006B is configured, for example, by nine video cameras arranged in a 3×3 matrix. The photographed data output from those nine cameras are used in the production of distance images for the photographing subject using a stereo viewing method, as will be described subsequently. When the user 1007 enters the space 1006A of the stereo photographing system 1006, as diagrammed, and that user 1007 is photographed by the plurality of multi-eyes stereo cameras 1006B, 1006B, . . . , the photographed data of the body of the user 7 photographed by those multi-eyes stereo cameras 1006B, 1006B, . . . are sent to the store system 1005.

The store system 1005 takes the photographed data of the user's body received from the stereo photographing system 1006 and sends them to the modeling server 1001 via the communications network 1008. The modeling server 1001 produces three-dimensional modeling data for the user's body, using the photographed data of the user's body received from the store system 1005, by performing processing that will be described in detail subsequently with reference to FIG. 16 to 20. The modeling server 1001 stores the produced three-dimensional model data of the user's body in a user database 1001A, and then transmits those three-dimensional model data of the user's body via the communications network 1008 to the store system 1005. The store system 1005 sends those three-dimensional model data of the user's body via the communications network 1008 (or via a transportable recording medium such as a recording disk) to the user system 1004. Or, alternatively, provision may be made so that the modeling server 1001, when so requested by the user system 1004, transmits the three-dimensional model data of the user's body stored in the user database 1001A directly to the user system 1004 via the communications network 1008.

It is also possible for the user himself or herself to possess the stereo photographing system 1006. In that case, he or she need only deploy the plurality of (two or three, for example) multi-eyes stereo cameras 1006B, 1006B, . . . in his or her own room, and make provision so that the photographed data from those multi-eyes stereo cameras 1006B, 1006B, . . . are sent via the user system 1004 to the modeling server 1001. At the time of this filing the price of a multi-eyes stereo camera 1006B itself was below ¥100,000, and will probably decline even farther in the future, wherefore the number of users that would be able to have their own stereo photographing system 1006 will probably be increasing from this point in time on.

Now, the apparel supplier system 1002 produces three-dimensional model data of various apparel items (clothing, shoes, hats, accessories, bags, etc.) supplied by that apparel supplier, accumulates those data in the apparel database 1002A, and sends those apparel three-dimensional model data to the virtual trial fitting server 1003 via the communications network 1008 or via a disk recording medium or the like. Alternatively, the apparel supplier system 1002 may photograph apparel (or a person wearing that apparel) with a stereo photographing system that is the same as or similar to the stereo photographing system 1006 of the store, send those photographed data to the modeling server 1001, and have the modeling server 1001 produce three-dimensional model data for that apparel, then have the three-dimensional model data for that apparel received from the modeling server 1001 and sent to the virtual trial fitting server 1003 (or, alternatively, have those data sent directly from the modeling server 1001 to the virtual trial fitting server 1003 via the communications network 1008).

The virtual trial fitting server 1003 might be the website of a department store or clothing store, for example. Thereupon, three-dimensional model data of various apparel items received from the apparel supplier system 1002, etc., are accumulated in the apparel database 1003A supplier by supplier, or there is a virtual trial fitting program 1003B that can be run on the user system 1004. Then, when requested by the user system 1004, the virtual trial fitting server 1003 sends the three-dimensional model data for those various apparel items and the virtual trial fitting program to the user system 1004 via the communications network 1008.

The user system 1004 installs the three-dimensional model data of the user's body received from the modeling server 1001, and the three-dimensional model data for the various apparel items and virtual trial fitting program received from the virtual trial fitting system 1003 on a hard disk drive or other auxiliary memory device 1004A, and then runs the virtual trial fitting program according to the directions of the user. The three-dimensional model data of the user's body and the three-dimensional apparel model data are made in a prescribed data format that can be imported into the virtual three-dimensional space by the virtual trial fitting program. The virtual trial fitting program imports the three-dimensional model data of the user's body and the three-dimensional model data for various apparel into the virtual three-dimensional space, dresses the three-dimensional model of the user with preferred apparel, causes preferred poses to be assumed and preferred motion to be performed, renders images of that figure as seen from preferred viewpoints, and displays those images on a display screen. The virtual trial fitting program, moreover, by using known art to map any color or texture to any site in the three-dimensional model data of the user's body or apparel, can simulate appearances in various cases, such as when the model has been suntanned, or has put on various kinds of cosmetics, or has dyed his or her hair, or has changed the color of his or her clothes, etc. Or, using known art to subject the three-dimensional model data of the user's body to enlargement, reduction, deformation, or replacement with another model, appearances can be simulated such as when the model has become heavier, has become thinner, has grown in stature, or has altered his or her hair style, etc. The virtual trial fitting program can also accept orders for any apparel from the user and send those orders to the virtual trial fitting server 1003.

According to this virtual trial fitting system, the user, even though not having his or her own equipment for three-dimensional modeling, nevertheless can, by going to a department store, game center, or convenience store and photographing his or her own body with the stereo photographing system 1006 installed there, have three-dimensional model data of his or her own body made, import those data into his or her own computer, and, using those three-dimensional model data for himself or herself, try on various apparel items at a high reality level in the virtual three-dimensional space of the computer. In addition, as will be described subsequently, it is possible to use those three-dimensional model data of himself or herself not only for virtual trial fitting, but also by importing and using those data in the virtual three-dimensional space of direct-involvement games and other applications. Also, if user photographed data or three-dimensional model data based thereon are acquired and employed, with the consent of the user and in a way that does not infringe on the privacy of the user, it becomes possible to design and manufacture apparel ideally suited to the body of the user, at lower than conventional cost, or to develop and design new apparel that is more advanced in terms of human engineering, based on detailed data on the human body not obtainable by ordinary measurement taking.

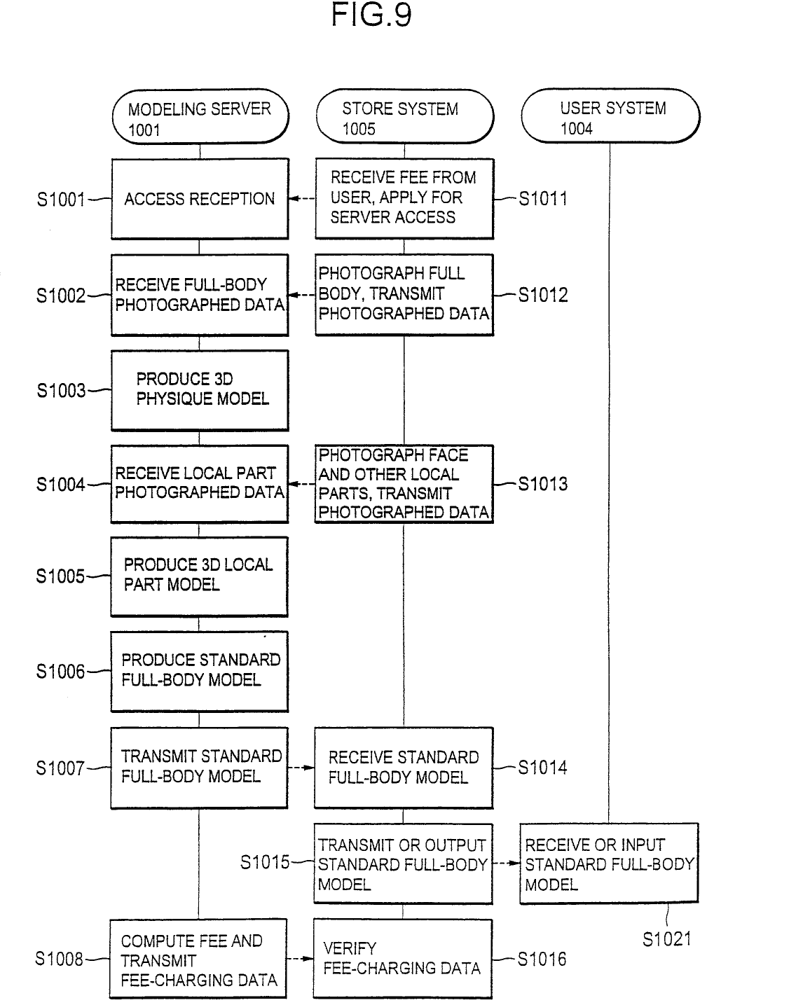

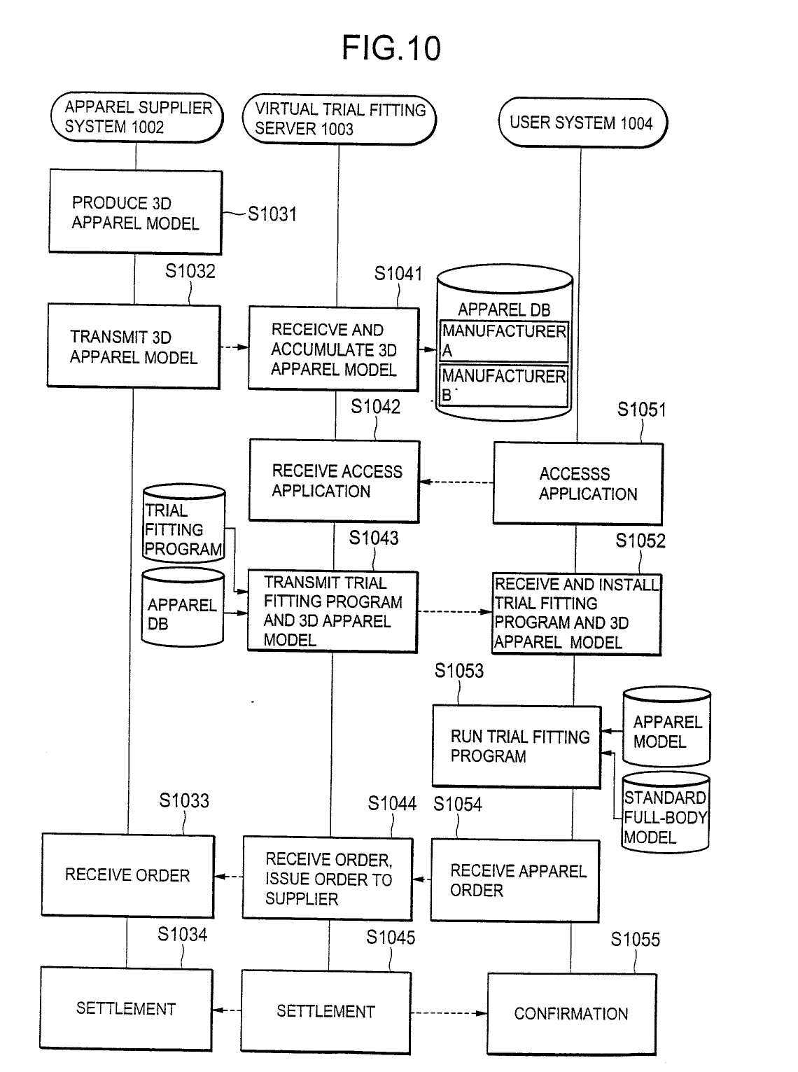

FIG. 9 and FIG. 10 represent the processing procedures for this virtual trial fitting system in greater detail. FIG. 9 represents processing procedures for producing three-dimensional model data for a user's body performed centrally by the modeling server 1001. FIG. 10 represents processing procedures for performing virtual trial fitting on a user system, centrally by the virtual trial fitting server 1003.

First, the processing procedures for producing three-dimensional model data for a user's body are described with reference to FIG. 8 and FIG. 9.

(1) As diagrammed in FIG. 6, a user 1007 goes to a store such as a department store, game center, or convenience store, pays a fee, and enters a stereo photographing system 1006 located there wearing as little as possible.

(2) As diagrammed in FIG. 9, the store system 1005, upon receiving the fee from the user, requests access to the modeling server 1001 (step S1011), and the modeling server 1001 accepts access from the store system 1005 (S1001).

(3) At the store system 1005 end, the full-length body of the user is photographed with the stereo photographing system 1006, and the resulting full-body photographed data are transmitted to the modeling server 1001 (S1012). The modeling server 1001 receives those full-body photographed data (S1002).

(4) The modeling server 1001, based on the received full-body photographed data, produces three-dimensional physique model data representing the full-body shape of the user (S1003).

(5) On the store system 1005 end, with the stereo photographing system 1006, photographing is performed on the local parts that need to be modeled in greater detail then the full body, typically the user's face, and photographed data for those local parts are transmitted to the modeling server 1001 (S1013). The modeling server 1001 receives those local part photographed data (S1004). Also, this local part photographing may be performed by a method that photographs only the local parts with a higher magnification or higher resolution than the full body, separately from the photographing of the full body, or, alternatively, by a method that simultaneously photographs the full body and the local parts by photographing the full body from the beginning with such high magnification or high resolution as is necessary for the local part photographing. (In the latter case, the data volume for the full body photographed data can be reduced, after photographing, to such low resolution as is necessary and sufficient.)

(6) The modeling server 1001, based on the local part photographed data received, produces three-dimensional local part model data that represents the shape of the local parts, particularly the face, of the user (S1005).

(7) The modeling server 1001, by inserting the corresponding three-dimensional local part model data into the face and other local parts of the three-dimensional physique model data for the full body produces a standard full-body model that represents both the shape of the full body of the user and the detailed shapes of the face and other local parts (S1006). The modeling server 1001 transmits that standard full-body model to the store system 1005 (S1007), and the store system 1005 receives that standard full-body model (S1014).

(8) The store system 1005 either transmits the received standard full-body model to the user system 1004 via the communications network 1008 or outputs it to a transportable recording medium such as a CD-ROM (S1015). The user system 1004 receives that standard full-body model either via the communications network 1008 from the store system 1005 or from the CD-ROM or other transportable recording medium, and stores it (S1021). Thereupon, the user may verify whether or not there are any problems with that standard full-body model by rendering that received standard full-body model with the store system 1005 or the user system 1004 and displaying it on a display screen.

(9) The modeling server 1001, when the store system 1005 has normally received the standard full-body model and verified that there are no problems with that standard full-body model, performs a fee-charging process for collecting a fee from the store (or from the user), and sends the resulting fee-charging data to the store system 1005 (S1008). The store system 1005 receives those resulting fee-charging data (S1016).

Next, the processing procedures for performing virtual trial fitting on a user system are described with reference to FIG. 8 and FIG. 10.

(1) The apparel supplier system 1002 produces three-dimensional model data for various apparel items (S1031), and transmits those data to the virtual trial fitting server 1003 (S1032). The virtual trial fitting server 1003 receives those three-dimensional model data for the various apparel items and accumulates them in the apparel database (S1041).

(2) The user system 1004 requests access to the virtual trial fitting server 1003 at any time (S1051). The virtual trial fitting server 1003, upon receiving the request for access from the user system 1004 (S1042), transmits the virtual trial fitting program and the three-dimensional model data for the various apparel items to the user system 1004 (S1043). The user system 1004 installs the virtual trial fitting program and the three-dimensional model data for the various apparel items received in its own machine so that it can execute the virtual trial fitting program (S1052). Furthermore, there is no reason why the virtual trial fitting program and the three-dimensional apparel model data must always be downloaded from the virtual trial fitting server 1003 to the user system 1004 simultaneously. The virtual trial fitting program and the three-dimensional apparel model data may be downloaded on different occasions, or, alternatively, either one or other or both of the virtual trial fitting program and the three-dimensional apparel model data may be distributed to the user, not via a communications network, but recorded on a CD-ROM or other solid recording medium and installed in the user system 1004.

(3) The user system 1004 runs the virtual trial fitting program at any time (S1053).

(4) The user can input an order for any apparel to the virtual trial fitting program, whereupon the virtual trial fitting program transmits order data for that apparel to the virtual trial fitting server 1003 (S1054).

(5) The virtual trial fitting server 1003, upon receiving order data from the user system 1004, sends the order data for that apparel to the apparel supplier system 1002 of the apparel supplier that provides that apparel (S1044), and then performs processing for the payment of the price and sends such payment related data as an invoice to the user system 1004 or the apparel supplier system (S1045). The apparel supplier system 1002 receives the order data and payment related data and the like from the virtual trial fitting server 1003 and performs the necessary clerical processing (S1033, S1034). The user system 1004 receives the payment related data from the virtual trial fitting server 1003 and obtains confirmation from the user (S1055).

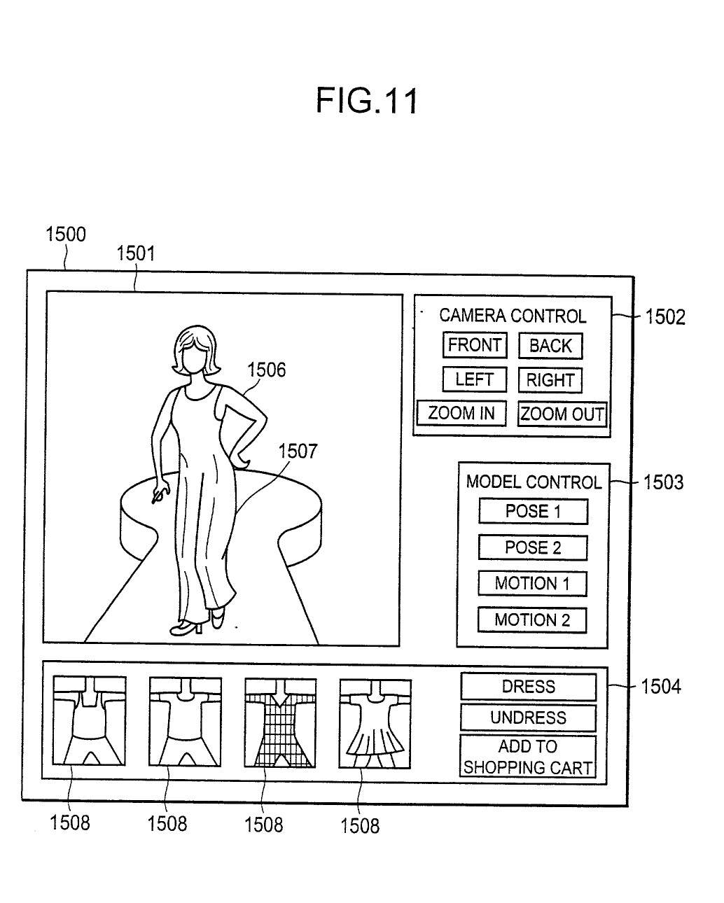

FIG. 11 represents one example of a virtual trial fitting window displayed by a virtual trial fitting program on the display screen of a user system.

In this virtual trial fitting window 1500 are a show stage window 1501, a camera control window 1502, a model control window 1503, and an apparel room window 1504.

The virtual trial fitting program, in virtual three-dimensional space simulating the space on a fashion show stage, stands the standard full-body model 1506 of the user on the stage, causes that standard full-body model 1506 to assume prescribed poses and to perform prescribed motions, renders such into two-dimensional color images photographed at a prescribed zoom magnification with cameras deployed at prescribed positions, and displays those two-dimensional color images on the show stage window 1501 as diagrammed.

In the apparel room window 1504 are displayed two-dimensional color images 1508, 1508, . . . that view the three-dimensional models of various pieces of apparel in basic shapes from the front, and “dress,” “undress,” and “add to shopping cart” buttons. When the user selects any of the apparel images 1508, 1508, . . . displayed in the apparel room window 1504 and hits the “dress” button, the virtual trial fitting program puts a three-dimensional model 1507 of the apparel selected on the standard full-body model 1506 of the user displayed in the show stage window 1501. When the user hits the “undress” button, the virtual trial fitting program removes the three-dimensional model 1507 of the selected apparel from that standard full-body model 1506.

When the user hits the “front,” “back,” “left,” or “right” button in the camera control window 1502, the virtual trial fitting program causes the location of the camera photographing the standard full-body model 1506 of the user in the virtual three-dimensional space to move to the front, back, left, or right, respectively, wherefore the image displayed in the show stage window 1501 will change according to the camera movement. When the user hits the “zoom in” or “zoom out” button in the camera control window 1502, the virtual trial fitting program either increases or decreases the zoom magnification of the camera photographing the standard full-body model 1506 of the user in the virtual three-dimensional space, wherefore the image displayed in the show stage window 1501 will change according to the change in the zoom magnification.

When the user hits the “pose 1” or “pose 2” button in the model control window 1503, the virtual trial fitting program causes the standard full-body model 1506 of the user in the virtual three-dimensional space to assume a pose assigned to “pose 1” or “pose 2,” respectively (such as a “standing at attention” posture or “at ease” posture, etc.). When the user hits the “motion 1” or “motion 2” button in the model control window 1503, the virtual trial fitting program causes the standard full-body model 1506 of the user in the virtual three-dimensional space to perform a motion assigned to “motion 1” or “motion 2,” respectively (such as walking to the front of the stage, turning about, and walking back, or turning around a number of times, etc.). When the standard full-body model 1506 of the user is caused to assume a pose or perform a motion designated by the user in this way, the virtual trial fitting program also moves the three-dimensional model 1507 of the apparel being worn by the standard full-body model 1506 of the user so as to be coordinated with that pose or motion.

Thus the user can put on a fashion show, causing any apparel to be worn by the standard full-body model 1506 of himself or herself, and verify the favorable or unfavorable points of the apparel. When the user selects any one of the apparel images 1508, 1508, . . . from the apparel room window 1504 and hits the “add to shopping cart” button, the virtual trial fitting program adds that selected piece of apparel to the “shopping cart” that is the list of purchase order candidates. Later, if the user opens a prescribed order window (not shown) and performs an order placing operation, the virtual trial fitting program prepares order data for the apparel in the shopping cart and transmits those data to the virtual trial fitting site.

Now, in order to cause the standard full-body model 1506 of the user to assume a plurality of poses and perform a plurality of motions, as diagrammed in FIG. 11, it is necessary that the standard full-body model 1506 of the user be configured so that such is possible. The following two ways of configuring such a standard full-body model 1506, for example, are conceivable.

(1) The standard full-body model 1506 is made of separate cubic models such that the parts of the body thereof are articulated by joints. The cubic models of those parts are turned about those joints as supporting points (that is, bent at the joints), whereby that standard full-body model 1506 can be made to assume various postures.

(2) Standard full-body models 1506 are prepared for each of a plurality of different poses. If the one of that plurality of standard full-body models 1506 having any particular pose is selected and placed in the virtual three-dimensional space, a form assuming that particular pose can be displayed. Also, a form performing any particular motion can be displayed by rapidly placing those multiplicity of standard full-body models 1506 into the virtual three-dimensional space, in the order according to the changes in poses involved in that particular motion.

Of the two methods described above, the method in (2) of preparing a plurality of standard full-body models in different poses can be simply carried out by producing three-dimensional models for each frame in moving images output from a multi-eyes stereo camera, as may be understood from the method of producing three-dimensional models that is described subsequently with reference to FIG. 16 to 20.

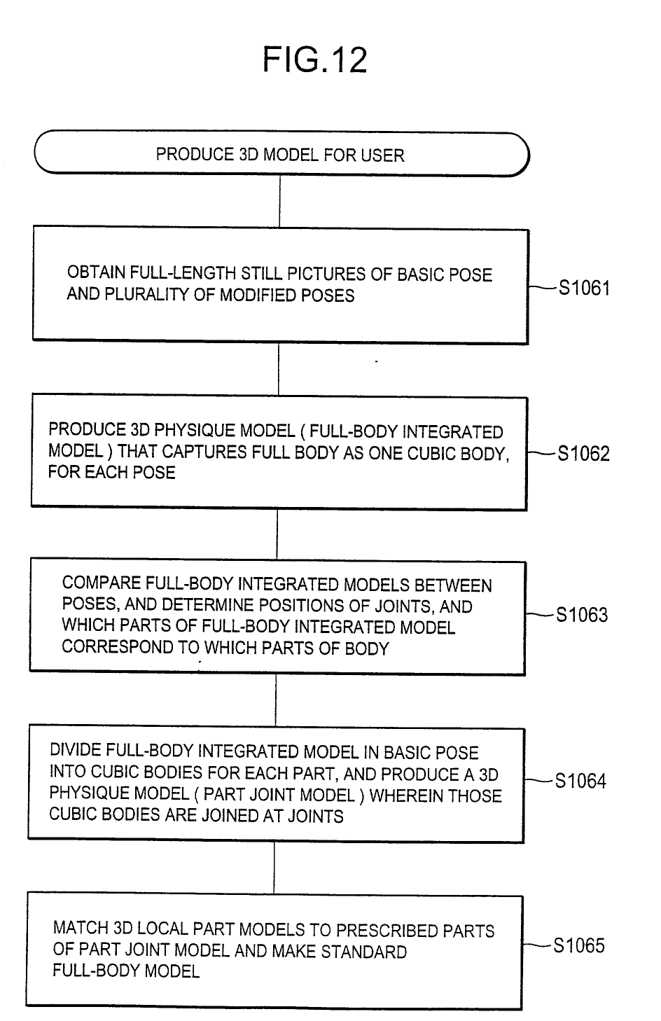

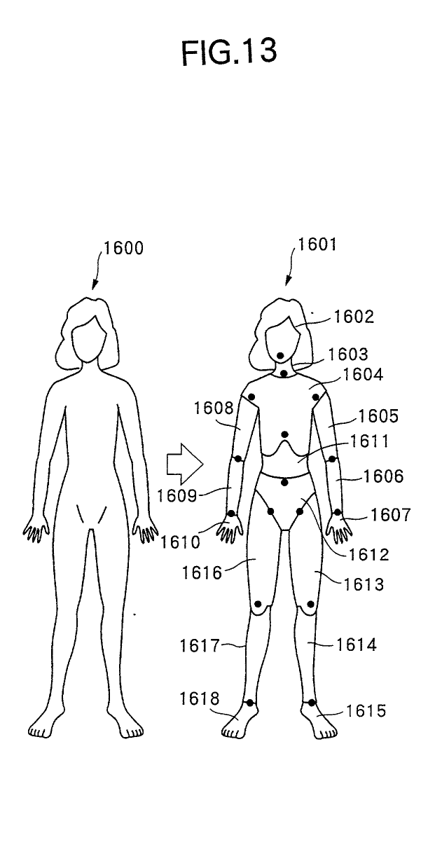

The method in (1) wherein an articulated standard full-body model is produced, on the other hand, can be carried out by processing procedures such as those indicated in FIG. 12 and FIG. 13, for example. Here, FIG. 12 represents the flow of processing performed by a modeling server in order to produce an articulated standard full-body model, and corresponds to steps S1002 to S1006 indicated in FIG. 9 and already described. FIG. 13 represents the configuration of a three-dimensional physique model produced in the course of that processing flow.

As indicated in step S1061 in FIG. 12, the modeling server first receives photographed data from the stereo photographing system when the user has assumed some basic pose and each of a plurality of other modified poses. This corresponds to the receiving of a series of frame images, plural in number, that configure moving images output from the multi-eyes stereo camera when photographing is being performed while the user is performing some motion in the stereo photographing system (that is, to photographed data for multiple poses that change little by little), as will be described with reference to FIG. 16 to 20.

Next, as indicated in step S1062, the modeling server produces, from those photographed data for the differing plurality of poses, three-dimensional model data for the full-length physique of the user for each pose. The three-dimensional physique model data for each pose produced at that time constitute three-dimensional model data that capture the full body of the user as one cubic body (hereinafter called the full-body integrated model), as indicated by the reference number 1600 in FIG. 13.

Next, as indicated in step S1063, the modeling server compares the full-body integrated model 1600 between different poses, and, by detecting the bending points when that is modified, that is, the support points about which the parts turn, the joint positions for the shoulders, elbows, hip joints, and knees, etc., are determined with the full-body integrated model 1600 in the basic pose, for example. Then, a determination is made as to which parts of the body those parts of the full-body integrated model 1600 divided by those joints correspond to, that is, the head, neck, left and right upper arms, left and right lower arms, left and right hands, chest, abdomen, hips, left and right thighs, left and right calves, and left and right feet, etc.

Next, as indicated in step S1064, the modeling server divides the full-body integrated model 1600 in the basic pose into the cubic models for the plurality of parts described earlier and, as indicated by the reference number 1601 in FIG. 13, produces a three-dimensional physique model wherein those cubic models 1602 to 1618 of the various parts are articulated by joints (indicated in the drawing by black dots) (hereinafter called the part joint model).

Next, as indicated in step S1065, the modeling server associates three-dimensional local part models with prescribed parts (such as the face part of the head 1602, for example) of the part joint model 1601 produced, and makes that the standard full-body model of the user.

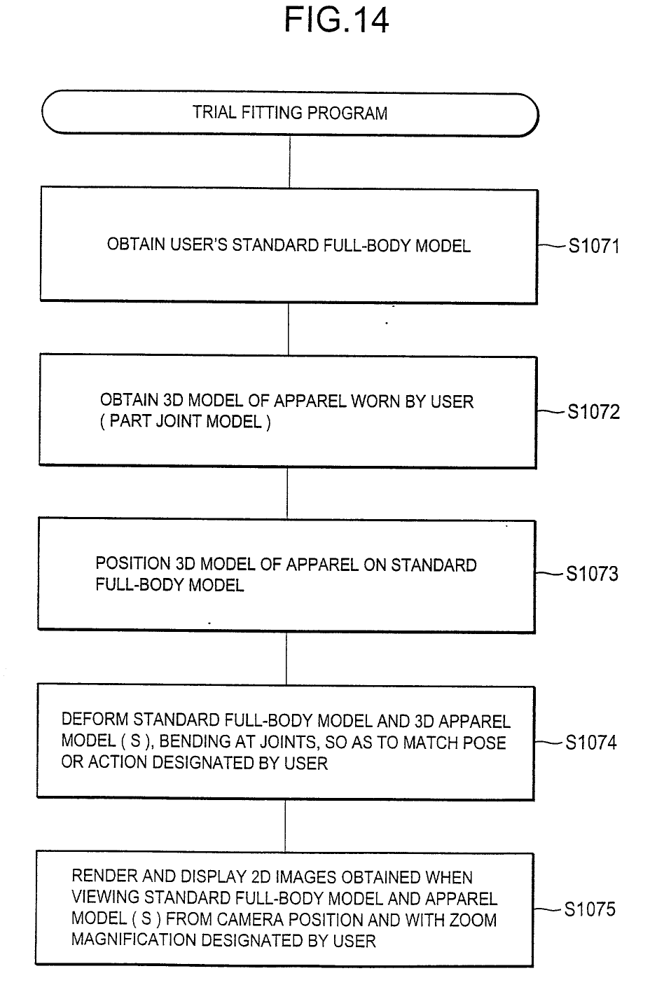

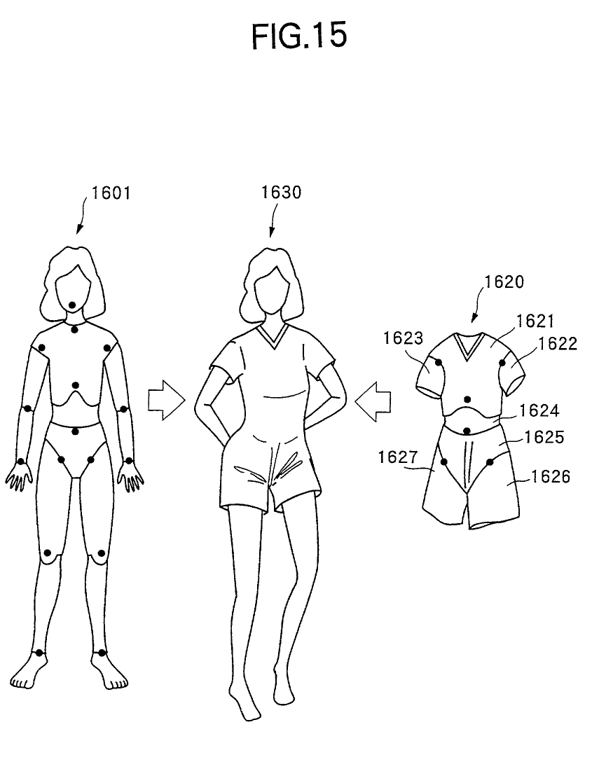

Using a standard full-body model that bends at the joints produced in that manner, the virtual trial fitting program of the user system causes that standard full-body model to assume a plurality of poses and perform a plurality of motions. FIG. 14 represents the process flow of a virtual trial fitting program for that purpose. FIG. 15 describes operations performed on three-dimensional models of apparel and the standard full-body model of the user during the course of that process flow.

As indicated in FIG. 14, the virtual trial fitting program, in step S1071, obtains the standard full-body model 1601 for the user. Also, in step S1072, the virtual trial fitting program obtains the three-dimensional model data for the apparel selected by the user. These three-dimensional apparel model data, as indicated by the reference number 1620 in FIG. 15, are divided into a plurality of parts 1621 to 1627 in the same manner as the standard full-body model of the user, and those parts 1621 to 1627 are configured such that they are articulated by joints indicated by black dots.

Next, as indicated in step S1073, the virtual trial fitting program positions the three-dimensional model data for the apparel to (that is, places the apparel on) the standard full-body model 1601 of the user in the virtual three-dimensional space.

Next, as indicated in step S1074, the virtual trial fitting program progressively deforms the standard full-body model 1601 and the three-dimensional apparel model data 1620, bending them at the joints, so that the standard full-body model 1601 wearing the apparel assumes the poses and performs the motions designated by the user, as indicated by the reference number 1630 in FIG. 15, in the virtual three-dimensional space. Then, as indicated in step S1075, two-dimensional images of the standard full-body model 1601 and the three-dimensional apparel model data 1620 that progressively deform in that manner are rendered, as seen from a user-designated camera position and user-designated zoom magnification, are rendered and displayed on the show stage window 1501 indicated in FIG. 11.

A detailed description is herebelow given of the configuration of the stereo photographing system 1006 diagrammed in FIG. 8. FIG. 16 represents, in simplified form, the overall configuration of this stereo photographing system 1006.

A prescribed three-dimensional space 1020 is established so that the modeling subject 1010 (a person in this example, although it may be any physical object) can be placed therein. About the periphery of this space 1020, at different locations, are fixed multi-eyes stereo cameras 1011, 1012, and 1013. In this embodiment aspect, there are three of these multi-eyes stereo cameras 1011, 1012, and 1013, but this is one preferred example, and any number 2 or greater is permissible. The lines of sight 1014, 1015, and 1016 of these multi-eyes stereo cameras 1011, 1012, and 1013 extend in mutually different directions into the space 1020.

The output signals from the multi-eyes stereo cameras 1011, 1012, and 1013 are input to the arithmetic logic unit 1018. The arithmetic logic unit 1018 produces three-dimensional model data for the object 1010, based on the signals input from the multi-eyes stereo cameras 1011, 1012, and 1013. Here, the arithmetic logic unit 1018 is represented in the drawing as a single block for convenience, but connotes the functional components that perform three-dimensional modeling, formed by the combination of the virtual trial fitting system and store system 1005 diagrammed in FIG. 8.

Each of the multi-eyes stereo cameras 1011, 1012, and 1013 comprises independent video cameras 1017S, 1017R, . . . , 1017R, the positions whereof are relatively different and the lines of sight whereof are roughly parallel, the number whereof is 3 or more, and preferably 9, arranged in a 3×3 matrix pattern. The one video camera 1017S positioned in the middle of that 3×3 matrix is called the “main camera.” The eight video cameras 1017R, . . . , 1017R positioned about that main camera 1017S are called “reference cameras”. The main camera 1017S and one reference camera 1017R constitute a minimum unit, or one pair of stereo cameras. The main camera 1017S and the eight reference cameras 1017R configure eight pairs of stereo cameras arranged in radial directions centered on the main camera 1017S. These eight pairs of stereo cameras make it possible to compute stable distance data relating to the object 1010 with high precision. Here, the main camera 1017S is a color or black and white camera. When color images are to be displayed on the television monitor 1019, a color camera is used for the main camera 1017S. The reference cameras 1017R, . . . , 1017R, on the other hand, need only be black and white cameras, although color cameras may be used also.

Each of the multi-eyes stereo cameras 1011, 1012, and 1013 outputs nine moving images from the nine video cameras 1017S, 1017R, . . . , 1017R. First, the arithmetic logic unit 1018 fetches the latest frame image (still image) of the nine images output from the first multi-eyes stereo camera 1011, and, based on those nine still images (that is, on the one main image from the main camera 1017S and the eight reference images from the eight reference cameras 1017R, . . . , 1017R), produces the latest distance image of the object 1010 (that is, an image of the object 1010 represented at the distance from the main camera 1017S), by a commonly known multi-eyes stereo viewing method. The arithmetic logic unit 1018, in parallel with that described above, using the same method as described above, produces latest distance images of the object 1010 for the second multi-eyes stereo camera 1012 and for the third multi-eyes stereo camera 1013 also. Following thereupon, the arithmetic logic unit 1018 produces the latest three-dimensional model of the object 1010, by a method described further below, using the latest distance images produced respectively for the three multi-eyes stereo cameras 1011, 1012, and 1013.

The arithmetic logic unit 1018 repeats the actions described above every time it fetches the latest frame of a moving image from the multi-eyes stereo cameras 1011, 1012, and 1013, and produces a three-dimensional model of the object 1010 for every frame. Whenever the object 1010 moves, the latest three-dimensional model produced by the arithmetic logic unit 1018 changes, following such motion of the object, in real time or approximately in real time.

A detailed description is now given of the internal configuration and operation of the arithmetic logic unit 1018.

In the arithmetic logic unit 1018, the plurality of coordinate systems described below is used. That is, as diagrammed in FIG. 16, in order to process an image from the first multi-eyes stereo camera 1011, a first camera Cartesian coordinate system i1, j1, d1 having coordinate axes matched with the position and direction of the first multi-eyes stereo camera 1011 is used. Similarly, in order to respectively process images from the second multi-eyes stereo camera 1012 and the third multi-eyes stereo camera 1013, a second camera Cartesian coordinate system i2, j2, d2 and a third camera Cartesian coordinate system i3, j3, d3 matched to the positions and directions of the second multi-eyes stereo camera 1012 and the third multi-eyes stereo camera 1013, respectively, are used. Furthermore, in order to define positions inside the space 1020 and process a three-dimensional model for the object 1010, a prescribed single overall Cartesian coordinate system x, y, z is used.

The arithmetic logic unit 1018 also, as diagrammed in FIG. 16, virtually finely divides the entire region of the space 1020 into Nx, Ny, and Nz voxels 1030, . . . , 1030 respectively along the coordinate axes of the overall coordinate system x, y, z (a voxel connoting a small cube). Accordingly, the space 1020 is configured by Nx×Ny×Nz voxels 1030, . . . , 1030. The three-dimensional model of the object 1010 is made using these voxels 1030, . . . , 1030. Hereafter, the coordinates of each voxel based on the overall coordinate system x, y, z are represented (vx, vy, vz).

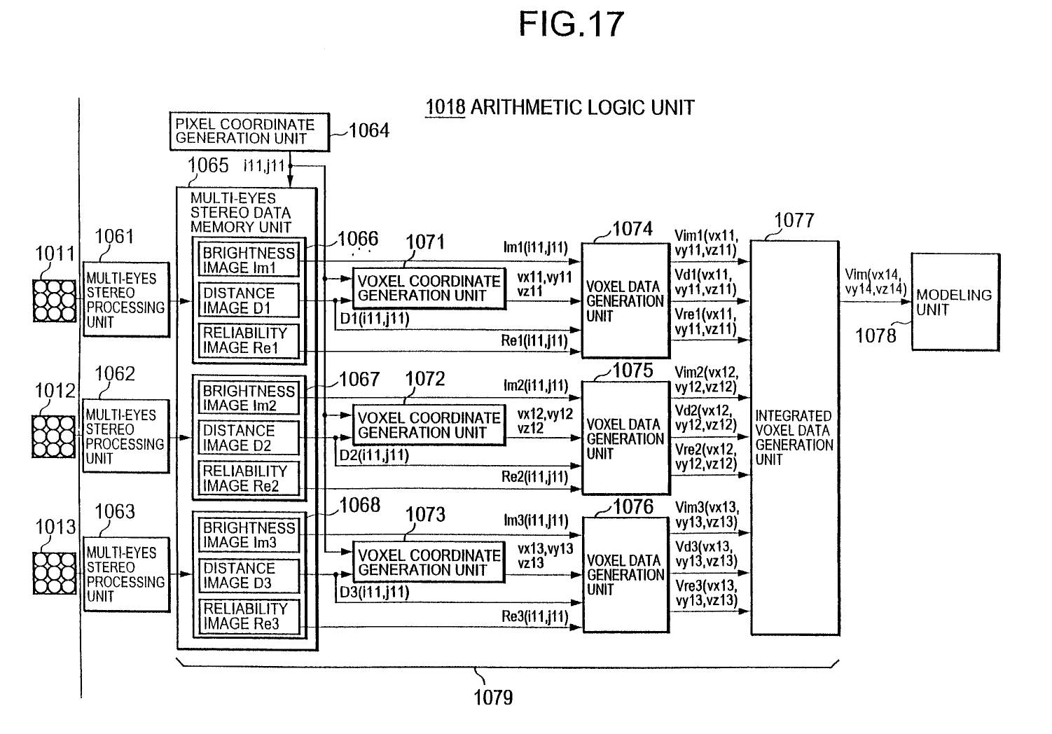

In FIG. 17 is represented the internal configuration of the arithmetic logic unit 1018.

The arithmetic logic unit 1018 has multi-eyes stereo processing units 1061, 1062, and 1063, a pixel coordinate generation unit 1064, a multi-eyes stereo data memory unit 1065, voxel coordinate generation units 1071, 1072, and 1073, voxel data generation units 1074, 1075, and 1076, an integrated voxel data generation unit 1077, and a modeling unit 1078. As already described, moreover, in the virtual trial fitting system diagrammed in FIG. 8, the arithmetic logic unit 1018 is configured by a store system 1005 and a modeling server 1001. Therefore, various different aspects can be adopted in terms of which of this plurality of configuring elements 1061 to 1068 of the arithmetic logic unit 1018 are handled by the store system 1005 and which are handled by the modeling server 1001. The processing functions of these configuring elements 1061 to 1078 are described below.

(1) Multi-eyes stereo processing units 1061, 1062, 1063

The multi-eyes stereo processing units 1061, 1062, and 1063 are connected on a one-to-one basis to the multi-eyes stereo cameras 1011, 1012, and 1013. Because the functions of the multi-eyes stereo processing units 1061, 1062, and 1063 are mutually the same, a representative description is given for the first multi-eyes stereo processing unit 1061.

The multi-eyes stereo processing unit 1061 fetches the latest frames (still images) of the nine moving images output by the nine video cameras 1017S, 1017R, . . . , 1017R, from the multi-eyes stereo camera 1011. These nine still images, in the case of black and white cameras, are gray-scale brightness images, and, in the case of color cameras, are three-color (R, G, B) component brightness images. The R, G, B brightness images, if they are integrated, become gray-scale brightness images as with the black and white cameras. The multi-eyes stereo processing unit 1061 makes the one brightness image from the main camera 1017S (as it is in the case of a black and white camera; made gray-scale by integrating the R, G, and B in the case of a color camera) the main image, and makes the eight brightness images from the other eight reference cameras (which are black and white cameras) 1017R, . . . , 1017R reference images. The multi-eyes stereo processing unit 1061 then makes pairs of each of the eight reference images, on the one hand, with the main image, on the other (to make eight pairs), and, for each pair, finds the parallax between the two brightness images, pixel by pixel, by a prescribed method.

Here, for the method for finding the parallax, the method disclosed in Japanese Patent Application Laid-Open No. H11-175725/1999, for example, can be used. The method disclosed in Japanese Patent Application Laid-Open No. H11-175725/1999, simply described, is as follows. First, one pixel on the main image is selected, and a window region having a prescribed size (3×3 pixels, for example) centered on that selected pixel is extracted from the main image. Next, a pixel (called the corresponding candidate point) at a position shifted away from the aforesaid selected pixel on the reference image by a prescribed amount of parallax is selected, and a window region of the same size, centered on that corresponding candidate point, is extracted from the reference image. Then the degree of brightness pattern similarity is computed between the window region at the corresponding candidate point extracted from the reference image and the window region of the selected pixel extracted from the main image (as, for example, the inverse of the square added value of the difference in brightness between positionally corresponding pixels in the two window regions, for example). While sequentially changing the parallax from the minimum value to the maximum value and moving the corresponding candidate point, for each individual corresponding candidate point, the computation of the degree of similarity between the window region at that corresponding candidate point and the window region of the pixel selected from the main image is repeatedly performed. From the results of those computations, the corresponding candidate point for which the highest degree of similarity was obtained is selected, and the parallax corresponding to that corresponding candidate point is determined to be the parallax in the pixel selected as noted above. Such parallax determination is done for all of the pixels in the main image. From the parallaxes for the pixels in the main image, the distances between the main camera and the portions corresponding to the pixels of the object are determined on a one-to-one basis. Accordingly, by computing the parallax for all of the pixels in the main image, as a result thereof, distance images are obtained wherein the distance from the main camera to the object is represented for each pixel in the main image.

The multi-eyes stereo processing unit 1061 computes distance images by the method described above for each of the eight pairs, then integrates the eight distance images by a statistical procedure (computing by averaging, for example), and outputs that result as the final distance image D1. The multi-eyes stereo processing unit 1061 also outputs a brightness image Im1 from the main camera 1017S. The multi-eyes stereo processing unit 1061 also produces and outputs a reliability image Re1 that represents the reliability of the distance image D1. Here, by the reliability image Re1 is meant an image that represents, pixel by pixel, the reliability of the distance represented, pixel by pixel, by the distance image D1. For example, it is possible to compute the degree of similarity for each parallax while varying the parallax as described earlier for the pixels in the main image, then, from those results, to find the difference in the degrees of similarity between the parallax of the highest degree of similarity and the parallaxes adjacent thereto before and after, and to use that as the reliability of the pixels. In the case of this example, the larger the difference in degree of similarity, the higher the reliability.

Thus, from the first multi-eyes stereo processing unit 1061, three types of output are obtained, namely the brightness image Im1, the distance image D1, and the reliability image Re1, as seen from the position of the first multi-eyes stereo camera 1011. Accordingly, from the three multi-eyes stereo processing units 1061, 1062, and 1063, the brightness images Im1, Im2, and Im3, the distance images D1, D2, and D3, and the reliability images Re1, Re2, and Re3 are obtained from the three camera positions (with the term “stereo output image” used as a general term for images output from these multi-eyes stereo processing units).

(2) Multi-eyes stereo data memory unit 1065

The multi-eyes stereo data memory unit 1065 inputs the stereo output images from the three multi-eyes stereo processing units 1061, 1062, and 1063, namely the brightness images Im1, Im2, and Im3, the distance images D1, D2, and D3, and the reliability images Re1, Re2, and Re3, and stores those stereo output images in memory areas 1066, 1067, and 1068 that correspond to the multi-eyes stereo processing units 1061, 1062, and 1063, as diagrammed. The multi-eyes stereo data memory unit 1065, when coordinates indicating pixels to be processed (being coordinates in the camera coordinate systems of the multi-eyes stereo cameras 1011, 1012, and 1013 indicated in FIG. 16, hereinafter indicated by (i11, j11)) are input from the pixel coordinate generation unit 1064, reads out and outputs the values of the pixel indicated by those pixel coordinates (i11, j11) from the brightness images Im1, Im2, and Im3, the distance images D1, D2, and D3, and the reliability images Re1, Re2, and Re3.

That is, the multi-eyes stereo data memory unit 1065, when the pixel coordinates (i11, j11) are input, reads out the brightness Im1(i11, j11), distance D1(i11, j11), and reliability Re1(i11, j11) of the pixel corresponding to the coordinates (i11, j11) in the first camera coordinate system i1, j1, d1 from the main image Im1, distance image D1, and reliability image Re1 of the first memory area 1066, reads out the brightness Im2(i11, j11), distance D2(i11, j11), and reliability Re2(i11, j11) of the pixel corresponding to the coordinates (i11, j11) in the second camera coordinate system i2, j2, d2 from the main image Im2, distance image D2, and reliability image Re2 of the second memory area 1067, reads out the brightness Im3(i11, j11), distance D3(i11, j11), and reliability Re3(i11, j11) of the pixel corresponding to the coordinates (i11, j11) in the third camera coordinate system i3, j3, d3 from the main image Im3, distance image D3, and reliability image Re3 of the third memory area 1068, and outputs those values.

(3) Pixel coordinate generation unit 1064

The pixel coordinate generation unit 1064 generates coordinates (i11, j11) that indicate pixels to be subjected to three-dimensional model generation processing, and outputs those coordinates to the multi-eyes stereo data memory unit 1065 and to the voxel coordinate generation units 1071, 1072, and 1073. The pixel coordinate generation unit 1064, in order to cause the entire range or a part of the range of the stereo output images described above to be raster-scanned, for example, sequentially outputs the coordinates (i11, j11) of all of the pixels in that range.

(4) Voxel coordinate generation units 1071, 1072, and 1073

Three voxel coordinate generation units 1071, 1072, and 1073 are provided corresponding to the three multi-eyes stereo processing units 1061, 1062, and 1063. The functions of the three voxel coordinate generation units 1071, 1072, and 1073 are mutually identical, wherefore the first voxel coordinate generation unit 1071 is described representatively.

The voxel coordinate generation unit 1071 inputs the pixel coordinates (i11, j11) from the pixel coordinate generation unit 1064, and inputs the distance D1(i11, j11) read out from the memory area 1066 that corresponds to the multi-eyes stereo data memory unit 1065 for those pixel coordinates (i11, j11). The input pixel coordinates (i11, j11) and the distance D1(i11, j11) represent the coordinates of one place on the outer surface of the object 1010 based on the first camera coordinate system i1, j1, d1. That being so, the voxel coordinate generation unit 1071 performs processing to convert coordinate values in the first camera coordinate system i1, j1, d1 incorporated beforehand to coordinate values in the overall coordinate system x, y, z, and converts the pixel coordinates (i11, j11) and distance D1(i11, j11) based on the first camera coordinate system i1, j1, d1 input to coordinates (x11, y11, z11) based on the overall coordinate system x, y, z. Next, the voxel coordinate generation unit 1071 determines whether or not the converted coordinates (x11, y11, z11) are contained in which voxel 1030 in the space 1020, and, when such are contained on some voxel 1030, outputs the coordinates (vx11, vy11, vz11) of that voxel 1030 (that meaning one voxel wherein it is estimated that the outer surface of the object 1010 exists). When the coordinates (x11, y11, z11) after conversion are not contained in any voxel 1030 in the space 1020, on the other hand, the voxel coordinate generation unit 1071 outputs prescribed coordinate values (xout, yout, zout) indicating that such are not contained (that is, that those coordinates are outside of the space 1020).

Thus the first voxel coordinate generation unit 1071 outputs voxel coordinates (vx11, vy11, vz11) where is positioned the outer surface of the object 1010 estimated on the basis of an image from the first multi-eyes stereo camera 1011. The second and third voxel coordinate generation units 1072 and 1073 also, similarly, output voxel coordinates (vx12, vy12, vz12) and (vx13, vy13, vz13) where is positioned the outer surface of the object 1010 estimated on the basis of images from the second and third multi-eyes stereo cameras 1012 and 1013.

The three voxel coordinate generation units 1071, 1072, and 1073, respectively, repeat the processing described above for all of the pixel coordinates (i11, j11) output from the pixel coordinate generation unit 1064. As a result, all voxel coordinates where the outer surface of the object 1010 is estimated to be positioned are obtained.

(5) Voxel data generation units 1074, 1075, 1076

Three voxel data generation units 1074, 1075, and 1076 are provided corresponding to the three multi-eyes stereo processing units 1061, 1062, and 1063. The functions of the three voxel data generation units 1074, 1075, and 1076 are mutually identical, wherefore the first voxel data generation unit 1074 is described representatively.

The voxel data generation unit 1074 inputs the voxel coordinates (vx11, vy11, vz11) described earlier from the corresponding voxel coordinate generation unit 1071, and, when the value thereof is not (xout, yout, zout), stores in memory data input from the multi-eyes stereo data memory unit 1065 relating to those voxel coordinates (vx11, vy11, vz11). Those data, specifically, are the set of three types of values, namely the distance D1(i11, j11), brightness Im1(i11, j11), and reliability Re1(i11, j11) of the pixel corresponding to the coordinates (vx11, vy11, vz11) of that voxel. These three types of values are associated with the coordinates (vx11, vy11, vz11) of that voxel, and accumulated, respectively, as the voxel distance Vd1(vx11, vy11, vz11), voxel brightness Vim1(vx11, vy11, vz11), and voxel reliability Vre1(vx11, vy11, vz11) (with sets of values that are associated with voxels as these are being called “voxel data”).

After the pixel coordinate generation unit 1064 has finished generating coordinates (i11, j11) for all of the pixels of the object being processed, the voxel data generation unit 1074 outputs the voxel data accumulated for all of the voxels 1030, . . . , 1030. The number of the voxel data accumulated for the individual voxels is not constant. As there are voxels for which pluralities of voxel data are accumulated, for example, so there are voxels for which no voxel data whatever are accumulated. By a voxel for which no voxel data whatever have been accumulated is meant a voxel wherein, based on the photographed images from the 1st multi-eyes stereo camera 1011, the existence of the outer surface of the object 1010 there has not been estimated.

In such manner, the first voxel data generation unit 1074 outputs voxel data Vd1(vx11, vy11, vz11), Vim1(vx11, vy11, vz11), and Vre1(vx11, vy11, vz11) based on photographed images from the first multi-eyes stereo camera 1011 for all of the voxels. Similarly, the second and third voxel data generation units 1075 and 1076 also output voxel data Vd2(vx12, vy12, vz12), Vim2(vx12, vy12, vz12), and Vre2(vx12, vy12, vz12) and Vd3(vx13, vy13, vz13), Vim3(vx13, vy13, vz13), and Vre3(vx13, vy13, vz13), respectively, based on photographed images from the second and third multi-eyes stereo cameras 1012 and 1013 for all of the voxels.

(6) Integrated voxel data generation unit 1077

The integrated voxel data generation unit 1077 accumulates and integrates, for each voxel 1030, the voxel data Vd1(vx11, vy11, vz11), Vim1(vx11, vy11, vz11), and Vre1(vx11, vy11, vz11), the voxel data Vd2(vx12, vy12, vz12), Vim2(vx12, vy12, vz12), and Vre2(vx12, vy12, vz12) and the voxel data Vd3(vx13, vy13, vz13), Vim3(vx13, vy13, vz13), and Vre3(vx13, vy13, vz13) input from the three voxel data generation units 1074, 1075, and 1076 described above, and thereby finds the integrated brightness Vim(vx14, vy14, vz14) for the voxels.

The following are examples of integration methods.

A Case of a voxel for which pluralities of voxel data are accumulated:

(1) The average of the plurality of brightness accumulated is made the integrated brightness Vim(vx14, vy14, vz14). In this case, the distribution value of the plurality of brightness accumulated is found, and, when that distribution value is equal to or greater than a prescribed value, that voxel is assumed to have no data, whereupon the integrated brightness can be set to Vim(vx14, vy14, vz14)=0, for example.

(2) Alternatively, from a plurality of accumulated reliabilities, the highest one is selected, and the brightness corresponding to that highest reliability is made the integrated brightness Vim(vx14, vy14, vz14). In that case, when that highest reliability is lower than a prescribed value, it is assumed that there are no data in that voxel, and the integrated brightness is set to Vim(vx14, vy14, vz14)=0, for example.

(3) Alternatively, a weight coefficient is determined from the accumulated reliabilities, that weight coefficient is applied to the corresponding brightness, and the averaged value is made the integrated brightness Vim(vx14, vy14, vz14).

(4) Alternatively, because it is assumed that the brightness reliability will be higher the closer the distance of the camera to the object, the shortest one of a plurality of distances accumulated is selected, and the one brightness corresponding to that shortest distance is made the integrated brightness Vim(vx14, vy14, vz14).

(5) Alternatively, a method which modifies or combines the methods noted above in (1) to (4) is used.

B. Case of a voxel for which only one set of voxel data is accumulated:

(1) One accumulated brightness is made the integrated brightness Vim(vx14, vy14, vz14) as it is.

(2) Alternatively, when the reliability is equal to or greater than a prescribed value, that brightness is made the integrated brightness Vim(vx14, vy14, vz14), and when the reliability is less than the prescribed value, it is assumed that that voxel has no data, and the integrated brightness is set to Vim(vx14, vy14, vz14)=0, for example.

C. Case of a voxel for which no voxel data are accumulated:

(1) It is assumed that that voxel has no data, and the integrated brightness is set to Vim(vx14, vy14, vz14)=0, for example.

The integrated voxel data generation unit 77 finds an integrated brightness Vim(vx14, vy14, vz14) for all of the voxels 1030, . . . , 1030 and outputs that to the modeling unit 1078.

(7) Modeling unit 1078

The modeling unit 1078 inputs an integrated brightness Vim(vx14, vy14, vz14) for all of the voxels 1030, . . . , 1030 inside the space 1020 from the integrated voxel data generation unit 1077. Voxels for which the value of the integrated brightness Vim(vx14, vy14, vz14) is other than “0” connote voxels where the outer surface of the object 1010 is estimated to exist. Thereupon, the modeling unit 1078 produces a three-dimensional model representing the three-dimensional shape of the outer surface of the object 1010, based on the coordinates (vx14, vy14, vz14) of voxels having values other than “0” for the integrated brightness Vim(vx14, vy14, vz14). This three-dimensional model may be, for example, polygon data that represent a three-dimensional shape by a plurality of polygons obtained by connecting the coordinates (vx14, vy14, vz14), for the voxels having integrated brightness Vim(vx14, vy14, vz14) values other than “0,” which are close to each other into closed loops. Moreover, the three-dimensional model generated here, when it has modeled the full body of the user, is a full-body integrated model 1600 such as has already been described with reference to FIG. 12 and FIG. 13. The modeling unit 1078 may convert that full-body integrated model 1600 to the part joint model 1601 with processing procedures already described with reference to FIG. 12 and 13, or, alternatively, it may output that full-body integrated model 1600 as is.

The processing in the units described above in (1) to (7) is repeated for each frame of the moving images output from the multi-eyes stereo cameras 1011, 1012, and 1013. As a result, the three-dimensional models, plural in number, will be generated one after another, at high speed, following the movement of the object 1010 in real time or in a condition approaching thereto.

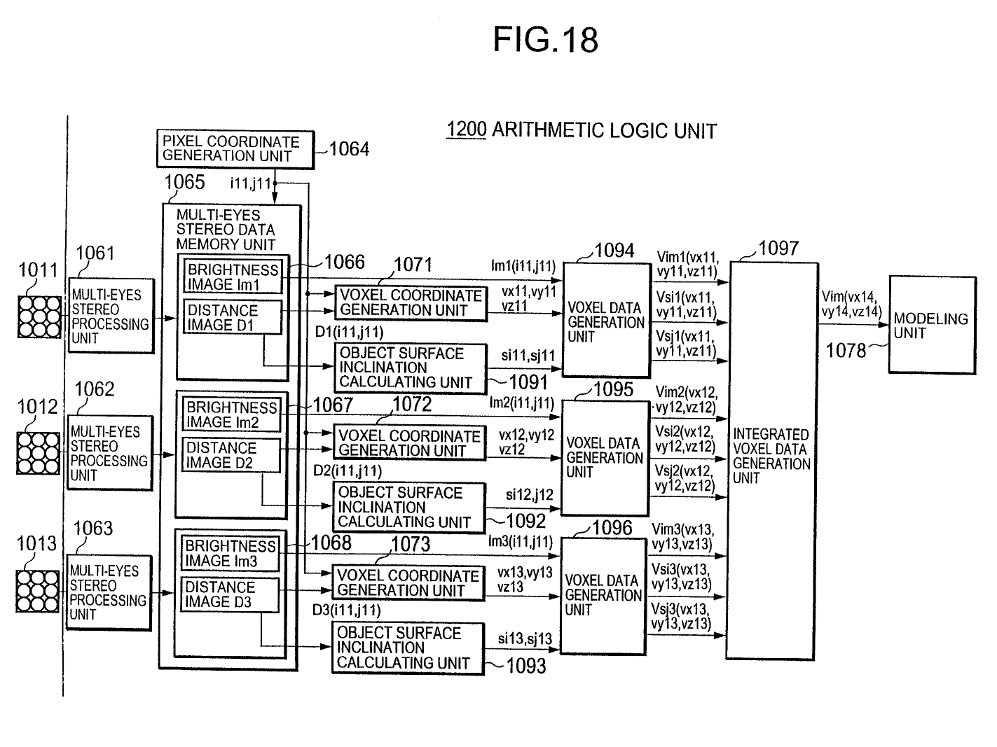

In FIG. 18 is represented the configuration of a second arithmetic logic unit 1200 that can be substituted in place of the arithmetic logic unit 1018 diagrammed in FIG. 16 and 17.

In the arithmetic logic unit 1200 diagrammed in FIG. 18, the multi-eyes stereo processing units 1061, 1062, and 1063, pixel coordinate generation unit 1064, multi-eyes stereo data memory unit 1065, voxel coordinate generation units 1071, 1072, and 1073, and modeling unit 1078 have exactly the same functions as the processing units of the same reference number that the arithmetic logic unit 1018 diagrammed in FIG. 17 has, as already described. What makes the arithmetic logic unit 1200 diagrammed in FIG. 18 different from the arithmetic logic unit 1018 diagrammed in FIG. 17 are the addition of object surface inclination calculating units 1091, 1092, and 1093, and the functions of voxel data generation units 1094, 1095, and 1096 and an integrated voxel data generation unit 1097 that are to process the outputs from those object surface inclination calculating units 1091, 1092, and 1093. Those portions that are different are now described.

(1) Object surface inclination calculating units 1091, 1092, and 1093

Three object surface inclination calculating units 1091, 1092, and 1093 are provided in correspondence, respectively, with the three multi-eyes stereo processing units 1061, 1062, and 1063. The functions of these object surface inclination calculating units 1091, 1092, and 1093 are mutually identical, wherefore the first object surface inclination calculating unit 1091 is described representatively.

The object surface inclination calculating unit 1091, upon inputting the coordinates (i11, j11) from the pixel coordinate generation unit 1064, establishes a window of a prescribed size (3×3 pixels, for example) centered on those coordinates (i11, j11), and inputs the distances for all of the pixels in that window from the distance image D1 in the memory area 1066 corresponding to the multi-eyes stereo data memory unit 1065. Next, the object surface inclination calculating unit 1091, under the assumption that the outer surface of the object 1010 (hereinafter called the object surface) inside the area of the window is a flat surface, calculates the inclination between the object surface in that window and a plane at right angles to the line of sight 1014 from the multi-eyes stereo camera 1011 (zero-inclination plane), based on the distances of all the pixels in that window.

For the calculation method, there is, for example, a method wherewith, using the distances inside the window, a normal vector for the object surface is found by the method of least squares, then the differential vector between that normal vector and the vector of the line of sight 1014 from the camera 1011 is found, the i direction component Si11 and the j direction component Sj11 of that differential vector are extracted, and the object surface is given the inclination Si11, Sj11.

In this manner, the first object surface inclination calculating unit 1091 calculates and outputs the inclination Si11, Sj11 for the object as seen from the first multi-eyes stereo camera 1011, for all of the pixels in the main image photographed by that camera 1011. Similarly, the second and third object surface inclination calculating units 1092 and 1093 calculate and output the inclinations Si12, Sj12 and Si13, Sj13 for the object as seen from the second and third multi-eyes stereo cameras 1012 and 1013, for all of the pixels in the main images photographed by those cameras 1012 and 1013, respectively.

(2) Voxel data generation units 1094, 1095, 1096

Three voxel data generation units 1094, 1095, and 1096 that correspond respectively to the three multi-eyes stereo processing units 1061, 1062, and 1063 are provided. The functions of these voxel data generation units 1094, 1095, and 1096 are mutually the same, wherefore the first voxel data generation unit 1094 is described representatively.

The voxel data generation unit 1094 inputs the voxel coordinates (vx11, vy11, vz11) from the corresponding voxel coordinate generation unit and, if the value thereof is not (xout, yout, zout), accumulates voxel data for those voxel coordinates (vx11, vy11, vz11). For the voxel data accumulated, there are three types of values, namely the brightness Im1(i11, j11) read out from the first memory area 1066 inside the multi-eyes stereo data memory unit 1065 for the pixel corresponding to those voxel coordinates (vx11, vy11, vz11), and the inclination Si11, Sj11 of the object surface output from the first object surface inclination calculating unit 1091. Those three types of values are accumulated in the form Vim1(vx11, vy11, vz11), Vsi1(vx11, vy11, vz11), and Vsj1(vx11, vy11, vz11).

After the pixel coordinate generation unit 1064 has finished generating the coordinates (i11, j11) for all of the pixels of the object being processed, the voxel data generation unit 1094 outputs the voxel data Vim1(vx11, vy11, vz11), Vsi1(vx11, vy11, vz11), and Vsj1(vx11, vy11, vz11) for all of the voxels 1030, . . . , 1030.

Similarly, the second and third voxel data generation units 1095 and 1096 output the voxel data Vim2(vx12, vy12, vz12), Vsi2(vx12, vy12, vz12), and Vsj2(vx12, vy12, vz12), and Vim3(vx13, vy13, vz13), Vsi3(vx13, vy13, vz13), and Vsj3(vx13, vy13, vz13), respectively, based, respectively, on the photographed images from the second and third multi-eyes stereo cameras 1012 and 1013, accumulated for all of the voxels 1030, . . . , 1030.

(3) Integrated voxel data generation unit 1097

The integrated voxel data generation unit 1097 accumulates and integrates, for each voxel 1030, the voxel data Vim1(vx11, vy11, vz11), Vsi1(vx11, vy11, vz11), and Vsj1(vx11, vy11, vz11), Vim2(vx12, vy12, vz12), Vsi2(vx12, vy12, vz12), and Vsj2(vx12, vy12, vz12), and Vim3(vx13, vy13, vz13), Vsi3(vx13, vy13, vz13), and Vsj3(vx13, vy13, vz13), from the three voxel data generation units 1094, 1095, and 1096, and thereby finds the integrated brightness Vim(vx14, vy14, vz14) for the voxels.

There are the following integration methods. The processing here is done with the presupposition that the smaller the object surface inclination, the higher the reliability of the multi-eyes stereo data.

A. Case of voxel for which pluralities of voxel data are accumulated:

(1) The sums of the squares of the i direction components Vsi1(vx11, vy11, vz11) and j direction components Vsj1(vx11, vy11, vz11) of the inclinations accumulated are found, and the brightness corresponding to the inclination where that sum of squares is the smallest is made the integrated brightness Vim(vx14, vy14, vz14). In this case, if the value of the smallest sum of squares is larger than a prescribed value, then it may be assumed that that voxel has no data, and the integrated brightness be made Vim(vx14, vy14, vz14)=0, for example.

(2) Alternatively, the average value of the i components and the average value of the j components of the plurality of inclinations accumulated are found, only inclinations that are comprehended within prescribed ranges centered on those average values of the i components and j components are extracted, the brightness corresponding to those extracted inclinations are extracted, and the average value of those extracted brightness is made the integrated brightness Vim(vx14, vy14, vz14).

B. Case of voxel for which only one set of voxel data is accumulated:

(1) One brightness accumulated is used as is for the integrated brightness Vim(vx14, vy14, vz14). In this case, if the sum of the squares of the i component and the j component of one inclination accumulated is equal to or greater than a prescribed value, it may be assumed that that voxel has no data, and the integrated brightness be made Vim(vx14, vy14, vz14)=0, for example.

C. Case of voxel for which no voxel data are accumulated:

(1) It is assumed that this voxel has no data, and the integrated brightness is made Vim(vx14, vy14, vz14)=0, for example.

In this manner, the integrated voxel data generation unit 97 computes all of the voxel integrated brightness Vim(vx14, vy14, vz14) and sends those to the modeling unit 1078. The processing done by the modeling unit 1078 is as already described with reference to FIG. 17.

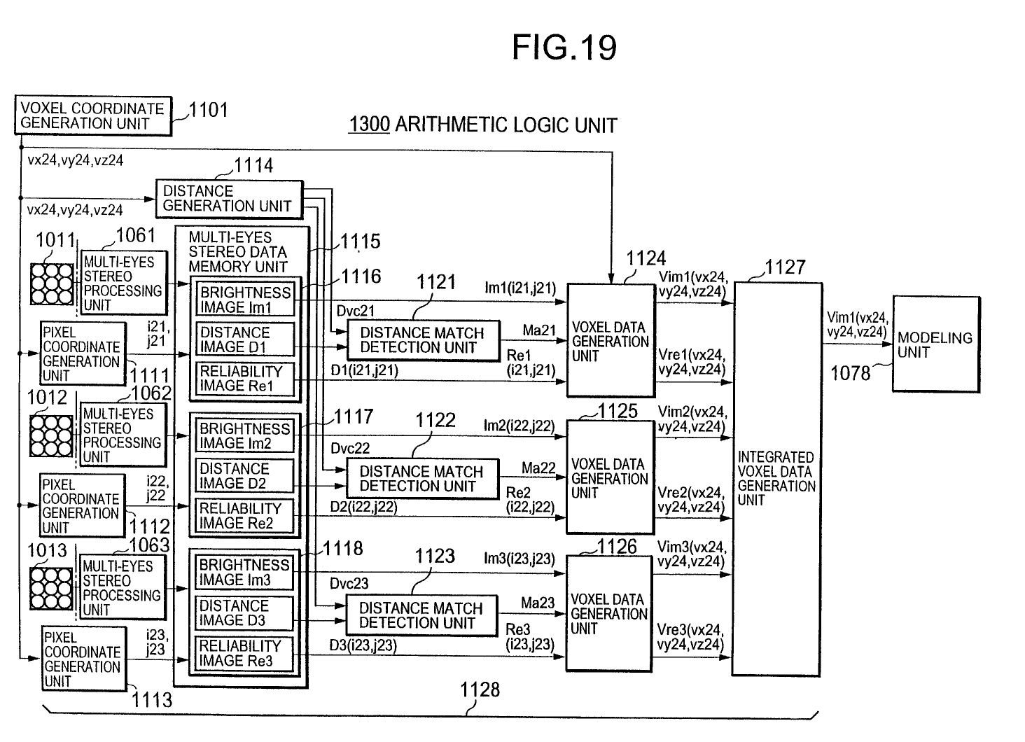

In FIG. 19 is diagrammed the configuration of a third arithmetic logic unit 1300 that can be substituted for the arithmetic logic unit 1018 diagrammed in FIG. 16 and 17.

The arithmetic logic unit 1300 diagrammed in FIG. 19, compared to the arithmetic logic units 1018 and 1200 diagrammed in FIG. 17 and FIG. 18, respectively, differs in the processing procedure for producing voxel data, as follows. That is, the arithmetic logic units 1018 and 1200 diagrammed in FIG. 17 and 18 scan within the images output by the multi-eyes stereo processing units, find corresponding voxels 1030 from the space 1020, for each pixel in those images, and assign voxel data. The arithmetic logic unit 1300 diagrammed in FIG. 19, conversely, first scans the space 1020, finds corresponding stereo data from the images output by the multi-eyes stereo processing units, for each voxel 1030 in the space 1020, and assigns those data to the voxels.

The arithmetic logic unit 1300 diagrammed in FIG. 19 has multi-eyes stereo processing units 1061, 1062, and 1063, a voxel coordinate generation unit 1101, pixel coordinate generation units 1111, 1112, and 1113, a distance generation unit 1114, multi-eyes stereo data memory units 1115, distance match detection units 1121, 1122, and 1123, voxel data generation units 1124, 1125, and 1126, an integrated voxel data generation unit 127, and a modeling unit 1078. Of these, the multi-eyes stereo processing units 1061, 1062, and 1063 and the modeling unit 1078 have exactly the same functions as the processing units of the same reference number in the arithmetic logic unit 1018 diagrammed in FIG. 17 and already described. The functions of the other processing units differ from those of the arithmetic logic unit 1018 diagrammed in FIG. 17. Those areas of difference are described below. In the description which follows, the coordinates representing the positions of the voxels 1030 are made (vx24, vy24, vz24).

(1) Voxel coordinate generation unit 1101

This unit sequentially outputs the coordinates (vx24, vy24, vz24) for all of the voxels 1030, . . . , 1030 in the space 1020.

(2) Pixel coordinate generation units 1111, 1112, 1113

Three pixel coordinate generation units 1111, 1112, and 1113 are provided corresponding respectively to the three multi-eyes stereo processing units 1061, 1062, and 1063. The functions of these pixel coordinate generation units 1111, 1112, and 1113 are mutually the same, wherefore the first pixel coordinate generation unit 1111 is described representatively.

The pixel coordinate generation unit 1111 inputs voxel coordinates (vx24, vy24, vz24), and outputs pixel coordinates (i21, j21) for images output by the corresponding first multi-eyes stereo processing unit 1061. The relationship between the voxel coordinates (vx24, vy24, vz24) and the pixel coordinates (i21, j21), moreover, may be calculated using the multi-eyes stereo camera 1011 attachment position information and lens distortion information, etc., or, alternatively, the relationships between the pixel coordinates (i21, j21) and all of the voxel coordinates (vx24, vy24, vz24) may be calculated beforehand, stored in memory in the form of a look-up table or the like, and called from that memory.

Similarly, the second and third pixel coordinate generation units 1112 and 1113 output the coordinates (i22, j22) and (i23, j23) for the images output by the second and third multi-eyes stereo processing units 1062 and 1063 corresponding to the voxel coordinates (vx24, vy24, vz24).

(4) Distance generation unit 1114

The distance generation unit 1114 inputs voxel coordinates (vx24, vy24, vz24), and outputs the distances Dvc21, Dvc22, and Dvc23 between the voxels corresponding thereto and the first, second, and third multi-eyes stereo cameras 1011, 1012, and 1013. The distances Dvc21, Dvc22, and Dvc23 are calculated using the attachment position information and lens distortion information, etc., of the multi-eyes stereo cameras 1011, 1012, and 1013.

(5) Multi-eyes stereo data memory unit 1115

The multi-eyes stereo data memory unit 1115, which has memory areas 1116, 1117, and 1118 corresponding to the three multi-eyes stereo processing units 1061, 1062, and 1063, inputs images (brightness images Im1, Im2, and Im3, distance images D1, D2, and D3, and reliability images Re1, Re2, and Re3) after stereo processing from the three multi-eyes stereo processing units 1061, 1062, and 1063, and stores those input images in the corresponding memory areas 1116, 1117, and 1118. The brightness image Im1, distance image D1, and reliability image Re1 from the first multi-eyes stereo processing unit 1061, for example, are accumulated in the first memory area 1116.

Following thereupon, the multi-eyes stereo data memory unit 1115 inputs pixel coordinates (i21, j21), (i22, j22), and (i23, j23) from the three pixel coordinate generation units 1111, 1112, and 1113, and reads out pixel stereo data (brightness, distance, reliability) corresponding respectively to the input pixel coordinates (i21, j21), (i22, j22), and (i23, j23), from the memory areas 1116, 1117, and 1118 corresponding respectively to the three pixel coordinate generation units 1111, 1112, and 1113, and outputs those. For the pixel coordinates (i21, j21) input from the first pixel coordinate generation unit 1111, for example, from the brightness image Im1, distance image D1, and reliability image Re1 of the first multi-eyes stereo processing unit 1061 that are accumulated, the brightness Im1(i21, j21), distance D1(i21, j21), and reliability Re1(i21, j21) of the pixel corresponding to those input pixel coordinates (i21, j21) are read out and output.

Furthermore, whereas the input pixel coordinates (i21, j21), (i22, j22), and (i23, j23) are real number data found by computation from the voxel coordinates, in contrast thereto, the pixel coordinates (that is, the memory addresses) of images stored in the multi-eyes stereo data memory unit 1115 are integers. Thereupon, the multi-eyes stereo data memory unit 1115 may discard the portions of the input pixel coordinates (i21, j21), (i22, j22), and (i23, j23) following the decimal point and convert those to integer pixel coordinates, or, alternatively, select a plurality of integer pixel coordinates in the vicinities of the input pixel coordinates (i21, j21), (i22, j22), and (i23, j23), read out and interpolate stereo data for that plurality of integer pixel coordinates, and output the results of those interpolations as stereo data for the input pixel coordinates.

(6) Distance match detection units 1121, 1122, 1123

Three distance match detection units 1121, 1122, and 1123 are provided corresponding respectively to the three multi-eyes stereo processing units 1061, 1062, and 1063. The functions of these distance match detection units 1121, 1122, and 1123 are mutually the same, wherefore the first distance match detection unit 1121 is described representatively.

The first distance match detection unit 1121 compares the distance D1(i21, j21) measured by the first multi-eyes stereo processing unit 1061 output from the multi-eyes stereo data memory unit 1115 against a distance Dvc1 corresponding to the voxel coordinates (vx24, vy24, vz24) output from the distance generation unit 1114. When the outer surface of the object 1010 exists in that voxel, D1(i21, j21) and Dvc21 should agree. Thereupon, the distance match detection unit 1121, when the absolute value of the difference between D1(i21, j21) and Dvc21 is equal to or less than a prescribed value, judges that the outer surface of the object 1010 exists in that voxel and outputs a judgment value Ma21−1. When the absolute value of the difference between D1(i21, j21) and Dvc21 is greater than the prescribed value, on the other hand, the distance match detection unit 1121 judges that the outer surface of the object 1010 does not exist in that voxel and outputs a judgment value Ma21=0.

Similarly, the second and third distance match detection units 1122 and 1123 judge whether or not the outer surface of the object 1010 exists in those voxels, based respectively on the measured distances D2(i22, j22) and D3(i23, j23) according to the second and third multi-eyes stereo processing units 1062 and 1063, and outputs the judgment values Ma22 and Ma23, respectively.

(7) Voxel data generation units 1124, 1125, 1126

Three voxel data generation units 1124, 1125, and 1126 are provided corresponding respectively to the three multi-eyes stereo processing units 1061, 1062 and 1063. The functions of these voxel data generation units 1124, 1125, and 1126 are mutually the same, wherefore the first voxel data generation unit 1124 is described representatively.

The first voxel data generation unit 1124 checks the judgment value Ma21 from the first distance match detection unit and, when Ma21 is 1 (that is, when the outer surface of the object 1010 exists in the voxel having the voxel coordinates (vx24, vy24, vz24)), accumulates the data output from the first memory area 1116 of the multi-eyes stereo data memory unit 1115 for that voxel as the voxel data for that voxel. The accumulated voxel data are the brightness Im1(i21, j21) and reliability Re1(i21, j21) for the pixel coordinates (i21, j21) corresponding to those voxel coordinates (vx24, vy24, vz24), and are accumulated, respectively, as the voxel brightness Vim1(vx24, vy24, vz24) and the voxel reliability Vre1(vx24, vy24, vz24).

After the voxel coordinate generation unit 1101 has generated voxel coordinates for all of the voxels 1030, . . . , 1030 which are to be processed, the voxel data generation unit 1124 outputs the voxel data Vim1(vx24, vy24, vz24) and Vre1(vx24, vy24, vz24) accumulated for each of all of the voxels 1030, . . . , 1030. The numbers of sets of voxel data accumulated for the individual voxels are not the same, and there are also voxels for which no voxel data are accumulated.

Similarly, the second and third voxel data generation units 1125 and 1126, for each of all of the voxels 1030, . . . , 1030, accumulate, and output, the voxel data Vim2(vx24, vy24, vz24) and Vre2(vx24, vy24, vz24), and Vim3(vx24, vy24, vz24) and Vre3(vx24, vy24, vz24), based respectively on the outputs of the second and third multi-eyes stereo processing units 1062 and 1063.

(8) Integrated voxel data generation unit 1127

The integrated voxel data generation unit 1127 integrates the voxel data from the three voxel data generation units 1124, 1125, and 1126, voxel by voxel, and thereby finds an integrated brightness Vim(vx24, vy24, vz24) for the voxels.

There are the following integration methods.

A Case of voxel for which pluralities of voxel data are accumulated:

(1) The average of a plurality of accumulated brightness is made the integrated brightness Vim(vx24, vy24, vz24). In this case, the distribution value of the plurality of brightness is found, and, if that distribution value is equal to or greater than a prescribed value, it may be assumed that that voxel has no data, and Vim(vx24, vy24, vz24)=0 be set, for example.

(2) Alternatively, the highest of a plurality of accumulated reliabilities is selected, and the brightness corresponding to that highest reliability is made the integrated brightness Vim(vx24, vy24, vz24). In that case, if that highest reliability is equal to or below the prescribed value, it may be assumed that that voxel has no data, and Vim(vx24, vy24, vz24)=0 be set, for example.

(3) Alternatively, a weight coefficient is determined from the accumulated reliabilities, each of the plurality of accumulated brightness, respectively, is multiplied by the weight coefficient, and the averaged value is made the integrated brightness Vim(vx24, vy24, vz24).

B. Case of voxel for which one set of voxel data is accumulated:

(1) That brightness is made the integrated brightness Vim(vx24, vy24, vz24). In this case, when the reliability is equal to or lower than a prescribed value, that voxel may be assumed to have no data and Vim(vx24, vy24, vz24)=0 set, for example.

C. Case of voxel for which no voxel data are accumulated:

(1) That voxel is assumed to have no data, and Vim(vx24, vy24, vz24)=0 set, for example.

In this manner, the integrated voxel data generation unit 1127 computes the integrated brightness Vim(vx24, vy24, vz24) for all of the voxels and sends the same to the modeling unit 1078. The processing of the modeling unit 1078 is as has already been described with reference to FIG. 17.

Now, with the arithmetic logic unit 1300 diagrammed in FIG. 19, in the same manner as seen in the difference between the arithmetic logic unit 1018 diagrammed in FIG. 17 and the arithmetic logic unit 1200 diagrammed in FIG. 18, it is possible to add an object surface inclination calculating unit and use the inclination of the object surface instead of the reliability when generating integrated brightness.

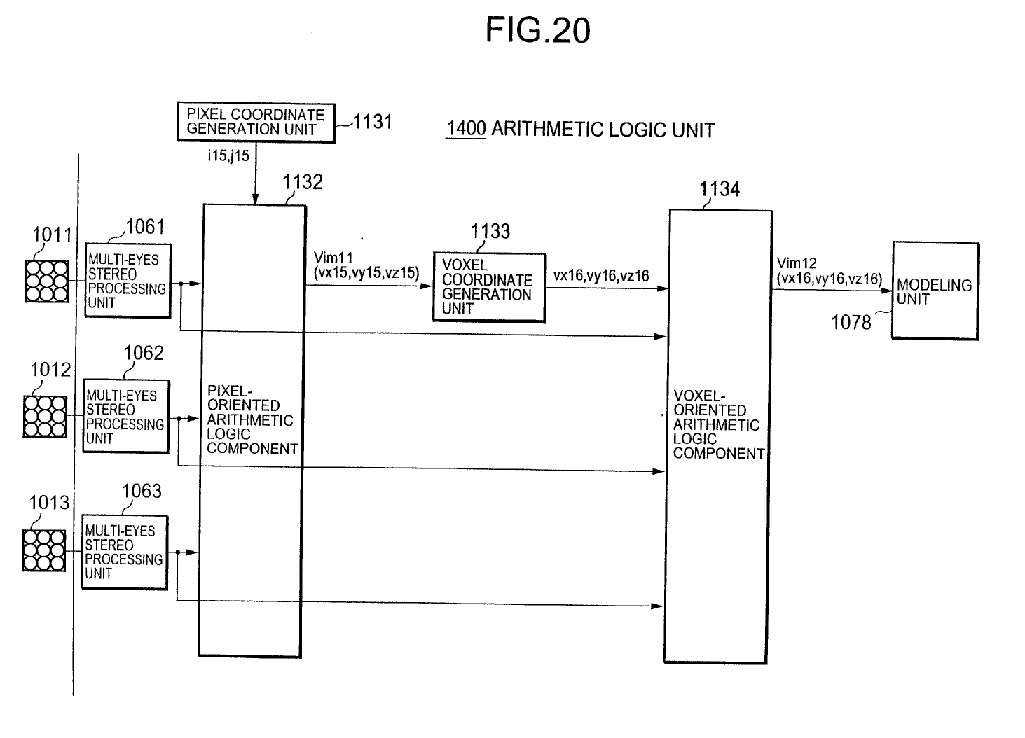

In FIG. 20 is diagrammed the configuration of a fourth arithmetic logic unit 1400 that can be substituted for the arithmetic logic unit 1018 diagrammed in FIG. 16 and 17.

The arithmetic logic unit 1400 diagrammed in FIG. 20, combining the configuration of the arithmetic logic unit 1018 diagrammed in FIG. 17 and the arithmetic logic unit 1300 diagrammed in FIG. 19, is designed so as to capitalize on the merits of those respective configurations while suppressing their mutual shortcomings. More specifically, based on the configuration of the arithmetic logic unit 1300 diagrammed in FIG. 19, processing is performed wherein the three axes of coordinates of the voxel coordinates (vx24, vy24, vz24) are varied, wherefore, when the voxel size is made small and the number of voxels increased to make a fine three-dimensional model, the computation volume becomes enormous, which is a problem. Based on the configuration of the arithmetic logic unit 1018 diagrammed in FIG. 17, on the other hand, it is only necessary to vary the two axes of coordinates of the pixel coordinates (i11, j11), wherefore the computation volume is small compared to the arithmetic logic unit 1300 of FIG. 19, but, if the number of voxels is increased to obtain a fine three-dimensional model, the number of voxels for which voxel data are given is limited by the number of pixels, wherefore gaps open up between the voxels for which voxel data are given, and a fine three-dimensional model cannot be obtained, which is a problem.

Thereupon, in order to resolve those problems, with the arithmetic logic unit 1400 diagrammed in FIG. 20, a small number of coarse voxels is first established and pixel-oriented arithmetic processing is performed as with the arithmetic logic unit 1018 of FIG. 17, and an integrated brightness Vim11(vx15, vy15, vz15) is found for the coarse voxels. Next, based on the coarse voxel integrated brightness Vim11(vx15, vy15, vz15), for a coarse voxel having an integrated brightness for which it is judged that the outer surface of the object 1010 exists, the region of that coarse voxel is divided into fine voxels having small regions, and voxel-oriented arithmetic processing such as is performed by the arithmetic logic unit 1300 of FIG. 19 is only performed for those divided fine voxels.

More specifically, the arithmetic logic unit 1400 diagrammed in FIG. 20 comprises, downstream of multi-eyes stereo processing units 1061, 1062, and 1063 having the same configuration as has already been described, a pixel coordinate generation unit 1131, a pixel-oriented arithmetic logic component 1132, a voxel coordinate generation unit 1133, a voxel-oriented arithmetic logic component 1134, and a modeling unit 1078 having the same configuration as already described.

The pixel coordinate generation unit 1131 and the pixel-oriented arithmetic logic component 1132 have substantially the same configuration as in block 1079 in the arithmetic logic unit 1018 diagrammed in FIG. 17 (namely, the pixel coordinate generation unit 1064, multi-eyes stereo data memory unit 1065, voxel coordinate generation units 1071, 1072, and 1073, voxel data generation units 1074, 1075, and 1076, and integrated voxel data generation unit 1077). More specifically, the pixel coordinate generation unit 1131, in the same manner as the pixel coordinate generation unit 1064 indicated in FIG. 17, scans all of the pixels in either the entire regions or in the partial regions to be processed of the images output by the multi-eyes stereo processing units 1061, 1062, and 1063, and sequentially outputs coordinates (i15, j15) for the pixels. The pixel-oriented arithmetic logic component 1132, based on the pixel coordinates (i15, j15) and on the distances relative to those pixel coordinates (i15, j15), finds the coordinates (vx15, vy15, vz15) of the coarse voxels established beforehand by the coarse division of the space 1020, and then finds, and outputs, an integrated brightness Vim11(vx15, vy15, vz15) for those coarse voxel coordinates (vx15, vy15, vz15) using the same method as the arithmetic logic unit 1018 of FIG. 17. Also, for the method used here for finding the integrated brightness Vim11(vx15, vy15, vz15), instead of the method already described, a simple method may be used which merely distinguishes whether or not Vim11(vx15, vy15, vz15) is zero (that is, whether or not the outer surface of the object 1010 exists in that coarse voxel).

The voxel coordinate generation unit 1133 inputs an integrated brightness Vim11(vx15, vy15, vz15) for the coordinates (vx15, vy15, vz15) for the coarse voxels, whereupon the coarse voxels for which that integrated brightness Vim11(vx15, vy15, vz15) is not zero (that is, wherein it is estimated that the outer surface of the object 1010 exists), and those only, are divided into pluralities of fine voxels, and the voxel coordinates (vx16, vy16, vz16) for those fine voxels are sequentially output.

The voxel-oriented arithmetic logic component 1134 has substantially the same configuration as in the block 1128 (i.e. the pixel coordinate generation units 1111, 1112, and 1113, distance generation unit 1114, multi-eyes stereo data memory unit 1115, distance match detection units 1121, 1122, and 1123, voxel data generation units 1124, 1125, and 1126, and integrated voxel data generation unit 1127) of the arithmetic logic unit 1300 diagrammed in FIG. 19. This voxel-oriented arithmetic logic component 1134, for the coordinates (vx16, vy16, vz16) of the fine voxels, finds voxel data based on the images output from the multi-eyes stereo processing units 1061, 1062, and 1063, integrates those to find the integrated brightness Vim12(vx16, vy16, vz16), and outputs that integrated brightness Vim12(vx16, vy16, vz16).

The process of generating the fine voxel data by the voxel-oriented arithmetic logic component 1134 is performed in a limited manner only on those voxels wherein it is assumed the outer surface of the object 1010 exists. Wasteful processing on voxels wherein the outer surface of the object 1010 does not exist is therefore eliminated, and processing time is reduced by that measure.

In the configuration described in the foregoing, the pixel-oriented arithmetic logic component 1132 and the voxel-oriented arithmetic logic component 1134 have multi-eyes stereo data memory units, respectively. However, the configuration can instead be made such that both the pixel-oriented arithmetic logic component 1132 and the voxel-oriented arithmetic logic component 1134 jointly share one multi-eyes stereo data memory unit.

Now, the individual elements that configure the arithmetic logic units 1018, 1200, 1300, and 1400 diagrammed in FIG. 17 to 20 as described in the foregoing can be implemented in pure hardware circuitry, by a computer program executed by a computer, or by a combination of those two forms. When implemented in pure hardware circuitry, modeling is completed at very high speed.

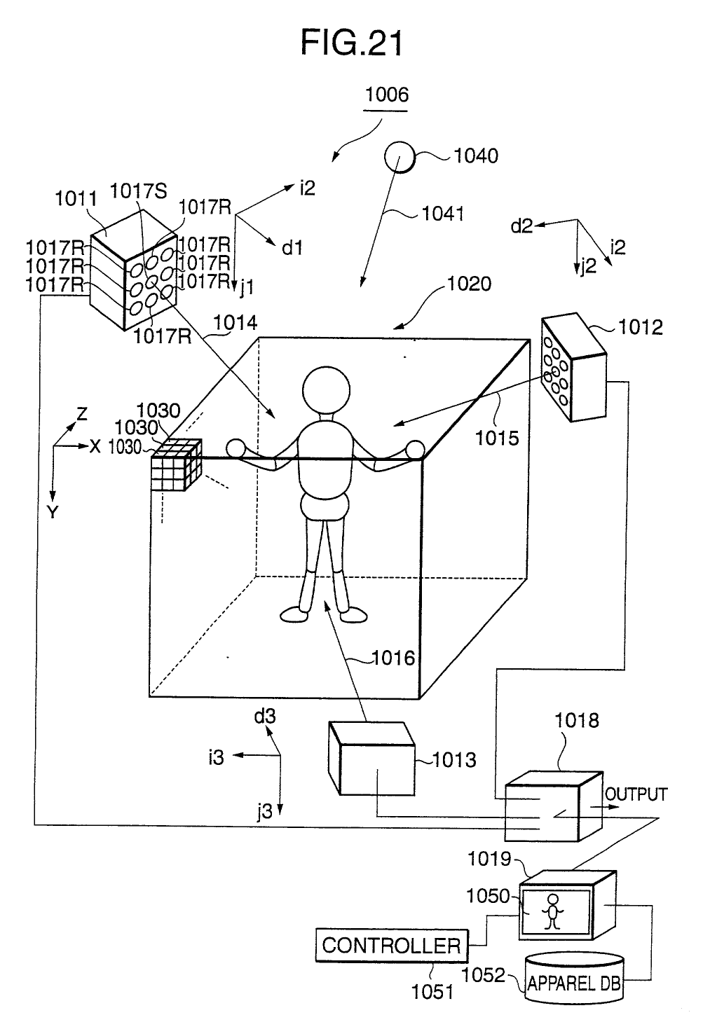

In FIG. 21 is diagrammed the overall configuration of a virtual trial fitting system relating to a seventh embodiment aspect of the present invention.

The virtual trial fitting system diagrammed in FIG. 21 is suitable for performing virtual trial fitting in a store such as a department store, apparel retailer, or game center, for example. More specifically, a stereo photographing system 1006 having the same configuration as that diagrammed in FIG. 16 is installed in a store, and thereto is connected the arithmetic logic unit 1018 having the configuration diagrammed in FIG. 17 (or the arithmetic logic unit 1200, 1300, or 1400 diagrammed in FIG. 18, 19, or 20). To the arithmetic logic unit 1018 is connected a computer system 1019. The computer system 19 has a virtual trial fitting program such as already described, holds an apparel database 1052 wherein are accumulated three-dimensional models of various apparel items, and has a controller 1051 that can be operated by a user 1010 who has entered the stereo photographing system 1006. The display screen 1050 thereof, furthermore, is placed in a position where it can be viewed by the user 1010 who is inside the stereo photographing system 1006.

The arithmetic logic unit 1018 inputs photographed data for the user 1010 from the stereo photographing system 1006, produces a standard full-body model for the user by a method already described, and outputs that standard full-body model to the computer system 1050. The arithmetic logic unit 1018 can also output the standard full-body model to the outside (writing it to a recording medium such as a CD-ROM, or sending it to a communications network, for example). The computer system 1019 executes the virtual trial fitting program, using the standard full-body model for the user input from the arithmetic logic unit 1018 and the three-dimensional models of the various apparel items stored in the apparel database 1052, and displays a virtual trial fitting window 1050, as indicated in FIG. 11, on that display screen 1050.

The user 1010, making control inputs from the controller 1051, can select apparel to be worn, and can alter the position, the line of sight 1041, and the zoom magnification of the virtual camera 1040 inside the virtual three-dimensional space. As already described, moreover, the arithmetic logic unit 1018 can produce a plurality of standard full-body models, one after another, that change along with, and in the same way as, the motions of the user 1010, in real time or approximately in real time, and send those to the computer system 1019. Therefore, if the user 1010 freely assumes poses and performs motions inside the stereo photographing system 1006, the three-dimensional model of the user in the virtual trial fitting window 1500 displayed on the display screen 1050 will assume the same poses and perform the same motions.

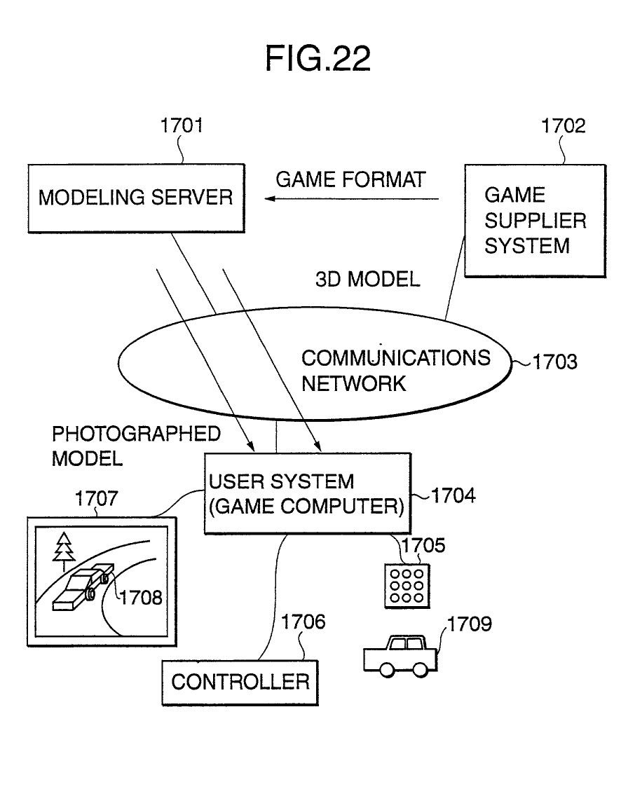

In FIG. 22 is diagrammed the overall configuration of one embodiment aspect of a game system that follows the present invention. This game system is for a user to import three-dimensional model data of any physical object into the virtual three-dimensional space of a computer game and play therewith.

As diagrammed in FIG. 22, a modeling server 1701, a computer system of a game supplier such as a game manufacturer or game retailer or the like (hereinafter called the “game supplier system”) 1702, and a computer system of a user (such as a personal computer or game computer or the like, hereinafter called the “user system”) 1704 are connected via a communications network 1703 such as the internet so that communications therebetween are possible. The user system 1704 has at least one multi-eyes stereo camera 1705, a controller 1706 operated by the user, and a display device 1707. In the user system 1704 are loaded a game program and a stereo photographing program.

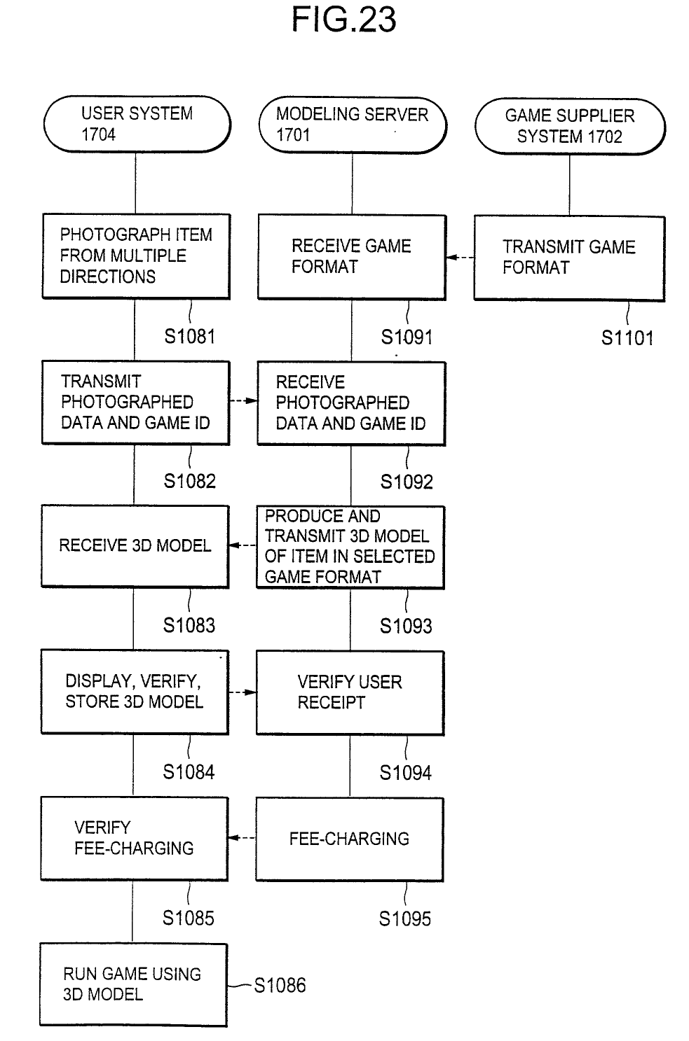

The process flow for this game system is indicated in FIG. 23. The operation of the game system is now described with reference to FIG. 22 and FIG. 23.

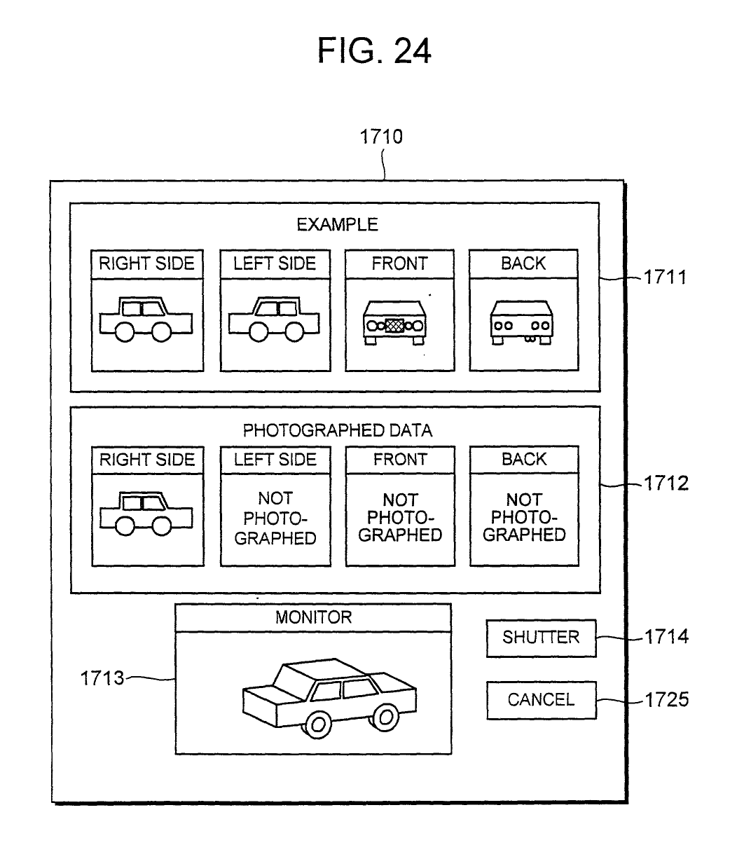

(1) As indicated in step S1081 in FIG. 23, in the user system 1704, the stereo photographing program is first run. Thereupon, the user, using the multi-eyes stereo camera 1704, photographs the item 1709 that he or she wishes to use in the game program (such as a toy automobile that he or she wishes to use as his or her own in an automobile race game, for example), from a plurality of directions (such as from the front, back, left, right, above, below, diagonally in front, and diagonally in back, for example), respectively. At that time, the stereo photographing program displays a photographing window 1710, such as shown in FIG. 24, for example, on the display device 1707. In this photographing window 1710 are arranged an aspect window 1711 for indicating the aspect when photographing from various directions, a photographed data window 1712 for representing the results actually photographed by the user, a monitor window 1713 for representing the video image currently being output from the multi-eyes stereo camera 1705, a “shutter” button 1714, and a “cancel” button 1715. If the user strikes the “shutter” button 1714, after adjusting the positional relationship between the multi-eyes stereo camera 1705 and the item 1709 so that the image displayed in the monitor window 1713 is oriented in the same way as the image oriented in the direction to be photographed in the aspect window 1711, a still image of the item 1709 oriented in that direction will be photographed.

(2) When the photographing from all of the directions has been completed, then, as indicated in step S1082 in FIG. 23, the stereo photographing program in the user system 1704 connects to the modeling server 1701 via the communications network 1703, and sends the photographed data of the item 1709 (still images photographed from a plurality of directions) to the modeling server 1701, and the modeling server 1701 receives those photographed data (S1092). At that time, moreover, the stereo photographing program in the user system 1704 notifies the modeling server 1701 of identifying information (game ID) for the game program that the user intends to use.

(3) As indicated in steps S1101 and S1091, the modeling server 1701 receives and accumulates information representing the data format for the three-dimensional models used by various game programs, beforehand, from the game supplier system 1702. The modeling server 1701 then, after receiving a game ID and photographed data for an item 1709 from the user system 1704, thereupon, as indicated in step S1093, produces three-dimensional model data for that item 1709, in the data format for the game ID received, using the photographed data received. The way in which the three-dimensional model data are made is basically the same as the method described with reference to FIG. 17 to 20. The modeling server 1701 transmits the three-dimensional model data produced for the item to the user system 1704 and, as indicated in step S1083, the stereo photographing program in the user system 1704 receives those three-dimensional model data.

(4) As indicated in step S1083, the stereo photographing program in the user system 1704, using the three-dimensional model data received, renders that three-dimensional model into two-dimensional images as seen from various directions (into moving images seen from all directions while turning that three-dimensional model, for example), and displays those on the display device 1707. The user views those images to check whether there are any problems with the received three-dimensional model data. When it has been verified that there are no such problems, the stereo photographing program stores the received three-dimensional model data, and notifies the modeling server 1701 that receipt has been made.

(5) As indicated in steps S1094 and S1095, the modeling server 1701, when it has been verified that the user has received the three-dimensional model data, performs a fee-charging process for collecting a fee from the user, transmits data resulting from that fee-charging process such as an invoice to the user system 1704, and, as indicated in step S1085, the stereo photographing program in the user system 1704 receives and displays those data resulting from that fee-charging process.

(6) After the production of the three-dimensional model data for the item 1709 has been finished in this manner, then, as indicated in step S1086, the user runs the game program on the user system 1704 and, in that game program, the three-dimensional model data for the item 1709 stored earlier are used. For example, as illustrated in the display device 1707 in FIG. 22, the user can use the three-dimensional model 1708 of his or her toy automobile 1709 and play the automobile race game.

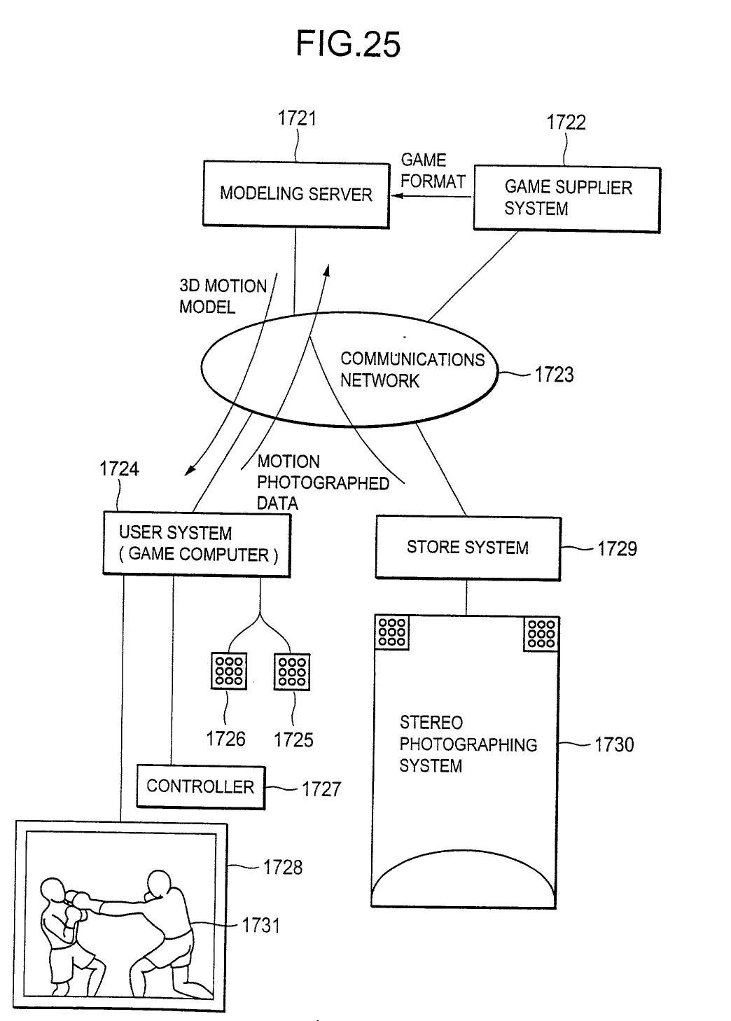

FIG. 25 represents a second embodiment aspect of a game system that follows the present invention. This game system is one for importing three-dimensional model data for the body of a person such as the user himself or herself or a friend into the virtual three-dimensional space of a computer game and playing that game.

As diagrammed in FIG. 25, a modeling server 1721, game supplier system 1722, user system 1724, and store system 1729 are connected via a communications network 1723 so that they can communicate. To the store system 1729 is connected a stereo photographing system 1730.

The game supplier system 1722, in the same manner as the game supplier system 1702 in the game system diagrammed in FIG. 22, provides format information for the three-dimensional models used in various game programs to the modeling server 1721. The store system 1729 and the stereo photographing system 1730, in the same manner as the store system 1005 and stereo photographing system 1006 of the virtual trial fitting system diagrammed in FIG. 8, photograph the body of the user with a plurality of multi-eyes stereo cameras and send those photographed data to the modeling server 1721.

The user system 1724, which is a personal computer or game computer, for example, has a controller 1727 operated by the user and a display device 1728, and is loaded with a game program for a game wherein human beings appear (such as a fighting game, for example). To the user system 1724, furthermore, if so desired by the user, are connected a plural number (such as 2, for example) of multi-eyes stereo cameras 1725 and 1726, and a stereo photographing program can be loaded for sending the photographed data from those multi-eyes stereo cameras 1725 and 1726 to the modeling server 1721 and receiving three-dimensional model data from the modeling server 1721.

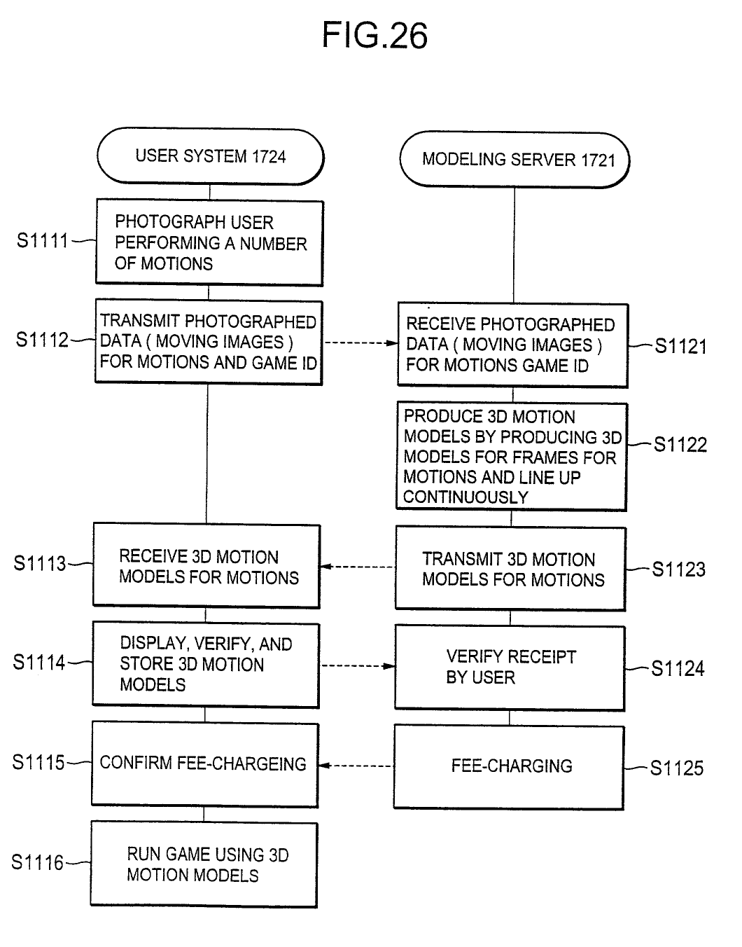

The process flow for this game system is diagrammed in FIG. 26. The operation of this game system is described with reference to FIG. 25 and FIG. 26.

(1) First, the user performs stereo photographing of the body of a person, such as himself or herself, for example, whom he or she wishes to appear in the game. This may be performed, as in the case of the virtual trial fitting system already described, by the stereo photographing system 1730 installed in a store, which has already been described. Thereupon, here, a description is given for an example case where the user performs the photographing using the multi-eyes stereo cameras 1725 and 1726 connected to his or her own user system 1724. As indicated in step S111 in FIG. 26, the user runs the stereo photographing program on the user system 1724, and photographs his or her own body with a plurality of multi-eyes stereo cameras 1725 and 1726 deployed so that they can photograph himself or herself from different locations. At that time, the user performs various prescribed motions used in the game (such as, in a fighting game, for example, punching, kicking, throwing, guarding, sidestepping, and other movements) in front of the multi-eyes stereo cameras 1725 and 1726, whereupon the moving image data photographed by the multi-eyes stereo cameras 1725 and 1726 for each motion are received by the user system 1724. Then, as indicated in step S1112, the photographed data (moving image data) for each motion and the game ID for the game program used are transmitted from the user system 1724 to the modeling server 1721.

(2) As indicated in steps S1121 and S1122, the modeling server 1721, upon receiving the game ID and the photographed data for each motion of the user, produces three-dimensional model data for the user's body in the data format for that game ID, for each frame of those photographed data (moving image data) for those motions, by the processing method described with reference to FIG. 17 to 20, and continuously lines up the plurality of three-dimensional model data produced respectively from the series of multiple frames of the images of the motions, according to the frame order. As a result, a series of pluralities of three-dimensional model data configuring the motions is formed. Then, as indicated in step S1123, the modeling server 1721 transmits the series of three-dimensional model data configuring the motions to the user system 1724.

(3) As indicated in steps S1113 and S1114, the stereo photographing program of the user system 1724, upon receiving the series of three-dimensional model data for the motions, produces a plural number of animation images that look respectively from a number of different viewpoints at the spectacle of the user performing the motions, using the series of three-dimensional models of those motions, and sequentially displays those animated images on the display device 1728. The user thereupon checks whether there are any problems with the series of three-dimensional model data for the motions received. When it has been verified that there are no such problems, the stereo photographing program stores the series of three-dimensional model data for the motions received, and notifies the modeling server 1721 of that receipt.

(4) As indicated in steps S1124 and S1125, the modeling server 1721, after verifying the receipt by the user of the three-dimensional model data, performs a fee-charging process for collecting a fee from the user, transmits data resulting from that fee-charging process such as an invoice to the user system 1724, and, as indicated in step S1115, the stereo photographing program in the user system 1724 receives and displays those data resulting from that fee-charging process.

(5) Thereafter, as indicated in step S1116, the user runs the game program on the user system 1724, and the series of three-dimensional model data for the motions stored earlier are used in that game program. For example, in response to control inputs made by the user from the controller 1727, the three-dimensional model 1731 of the user performs the motions of various moves such as straight punches, uppercuts, or tripping, in the virtual three-dimensional space of the fighting game, as indicated in the display device 1728 in FIG. 25.

Now, in the description given in the foregoing, the motions are configured by series of multiple three-dimensional models, but, instead thereof, it is possible also to employ a three-dimensional model wherein the parts of the body are articulated with joints (part joint model) 1601, as diagrammed in FIG. 13, and motion data for causing that part joint model to move in the same way as the motion of the user. When such a part joint model 1601 and motion data are employed, the modeling server 1721 performs processing such as that already described with reference to FIG. 12 and 13 to produce the part joint model 1601, and, together therewith, calculates the turning angle of the parts at the joints and the positions where the part joint model 1601 is present in order to put the part joint model 1601 in the same attitude as the three-dimensional models produced from the frames of the moving images of the motions of the user, thereby creating motion data, and transmits that part joint model 1601 and motion data to the user system 1724.

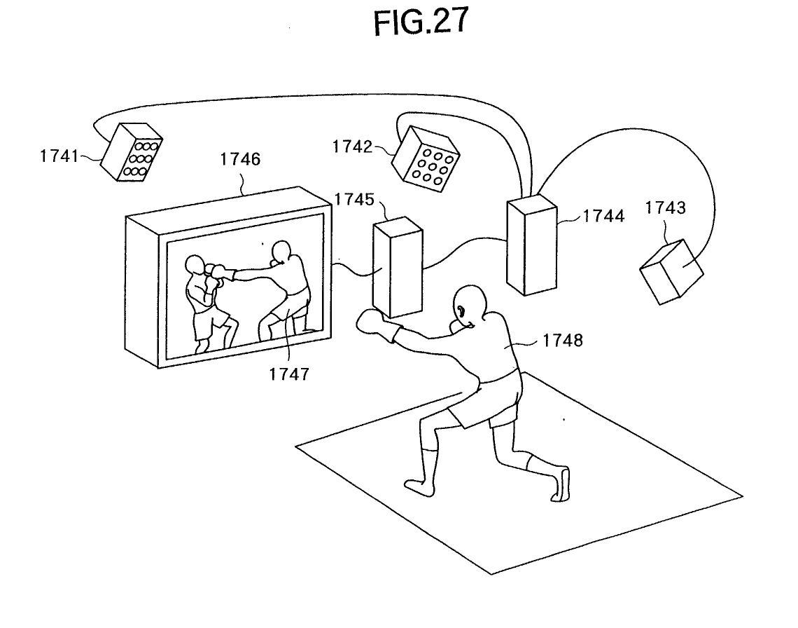

In FIG. 27 is represented the overall configuration of a game system relating to of a tenth embodiment aspect of the present invention. In this game system, a three-dimensional model that is a three-dimensional model of one's own body and that moves in real time in exactly the same way as oneself is imported into the virtual three-dimensional space of a game, and a game can be participated in that exhibits a very high feeling of reality.

As diagrammed in FIG. 27, a plural number of multi-eyes stereo cameras 1741 to 1743 is deployed at different locations about the periphery of a prescribed space into which a user 1748 is to enter, such that that space can be photographed. These multi-eyes stereo cameras 1741 to 1743 are connected to an arithmetic logic unit 1744 that is for effecting three-dimensional modeling. The output of that arithmetic logic unit 1744 is connected to a game apparatus 1745 (such, for example, as a personal computer, a home game computer, or a commercial game computer installed at a game center or the like). The game apparatus 1745 has a display device 1746. The user 1748 is able to see the screen of that display device 1746. In other words, this game system has substantially the same configuration as the virtual trial fitting system diagrammed in FIG. 21, made so that a game can be run on the computer system 1019 indicated in FIG. 21.

The arithmetic logic unit 1744 produces a series of three-dimensional model data, one set after another, at high speed, that move along with and in the same manner, in real time, as the motion of the user 1748, from photographed data (moving image data) from the multi-eyes stereo cameras 1741 to 1743, and send those data to the game apparatus 1745. The game apparatus 1745 imports that series of three-dimensional model data into the virtual three-dimensional space of the game and displays, on the display device 1746, a three-dimensional model 1747 that moves in exactly the same way and with the same form as the actual user 1748. Thus the user 1748 can play the game with the sense of reality that he or she himself or herself has actually entered the world of the game.

A number of embodiment aspects of the present invention are described in the foregoing, but those embodiment aspects are nothing more than examples given for the purpose of describing the present invention, and do not signify that the present invention is limited to those embodiment aspects alone. Accordingly, the present invention can be embodied in various aspects other than the embodiment aspects described in the foregoing. The present invention can be employed in various applications other than virtual trial fitting or games wherein it is possible to use a three-dimensional model.

What is claimed is:

1. A three-dimensional modeling apparatus comprising:
a stereo processing unit that receives images from a plural number of stereo cameras deployed at different locations so as to photograph a same object, and produces a plurality of distance images of said object from images from said plural number of stereo cameras;
a voxel processing unit that receives said plurality of distance images from said stereo processing unit, and, from among a multiplicity of voxels established beforehand in a prescribed space into which said object enters, selects voxels in which the surface of said object exists; and
a modeling unit for producing a three-dimensional model of said object, based on coordinates of the voxels selected by said voxel processing unit.

2. The three-dimensional modeling apparatus according to claim 1, wherein said stereo cameras output moving images respectively; and, for each frame of said moving images from said stereo cameras, said stereo processing unit, said voxel processing unit, and said modeling unit are configured so as to perform, respectively, a process for producing said distance images, a process for selecting voxels in which the surface of said object exists, and a process for producing a three-dimensional model of said object.

3. A three-dimensional modeling method comprising the steps of:
receiving images from a plural number of stereo cameras deployed at different locations so as to photograph a same object, and producing a plurality of distance images of said object from images from said plural number of stereo cameras;
receiving a plurality of said distance images and selecting, from among a multiplicity of voxels established beforehand inside a prescribed space into which said object enters, voxels in which the surface of said object exists; and
producing a three-dimensional model of said object based on coordinates of said selected voxels.

4. A three-dimensional image production apparatus comprising:
a stereo processing unit that receives images from a plural number of stereo cameras deployed at different locations so as to photograph a same object, and produces a plurality of distance images of said object from images from said plural number of stereo cameras;
an object detection unit that receives said plurality of distance images from said stereo processing unit, and determines coordinates in which the surface of said object exists, in a viewpoint coordinate system referenced to a viewpoint established at any location; and
a target image production unit for producing an image of said object as seen from said viewpoint, based on said coordinates determined by said object detection unit.

5. The three-dimensional image production apparatus according to claim 4, wherein said stereo cameras are output moving images, respectively; and, for each frame of said moving images from said stereo cameras, said stereo processing unit, said object detection unit, and said target image production unit are configured so as to perform, respectively, a process for producing said distance images, a process for determining coordinates wherein surface of said object exists, and a process for producing images of said object.

6. A three-dimensional image production method comprising the steps of:
receiving images from a plural number of stereo cameras deployed at different locations so as to photograph a same object, and producing a plurality of distance images of said object from images from said plural number of stereo cameras;
receiving plurality of said distance images and determining coordinates in which the surface of said object exists, in a viewpoint coordinate system referenced to a viewpoint established at any location; and
producing an image of said object as seen from said viewpoint, based on said determined coordinates.

7. A system for enabling a real physical object to appear in virtual three-dimensional space in a computer application used by a user, comprising:
photographed data reception means for receiving photographed data produced by stereo photographing a real physical object, from a stereo photographing apparatus usable by said user, capable of communicating with said stereo photographing apparatus;
modeling means for producing a three-dimensional model of said physical object, based on said received photographed data, in a prescribed data format that can be imported into virtual three-dimensional space by said computer application; and
three-dimensional model output means for outputting three-dimensional model data of said physical object, by a method wherewith those data can be presented to said user or to a computer application used by said user.

8. The system according to claim 7, wherein said photographed data received from said stereo photographing apparatus comprise photographed data for a plurality of poses photographed, respectively, when said real physical object assumed different poses; and said modeling means produce said three-dimensional model data for said physical object, based on said photographed data for said plurality of poses, in such a configuration that different poses can be assumed or different motions reproduced.

9. The system according to claim 7, wherein said photographed data received from said stereo photographing apparatus comprise photographed data for moving images photographed when said real physical object performed some motion; and said modeling means produce said three-dimensional model data for said physical object, based on said photographed data for said moving images, in such a configuration that same motion as that performed by said physical object is reproduced.

10. The system according to claim 9, wherein said modeling means produce said three-dimensional model data so that same motion is reproduced as the motion performed by said real physical object, following said latter motion substantially in real time during the photographing by said stereo photographing apparatus.

11. A method for enabling a real physical object to appear in virtual three-dimensional space in a computer application used by a user, comprising the steps of:
receiving photographed data produced by stereo photographing a real physical object from a stereo photographing apparatus that can be used by said user;
producing a three-dimensional model of said physical object, based on said photographed data received, in a prescribed data format capable of being imported into virtual three-dimensional space by said computer application; and
outputting three-dimensional model data for said physical object by a method that enables the date to be provided to said user or to said computer application used by said user.

12. A system for enabling a real physical object to appear in virtual three-dimensional space in a computer application used by a user, comprising:
a stereo photographing apparatus that can be used by said user; and
a modeling apparatus capable of communicating with said stereo photographing apparatus, and also capable of communicating with a computer apparatus that can be used by said user; wherein said modeling apparatus has:
photographed data receiving means for receiving photographed data produced by stereo photographing a real physical object from said stereo photographing apparatus;
modeling means for producing a three-dimensional model of said physical object, based on said photographed data received, in a prescribed data format capable of being imported into virtual three-dimensional space by said computer application; and
three-dimensional model transmission means for transmitting three-dimensional model data for said physical object to said computer apparatus that can be used by said user.

13. A system for enabling a real physical object to appear in virtual three-dimensional space in a computer application used by a user, comprising:
a computer apparatus for execution of said computer application by said user;
a stereo photographing apparatus that can be used by said user; and
a modeling apparatus capable of communicating with said stereo photographing apparatus and said computer apparatus; wherein said modeling apparatus has:
photographed data receiving means for receiving photographed data produced by stereo photographing a real physical object from said stereo photographing apparatus;
modeling means for producing a three-dimensional model of said physical object, based on said photographed data received, in a prescribed data format capable of being imported into virtual three-dimensional space by said computer application; and
three-dimensional model transmission means for transmitting three-dimensional model data for said physical object to said computer apparatus.

14. A method for enabling a real physical object to appear in virtual three-dimensional space in a computer application used by a user, comprising the steps of:
stereo-photographing a real physical object;
producing a three-dimensional model of said physical object, based on photographed data of said physical object obtained by stereo photographing, in a prescribed data format capable of being imported into virtual three-dimensional space by said computer application; and
inputting three-dimensional model data for said physical object into a computer apparatus capable of executing said computer application.
